(19) United States
(12) Patent Application Publication
(10) Pub. No.: US 2024/0287229 A1
(43) Pub. Date: Aug. 29, 2024

(54) ELASTOMERIC ELECTROLYTE FOR HIGH-ENERGY ALL-SOLID-STATE METAL BATTERIES

(71) Applicants: GEORGIA TECH RESEARCH CORPORATION, Atlanta, GA (US); KOREA ADVANCED INSTITUTE OF SCIENCE AND TECHNOLOGY, Yuseong-Gu (KR)

(72) Inventors: Seung Woo Lee, Atlanta, GA (US); Junghun Han, Yuseong-Gu (KR); Bumjoon J. Kim, Yuseong-Gu (KR); Michael J. Lee, Atlanta, GA (US)

(21) Appl. No.: 18/567,659

(22) PCT Filed: Jun. 8, 2022
(86) PCT No.: PCT/US22/32706

§ 371 Date: Dec. 6, 2023

Related U.S. Application Data
(60) Provisional application No. 63/209,140, filed on Jun. 10, 2021.
(60) Provisional application No. 63/242,156, filed on Sep. 9, 2021.
(60) Provisional application No. 63/285,687, filed on Dec. 3, 2021.

(51) Int. Cl. C08F 220/18; C08K 5/5313; H01M 4/02; H01M 4/525; H01M 10/0565

(52) U.S. Cl. CPC C08F 220/1804; C08K 5/5313; H01M 4/525; H01M 10/0565; H01M 2004/027; H01M 2004/028; H01M 2300/0082

(57) ABSTRACT

Disclosed is a polymer composition comprising a) a matrix comprising an elastomeric polymer; b) a plurality of plastic crystals dispersed within the matrix to form a three-dimensional interconnected phase of plastic crystals, and wherein the polymer composition exhibits an ionic conductivity of at least about 1.1 mS/cm at about 20° C. Also disclosed herein are electrochemical cells comprising the same and methods of making and using the same.

### CROSS-REFERENCE TO RELATED APPLICATIONS

This application claims the benefit of U.S. Provisional Application No. 63/209,140, filed Jun. 10, 2021, U.S. Provisional Application No. 63/242,156, filed Sep. 9, 2021, and U.S. Provisional Application No. 63/285,687, filed Dec. 3, 2021, the contents of which are incorporated herein by reference in their entirety.

### TECHNICAL FIELD

This application relates generally to metal and metal-ion batteries with stable solid electrolytes.

### BACKGROUND

Rechargeable batteries based on metal anodes, including lithium (Li), sodium (Na), and zinc (Zn), show great promise in achieving high energy density. Unfortunately, the electrochemical interface of the metal anodes is not favorable for metal deposition. Metal nucleation is inhomogeneous at the surface, leading to the growth of metal dendrites and the formation of unstable solid-electrolyte interphase (SEI) incapable of protecting metals from the side reactions with the electrolyte.

Thus, many research efforts have been devoted to resolving these issues using porous scaffolds, artificial SEI layers, and solid-state electrolytes (SSEs). In particular, solid-state LMBs based on inorganic or organic SSEs have emerged as a promising candidate as they offer a substantial improvement in safety by eliminating the flammable organic solvents. Considering the compatibility with the current roll-to-roll-based manufacturing process of Li-ion batteries, solid polymer electrolytes (SPEs) have attracted great interest because of their low manufacturing cost, non-toxicity, and relatively soft nature that enables the formation of a smooth interface with the electrodes. Among the various polymers, poly(ethylene oxide) (PEO)-based SPEs have been the subject of intensive research; however, these polymers do not exhibit sufficient ionic conductivity and stability for the stable operation of LMBs. A common approach to improving ionic conductivity is incorporating additives, such as organic and inorganic fillers, into the polymer matrix to form a gel or hybrid SPEs.

However, the ionic conductivity and/or mechanical properties of these gel and hybrid SPEs should be further enhanced for viability in high-energy LMBs. Elastomers, synthetic rubbers, are widely used in consumer products and advanced technologies (wearable electronics and soft robotics) due to their superior mechanical properties. Elastomers can provide an excellent matrix to disperse functional components while maintaining both mechanical elasticity and functionality. For example, the important functionalities of the blends, such as electrical and ionic conductivities, can be well maintained when dispersed components are three-dimensionally connected within an elastomer matrix. Polymerization-induced phase separation (PIPS) is a process that controls the domain size and connectivity of phase-separated structures, allowing the formation of co-continuous nanostructures. However, no attempt has been made to develop an ion-conducting phase within an elastomeric system using PIPS.

Thus, new approaches to providing stable solid-polymer electrolytes and batteries utilizing the same and methods of making the same are needed. These needs and other needs are at least partially satisfied by the present disclosure.

### SUMMARY

The present disclosure is directed to a polymer composition comprising: a) a matrix comprising an elastomeric polymer; b) a plurality of plastic crystals dispersed with the matrix to form a three-dimensional interconnected phase of plastic crystals, and wherein the polymer composition exhibits an ionic conductivity of at least about 1.1 mS/cm at about 20° C.

The disclosure is further directed to a polymer composition formed by polymerizing a mixture comprising: a) one or more monomers of Formula (I), b) a plurality of plastic crystals; and c) a salt AB, wherein

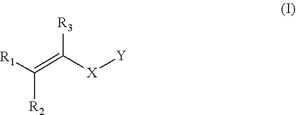

wherein R₁, R₂, and R₃, each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), (C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,

wherein X is C(O), O, or null,

wherein Y is OR₄, R₄, R₄′OR₄″, C(O)R₄, N(R₄)(R₄′″), or ON;

wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;

wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;

wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;

or wherein R₄″ is P(O)(OR₄″)₂;

wherein R₄″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl, wherein n is 1 to 200; wherein A is selected from Li, K, Na, Ca, Mg, Zn, Al, or a combination thereof; and B is selected from bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

Also disclosed herein are aspects where the mixture further comprises a cross-linker. In still further aspects, the cross-linker can comprise one or more of:

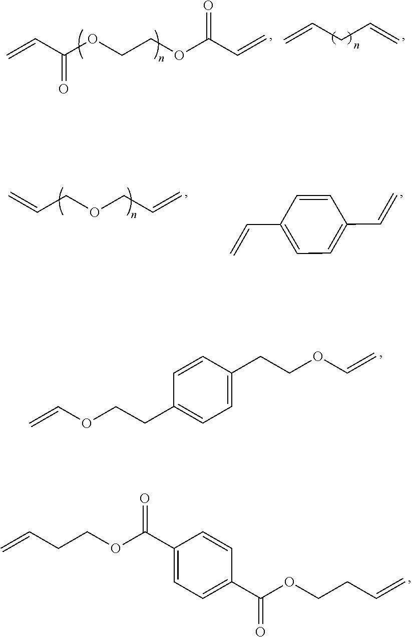

a combination thereof and wherein n is from 1 to 30.

In yet still, further aspects, the plurality of plastic crystals are derived from one or more:

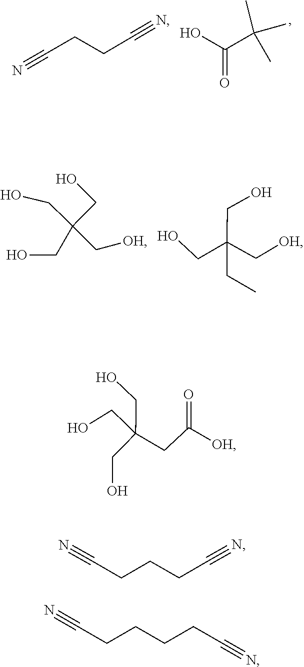

or a combination thereof.

Also disclosed herein are solid electrolytes comprising any of the disclosed herein polymer compositions.

Still further, the disclosure is directed to electrochemical cells comprising the solid electrolytes comprising the disclosed herein polymer compositions.

In some aspects disclosed herein, electrochemical cells comprise an anode electrode; and a cathode electrode; wherein the anode electrode and the cathode electrode are in electrical communication with any of the disclosed herein solid electrolytes. In such exemplary and unlimiting aspects, the metal material can comprise Li, Ca, Na, K, Mg, Zn, Al, alloys thereof, or a combination thereof. In yet still further aspects, the electrochemical cells disclosed herein comprise batteries.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### DESCRIPTION OF DRAWINGS

FIGS. 1A-1E depict the design of a plastic-crystal-embedded elastomer electrolyte. FIG. 1A depicts a schematic illustration of the design and structure for PCEE. The structure of PCEE shows that the 3D interconnected plastic crystal phase ( [symbol] ) is surrounded by the elastomer phase [symbol] . The plastic crystal phase supports a fast ion-conducting pathway, whereas the elastomer phase provides superior mechanical extensibility. FIG. 1B shows a 3D tomography image of PCEE constructed by an X-ray microscope. FIG. 1C shows a cross-sectional SEM image of PCEE film. FIG. 1D shows a cross-sectional TEM image of PCEE film. FIG. 1E shows electron energy-loss spectroscopy elemental mapping of the TEM image of FIG. 1D.

FIGS. 2A-2C depict the fabrication process of in situ-polymerized PCEE within the electrochemical cell. FIG. 2A shows digital photo images of a homogeneous solution consisting of BA, SBN, LiTFSI, PEGDA, and AIBN for built-in polymerization (left) and haze-colored PCEE on the bottom of a glass vial after polymerization at 70° C. for 2 h (right). FIG. 2B shows a photo image of PCEE showing mechanical elasticity. FIG. 2C shows a schematic illustration of the build-in polymerization process. The solution was injected into the electrochemical cells and then heated in an oven for build-in polymerization.

FIGS. 3A-3C show scanning electron microscopy (SEM) images of PCEE at different magnifications showing the detailed morphology.

FIG. 4 shows differential scanning calorimetry (DSC) measurements of BA100, SN 100, and built-in PCEE. The pristine elastomers (BA100), which were produced by the polymerization of BA and PEGDA, have a low glass transition temperature (T_{g}) of −32° C. SN 100 had a plastic crystal phase (positional order but orientational disorder) in the temperature range from −39° C. of the plastic crystal temperature (T_{PC}) to 25° C. of the melting temperature (Tₘ). Built-in PCEE exhibited thermal characteristics of both BA100 and SN100, indicating the separate formation of both phases.

FIGS. 5A-5D depict thermogravimetric analysis (TGA) measurements of BA100 (FIG. 5D), SN100 (FIG. 5C), and built-in PCEE (FIG. 5A-5B). The onset decomposition temperature of SN 100 was ˜105° C., which showed low thermal stability. In contrast, the thermal degradation of the BA100 started to occur at a high temperature of ˜316° C. PCEE showed improved thermal stability over pure SN 100, demonstrating the important role of elastomer as a protecting layer for the plastic crystal SN phase.

FIG. 6 depicts Fourier Transform Infrared Spectroscopy (FT-IR) spectra of BA-based solution, BA100, SN100, and built-in PCEE. Built-in PCEE showed the vibrational peaks originated from its main components (BA, SN, and LiTFSI). The vibrational peak corresponding to C≡N stretching of SN and built-in PCEE appeared at 2246 cm⁻¹. For built-in PCEE and BA100, the vibrational peak of C═O stretching (acrylate ester) appeared at 1736 cm⁻¹. The vibrational peak of C═C stretching of the BA monomer at 1620 cm⁻¹ disappeared due to the conversion from C═C to —C—C-through polymerization.

FIGS. 7A-7D depict a comparison of morphology, ion conductivity, and mechanical property between polymerization induced-PCEE and blend systems. FIG. 7A shows the morphology of PCEE. SEM image of PCEE shows the continuously-connected SN phases within the elastomeric matrix that was uniformly developed over a large area through PIPS. FIG. 7B shows a morphology of blend consisting of elastomeric polymer (cross-linked poly(butylacryIate) and PEGDA) and plastic crystal (SN) with LiTFSI. A blend is prepared from a mixture of elastomeric polymers and SN-LiTFSI in chloroform, followed by a drying process. The same weight ratios of BA, SN, PEGDA, and LiTFSI are used for constructing the PCEE and blend systems. SEM image of blend shows a macrophase separation with a length-scale of over μm. FIGS. 7C-7D compare ionic conductivity (FIG. 7C) and toughness (FIG. 7D) between the PCEE and blend systems.

FIGS. 8A-8F depict the properties of the built-in PCEE. FIG. 8A shows Arrhenius plots of the built-in PCEE and its components (BA100 and SN100) based on measurements of ionic conductivity (Q) versus temperature (T). FIG. 8B shows stress-strain curves of the built-in PCEE and BA100 at an extension rate of 100 mm min⁻¹. The tensile property of SN100 could not be measured owing to its brittleness. FIG. 8C shows photo images and schemes showing the ex-situ and the built-in PCEEs. FIG. 8D shows a cross-sectional SEM image of the built-in PCEE on the Li metal anode. FIG. 8E shows an interfacial adhesion test between the built-in PCEE and the Cu foil. The red dotted line indicates the average force per width. FIG. 8F shows Nyquist plots of as-prepared symmetric Li cells configured with various electrolytes. The solid lines correspond to the equivalent circuit fits.

FIG. 9 shows the ionic conductivity of the polymer electrolytes as a function of BA:SN (vol %) composition. The ionic conductivity was measured from BA100 (matrix phase) to SN100 (core phase) in gradual increments of 10 vol % of SN. The results showed that the ionic conductivity increased with increasing SN. The ionic conductivity was not maximized at the 5:5 point, but the increment in the conductivity after BA50SN50 (5:5 point) became relatively modest. Therefore, BA50SN50 was selected as the optimal composition by considering both the contributions of the elastomeric properties and the high ionic conductivity (˜10⁻³ S cm⁻¹).

FIG. 10 shows X-ray diffraction (XRD) spectra of BA100, SN 100, and PCEE.

FIG. 11 shows a flame retardant of PCEE. Photo images of flammability test on the PCEE.

FIG. 12 shows an interfacial adhesion test between ex-situ PCEE and Cu foil. The ex-situ PCEE was sandwiched between two pieces of Cu foil. Two free arms of Cu foils were stretched in a 180-degree peeling test. The adhesion energy was determined by the plateau value of the force per width demanded for the extension. The adhesion energy of ex-situ PCEE was only 2.7 J m⁻², which is lower by one order in magnitude compared to that of built-in PCEE (21.5 J m⁻²).

FIG. 13 shows the cumulative capacity of the symmetric Li cell with built-in PCEE. The symmetric Li cell was performed at a high current density of 10 mA cm⁻² with a capacity of 10 mAh cm⁻² for every Li plating/stripping (fraction of Li passed per cycle: 0.15) at 20° C.

FIGS. 14A-14J show built-in PCEE in symmetric Li and asymmetric Li∥Cu cells. FIG. 14A shows the cycling performance of the symmetric Li cells with various electrolytes. Insets: enlarged voltage profiles for different times. FIGS. 14B-14D show top-view SEM images of the Li metal anodes with SN100 after cell failure (FIG. 14B), ex-situ PCEE (FIG. 14C), and built-in PCEE (FIG. 14D) after 100 cycles at a current density of 10 mA cm-2 with a capacity of 10 mAh cm-2. Insets: magnified top-view SEM images. FIG. 14E shows coulombic efficiencies for the asymmetric Li∥Cu cells with the built-in PCEE at current densities of 2 mA cm-2 and 5 mA cm-2 with capacities of 4 mA cm-2 and 10 mAh cm-2, respectively. FIG. 14F shows corresponding enlarged voltage profiles. FIGS. 14G-14I show cross-sectional SEM images of pristine (FIG. 14G), Li-plated (FIG. 14H), and Li-stripped (FIG. 14I) Cu electrodes assembled with the built-in PCEE. FIG. 14J shows a schematic illustration of Li plating and stripping with different electrolytes.

FIGS. 15A-15F show electrochemical characterization for the symmetric Li cells with built-in PCEE. FIG. 15A shows time-dependent Nyquist plots of the symmetric Li cells configured with built-in PCEE. FIG. 15B shows Nyquist plots of the symmetric Li cells configured with built-in PCEE after 25, 75, and 100 cycles. FIG. 15C shows the cycling performance of the symmetric Li cells configured with built-in PCEE at different current densities. FIG. 15D shows voltage hysteresis of Li plating/stripping for built-in PCEE compared with previously reported literature data. FIG. 15E shows Nyquist plots of the symmetric Li cells before and after polarization of 10 mV. FIG. 15F shows the steady-state current measurement of the symmetric Li cells under 10 mV polarization for 10 h. EIS was measured at an open-circuit voltage in the range of 105 to 10° Hz with an amplitude of 10 mV.

FIG. 16 shows an equivalent circuit for modeling Nyquist plots of symmetric Li cells.

FIG. 17 shows the characterization of the SEI components on the cycled Li metal anodes with built-in PCEE and SN 100 by XPS. The high-resolution Li 1 s, C 1 s, O 1 s, N 1 s, and F 1 s XPS spectra of the Li metal anodes were measured after 100 cycles of the symmetric Li cells with built-in PCEE and SN100 at a current density of 1 mA cm⁻² with a capacity of 1 mAh cm⁻².

FIGS. 18A-18B show the cycling performance of the asymmetric Li∥Cu cells configured with SN 100. FIG. 18A shows coulombic efficiencies as a function of cycle number at 0.5 mA cm⁻² with 1 mA cm⁻². FIG. 18B shows corresponding Li stripping and plating profiles.

FIGS. 19A-19C show Li plating and stripping behavior of built-in PCEE on bare Cu. FIG. 19A shows the cycling performance of the asymmetric Li∥Cu cells at current densities of 0.5 and 1 mA cm⁻², respectively. FIGS. 19B-19C show Li stripping and plating profiles for built-in PCEE at a current density of 0.5 mA cm⁻² with a capacity of 1 mAh cm⁻² (FIG. 19B) and a current density of 1 mA cm⁻² with a capacity of 2 mAh cm⁻² (FIG. 19C).

FIGS. 20A-20C show electrochemical stability of built-in PCEE paired with high-voltage NMC-622 cathode. FIG. 20A shows an electrochemical floating experiment was performed using Li∥NMC-622 with built-in PCEE. The cell was charged to 4.2 Vat 0.2C (1 C=180 mA g⁻¹) and then held at gradually higher voltages for 10 h up to 4.7 V. FIG. 20B shows the rate capability of the full cell (35-μm-thick Li anode; 25-μm-thick built-in PCEE; high-loading NMC-622 (9.7 mg cm⁻²) in the voltage range of 2.7-4.5 V at equal current densities. (Inset: the capacity utilization at different areal current densities). FIG. 20C shows the cycling performance of the full cell (excess Li; 25-μm-thick built-in PCEE; NMC-622 (2.1 mg cm⁻²)) as a function of cycle number in the voltage range of 2.7-4.5 V. The cell maintained a high capacity of ˜140 mAh g-1 (82% capacity retention) with high CEs of 99.5% for 100 cycles, confirming the stable operation at high voltage. Cells were performed at 20° C.

FIG. 21 illustrates electrochemical oxidative stability. Linear sweep voltammetry (LSV) profiles of BA100, SN100, and built-in PCEE in Li∥stainless steel cell at a scan rate of 1 mV s⁻¹ (Inset: enlarged LSV profiles in the potential range of 4 to 5.5 V).

FIGS. 22A-22B show the cycling performance of the Li∥LiFePO4 cell at 1 C without voltage holding. FIG. 22A shows capacity and Coulombic efficiency as a function of cycle number. FIG. 22B shows corresponding voltage profiles. 1 C=170 mA g⁻¹.

FIGS. 23A-23B show electrochemical performances of the full cells with high-voltage NMC-83 cathode. FIG. 23A shows the charge and discharge profiles of the full cell in the voltage range of 2.7-4.3V at 0.1 mA cm⁻². FIG. 23B shows temperature-dependent voltage profiles of the full cell charged/discharged at equal temperatures (60 to 0° C.) in the voltage range of 2.7-4.5 V. (Inset: the capacity utilization at different temperatures). All full cells were configured with 35-μm-thick Li anode; 25-μm-thick built-in PCEE; high-loading NMC-83 (>10 mg cm⁻²).

FIGS. 24A-24D show Towards a high-energy all-solid-state LMB with elastomeric electrolyte. FIG. 24A shows the cycling performance of the full cell as a function of cycle number in the voltage range of 2.7-4.3 V. The cell was initially cycled at a current density of 0.1 mA cm⁻² for 3 cycles before cycling at 0.5 mA cm⁻². FIG. 24B shows the rate capability of the full cell in the voltage range of 2.7-4.5 V at equal current densities. Inset shows the capacity utilization at different areal current densities. FIG. 24C shows the Ragone plot for the full cells at ambient temperature (20-30° C.). Specific energy and power in the respective references are depicted within the light-shaded regions (blue polymer/composite electrolyte; grey, inorganic electrolyte). Specific energy and power are normalized by the mass of the cells (anode, solid electrolyte, and cathode), excluding the weight of the cell casing and current collectors. FIG. 24D shows a schematic illustration of all-solid-state LMB that comprises a thin Li metal anode, thin built-in PCEE, and high-loading NMC-83. The full cell with the built-in PCEE shows higher specific energy than the typical full cells listed in FIG. 25. All full cells were configured with 35-μm-thick Li anode, 25-μm-thick built-in PCEE, and high-loading NMC-83 (>10 mg cm⁻²).

FIG. 25 shows a comparison of battery performance with previously reported solid-state LMBs.

FIGS. 26A-26D shows the schematic procedure with digital photo images for the preparation of PCEE. The PCEE was prepared in four steps. First, a BA100 solution consisting of BA (monomer), PEGDA (cross-linker), AIBN (thermal initiator), and LiTFSI (salt) was prepared. After dissolving PEGDA, AIBN, and LiTFSI in BA (liquid state), the solution was stirred at room temperature for 1 h to ensure uniform mixing. Second, an SN100 solution consisting of SN (plastic crystal) and LiTFSI (salt) was prepared. SN was in a crystal state at room temperature, and LiTFSI was subsequently mixed with SN. To prevent side-reactions of SN with Li metal, 5 vol % fluoroethylene carbonate was also added. Then, these components were stirred at 50° C. for 1 h to prepare a homogeneous solution. In the third step, the BA100 and SN100 solutions were combined by controlling the volume ratio. For BA50SN50, the volume ratio of BA100 and SN100 solutions was 1:1. Finally, the solution was stirred at 5000 for 1 h and then polymerized at 70° C. for 2 h, resulting in the formation of PCEE.

FIGS. 27A-27B show galvanostatic charge/discharge profile of LiNi0.88Co0.09Al0.03O2 (NCA-88) at 0.2 C (FIG. 27A) and cycling performance of the full cell (Li//Built-in PCEE//NCA-88) as a function of cycle number at 0.2 C in the voltage range of 2.7-4.3 V (1 C=190 mA g⁻¹) (FIG. 27B)

FIG. 28 shows conductivity as a function of temperature for PCEE systems with mono- (Li, Na, and K), di- (Mg and Zn), and trivalent cations (Al).

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### DEFINTIONS

As used herein, the terms “optional” or “optionally” means that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a monomer” includes two or more monomers, reference to “a battery” includes two or more such batteries, and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise. It is further understood that these phrases are used for explanatory purposes only. It is further understood that the term “exemplary” as used herein means “an example of” and is not intended to convey an indication of a preferred or ideal aspect.

The term “or” means “and/or.” Recitation of ranges of values is merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

Recitation of ranges of values herein is merely intended to serve as a shorthand method of referring individually to each separate value recited or falling within the range, unless otherwise indicated herein, and each separate value is incorporated into the specification as if it were individually recited. Ranges provided herein are understood to be shorthand for all of the values within the range. For example, a range of 1 to 50 is understood to include any number, combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

The organic moieties mentioned when defining variable positions within the general formulae described herein (e.g., the term “halogen”) are collective terms for the individual substituents encompassed by the organic moiety. The prefix Cₙ₋ₘ preceding a group or moiety indicates, in each case, the possible number of carbon atoms in the group or moiety that follows.

The term “ion,” as used herein, refers to any molecule, portion of a molecule, a cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, a portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), a cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), a cluster of molecules, molecular complex, moiety, or atom, containing a net positive charge or that can be made to contain a net positive charge. The term “cation precursor” is used herein to specifically refer to a molecule that can be converted to a cation via a chemical reaction (e.g., protonation or alkylation).

As used herein, the term “substituted” means that a hydrogen atom is removed and replaced by a substituent. It is contemplated to include all permissible substituents of organic compounds. As used herein, the phrase “optionally substituted” means unsubstituted or substituted. It is understood that substitution at a given atom is limited by valency. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein, which satisfy the valencies of the heteroatoms. This disclosure is not intended to be limited in any manner by the permissible substituents of organic compounds. Also, the terms “substitution” or “substituted with” include the implicit proviso that such substitution is in accordance with a permitted valence of the substituted atom and the substituent and that the substitution results in a stable compound, e.g., a compound that does not spontaneously undergo transformation such as by rearrangement, cyclization, elimination, etc. In still further aspects, it is understood that when the disclosure describes a group being substituted, it means that the group is substituted with one or more (i.e., 1, 2, 3, 4, or 5) groups as allowed by valence selected from alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

“Z¹,” “Z²,” “Z³,” and “Z⁴” are used herein as generic symbols to represent various specific substituents. In certain aspects, the generic symbols to represent various specific substituents can be marked as “R¹,” “R²,” “R³,” or “Rn,” wherein n is a subsequent number of substituents. These symbols can be any substituent, not limited to those disclosed herein, and when they are defined to be certain substituents in one instance, they can, in another instance, be defined as some other substituents.

The expressions “ambient temperature” and “room temperature” as used herein are understood in the art and refer generally to a temperature, e.g., a reaction temperature, that is about the temperature of the room in which the reaction is carried out, for example, a temperature from about 20° C. to about 30° C.

A dash (“-”) that is not between two letters or symbols is used to indicate a point of attachment for a substituent. For example, —(C═O)NH₂ is attached through carbon of the keto (C═O) group.

The term “aliphatic,” as used herein, refers to a non-aromatic hydrocarbon group and includes branched and unbranched, alkyl, alkenyl, or alkynyl groups. As used herein, the term “Cₙ-Cₘ alkyl” (or “Cₙ₋ₘ”) employed alone or in combination with other terms refers to a saturated hydrocarbon group that may be straight-chain or branched, having n to m carbons. It is understood that the terms Cₙ₋ₘ and Cₙ-Cₘ can be used interchangeably and just to show that the specific compound has between n to m carbons. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl moieties include, but are not limited to, chemical groups such as methyl, ethyl, n-propyl, isopropyl, n-butyl, teri-butyl, isobutyl, sec-butyl; higher homologs such as 2-methyl-I-butyl, n-pentyl, 3-pentyl, n-hexyl, 1,2,2-trimethylpropyl, heptyl, octyl, nonyl, decyl, dodecyl, tetradecyl, hexadecyl, eicosyl, tetracosyl, and the like. The alkyl group can also be substituted or unsubstituted. Throughout the specification, “alkyl” is generally used to refer to both unsubstituted alkyl groups and substituted alkyl groups; however, substituted alkyl groups are also specifically referred to herein by identifying the specific substituent(s) on the alkyl group. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below, provided that the substituents are sterically compatible and the rules of chemical bonding and strain energy are satisfied.

The term “heteroaliphatic” refers to an aliphatic moiety that contains at least one heteroatom in the chain, for example, an amine, carbonyl, carboxy, oxo, thio, phosphate, phosphonate, nitrogen, phosphorus, silicon, or boron atoms in place of a carbon atom. In certain embodiments, the only heteroatom is nitrogen. In certain embodiments, the only heteroatom is oxygen. In certain embodiments, the only heteroatom is sulfur. “Heteroaliphatic” is intended herein to include, but is not limited to, heteroalkyl, heteroalkenyl, heteroalkynyl, heterocycloalkyl, heterocycloalkenyl, and heterocycloalkynyl moieties. In certain embodiments, “heteroaliphatic” is used to indicate a heteroaliphatic group (cyclic, acyclic, substituted, unsubstituted, branched, or unbranched) having 1-20 carbon atoms. In certain embodiments, the heteroaliphatic group is optionally substituted in a manner that results in the formation of a stable moiety. Nonlimiting examples of heteroaliphatic moieties are polyethylene glycol, polyalkylene glycol, amide, polyamide, polylactide, polyglycolide, thioether, and ether, alkyl-heterocycle-alkyl, —O-alkyl-O-alkyl, alkyl-O-haloalkyl, etc.

Throughout the specification, “alkyl” is generally used to refer to both unsubstituted alkyl groups and substituted alkyl groups; however, substituted alkyl groups are also specifically referred to herein by identifying the specific substituent(s) on the alkyl group.

For example, the term “halogenated alkyl” specifically refers to an alkyl group that is substituted with one or more halides, e.g., fluorine, chlorine, bromine, or iodine. Haloalkyl” is a branched or straight-chain alkyl group substituted with 1 or more halo atoms described above, up to the maximum allowable number of halogen atoms. Examples of haloalkyl groups include, but are not limited to, fluoromethyl, difluoromethyl, trifluoromethyl, chloromethyl, dichloromethyl, trichloromethyl, pentafluoroethyl, heptafluoropropyl, difluorochloromethyl, dichlorofluoromethyl, difluoroethyl, difluoropropyl, dichloroethyl and di chloropropyl. “Perhaloalkyl” means an alkyl group having all hydrogen atoms replaced with halogen atoms. Examples include but are not limited to trifluoromethyl and pentafluoroethyl.

The term “alkoxyalkyl” specifically refers to an alkyl group that is substituted with one or more alkoxy groups, as described below. The term “alkylamino” specifically refers to an alkyl group that is substituted with one or more amino groups, as described below and the like. When “alkyl” is used in one instance, and a specific term such as “alkylalcohol” is used in another, it is not meant to imply that the term “alkyl” does not also refer to specific terms such as “alkylalcohol” and the like.

As used herein, “Cₙ-Cₘ alkenyl” refers to an alkyl group having one or more double carbon-carbon bonds and having n to m carbons. Alkenyls can be straight-chained or branched. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Examples of alkenyl groups include, but are not limited to, ethenyl, n-propenyl, isopropenyl, n-butenyl, seobutenyl, and the like. In various aspects, the alkenyl moiety contains 2 to 6, 2 to 4, or 2 to 3 carbon atoms. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, cyano, silyl, sulfo-oxo, sulfonyl, sulfone, sulfoxide, thiol, thiol, or phosphonyl, as described below.

As used herein, “Cₙ-Cₘ alkynyl” refers to an alkyl group having one or more triple carbon-carbon bonds and having n to m carbons. Alkynyls can be straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₀₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. In various aspects, the alkynyl moiety contains 2 to 6, 2 to 4, or 2 to 3 carbon atoms. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, cyano, silyl, sulfo-oxo, sulfonyl, sulfone, sulfoxide, thiol, or phosphonyl, as described below.

As used herein, the term “Cₙ-Cₘ alkylene,” employed alone or in combination with other terms, refers to a divalent alkyl linking group having n to m carbons. Examples of alkylene groups include, but are not limited to, ethan-1,2-diyl, propan-1,3-diyl, propan-1,2-diyl, butan-1,4-diyl, butan-1,3-diyl, butan-1,2-diyl, 2-methyl-propan-1,3-diyl, and the like. In various aspects, the alkylene moiety contains 2 to 6, 2 to 4, 2 to 3, 1 to 6, 1 to 4, or 1 to 2 carbon atoms.

As used herein, the term “Cₙ-Cₘ alkoxy,” employed alone or in combination with other terms, refers to a group of formula —O-alkyl, wherein the alkyl group has n to m carbons. In other words, the term alkoxy, as used herein, is an alkyl group bound through a single, terminal ether linkage; that is, an “alkoxy” group can be defined as a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy. In other aspects, an example of alkoxy groups includes methoxy, ethoxy, propoxy (e.g., w-propoxy and isopropoxy), teri-butoxy, and the like. In various aspects, the alkyl group has 1 to 6, 1 to 4, or 1 to 3 carbon atoms.

The term “cyclic group” is used herein to refer to either aryl groups or non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

As used herein, “aryl” refers to a radical of a monocyclic or polycyclic (e.g., bicyclic or tricyclic) 4n+2 aromatic ring system (e.g., having 6, 10, or 14 it electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more cycloalkyl or heterocycle groups wherein the radical or point of attachment is on the aryl ring, and in such instances, the number of carbon atoms continues to designate the number of carbon atoms in the aryl ring system. The one or more fused cycloalkyl or heterocycle groups can be 4 to 7-membered saturated or partially unsaturated cycloalkyl or heterocycle groups.

“Arylalkyl” refers to either an alkyl group as defined herein substituted with an aryl group as defined herein or to an aryl group as defined herein substituted with an alkyl group as defined herein.

The term “heterocycle” denotes saturated and partially saturated heteroatom-containing ring radicals wherein there are 1, 2, 3, or 4 heteroatoms independently selected from nitrogen, sulfur, boron, silicone, and oxygen. Heterocyclic rings may comprise monocyclic 3-10 membered rings, as well as 5-16 membered bicyclic ring systems (which can include bridged, fused, and spiro-fused bicyclic ring systems). It does not include rings containing —O—O—, —O—S— or —S—S— portions. Examples of saturated heterocycle groups include saturated 3- to 6-membered heteromonocyclic groups containing 1 to 4 nitrogen atoms [e.g., pyrrolidinyl, imidazolidinyl, piperidinyl, pyrrolinyl, piperazinyl]; saturated 3 to a 6-membered heteromonocyclic group containing 1 to 2 oxygen atoms and 1 to 3 nitrogen atoms [e.g., morpholinyl]; saturated 3 to 6-membered heteromonocyclic group containing 1 to 2 sulfur atoms and 1 to 3 nitrogen atoms [e.g., thiazolidinyl]. Examples of partially saturated heterocycle radicals include but are not limited to dihydrothienyl, dihydropyranyl, dihydrofuryl, and dihydrothiazolyl. Examples of partially saturated and saturated heterocycle groups include but are not limited to pyrrolidinyl, imidazolidinyl, piperidinyl, pyrrolinyl, pyrazolidinyl, piperazinyl, morpholinyl, tetrahydropyranyl, thiazolidinyl, dihydrothienyl, 2,3-dihydro-benzo[1,4]dioxanyl, indolinyl, isoindolinyl, dihydrobenzothienyl, dihydrobenzofuryl, isochromanyl, chromanyl, 1,2-dihydroquinolyl, 1,2, 3, 4-tetrahydro-isoquinolyl, 1,2,3,4-tetrahydro-quinolyl, 2, 3, 4, 4a, 9,9a-hexahydro-1H-3-aza-fluorenyl, 5,6,7-trihydro-1, 2, 4-triazolo[3,4-a]isoquinolyl, 3,4-dihydro-2H-benzo[1,4]oxazinyl, benzo[I,4]dioxanyl, 2,3-dihydro-1H—Iλ′-benzo[d]isothiazol-6-yl, dihydropyranyl, dihydrofuryl, and dihydrothiazolyl.

“Heterocycle” also includes groups wherein the heterocyclic radical is fused/condensed with an aryl or carbocycle radical, wherein the point of attachment is the heterocycle ring. “Heterocycle” also includes groups wherein the heterocyclic radical is substituted with an oxo group

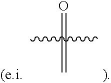 [SMILES: *=O]

For example, a partially unsaturated condensed heterocyclic group containing 1 to 5 nitrogen atoms, for example, indoline or isoindoline; a partially unsaturated condensed heterocyclic group containing 1 to 2 oxygen atoms and 1 to 3 nitrogen atoms; a partially unsaturated condensed heterocyclic group containing 1 to 2 sulfur atoms and 1 to 3 nitrogen atoms; and a saturated condensed heterocyclic group containing 1 to 2 oxygen or sulfur atoms.

The term “heterocycle” also includes “bicyclic heterocycle.” The term “bicyclic heterocycle” denotes a heterocycle as defined herein wherein there is one bridged, fused, or spirocyclic portion of the heterocycle. The bridged, fused, or spirocyclic portion of the heterocycle can be a carbocycle, heterocycle, or aryl group as long as a stable molecule result. Unless excluded by context, the term “heterocycle” includes bicyclic heterocycles. Bicyclic heterocycle includes groups wherein the fused heterocycle is substituted with an oxo group. Non-limiting examples of bicyclic heterocycles include:

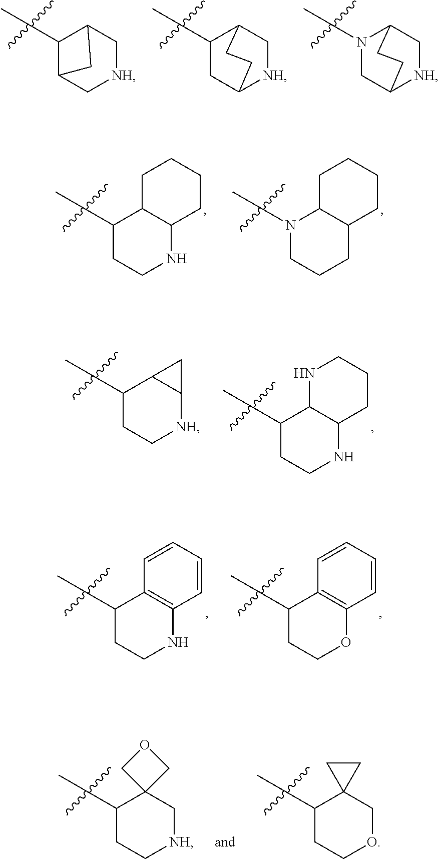

“Heterocyclealkyl” refers to either an alkyl group as defined herein substituted with a heterocycle group as defined herein or to a heterocycle group as defined herein substituted with an alkyl group as defined herein.

The term “heteroaryl” denotes stable aromatic ring systems that contain 1, 2, 3, or 4 heteroatoms independently selected from O, N, and S, wherein the ring nitrogen and sulfur atom(s) are optionally oxidized, and the nitrogen atom(s) are optionally quarternized. Examples include but are not limited to, unsaturated 5 to 6 membered heteromonocyclyl groups containing 1 to 4 nitrogen atoms, such as pyrrolyl, imidazolyl, pyrazolyl, 2-pyridyl, 3-pyridyl, 4-pyridyl, pyrimidyl, pyrazinyl, pyridazinyl, triazolyl [e.g., 4H—I,2,4-triazolyl, H4-1,2,3-triazolyl, 2H—I,2,3-triazolyl]; unsaturated 5- to 6-membered heteromonocyclic groups containing an oxygen atom, for example, pyranyl, 2-furyl, 3-furyl, etc.; unsaturated 5 to 6-membered heteromonocyclic groups containing a sulfur atom, for example, 2-thienyl, 3-thienyl, etc.; unsaturated 5- to 6-membered heteromonocyclic groups containing 1 to 2 oxygen atoms and 1 to 3 nitrogen atoms, for example, oxazolyl, isoxazolyl, oxadiazolyl [e.g., 1,2,4-oxadiazolyl, 1,3,4-oxadiazolyl, 1,2,5-oxadiazolyl]; unsaturated 5 to 6-membered heteromonocyclic groups containing 1 to 2 sulfur atoms and 1 to 3 nitrogen atoms, for example, thiazolyl, thiadiazolyl [e.g., 1,2,4-thiadiazolyl, 1,3,4-thiadiazolyl, 1,2,5-thiadiazolyl], In certain embodiments the “heteroaryl” group is a 8, 9, or 10 membered bicyclic ring system. Examples of 8, 9, or 10 membered bicyclic heteroaryl groups include benzofurazanyl, benzothiophenyl, benzothiazolyl, benzoxazolyl, quinazolinyl, quinoxalinyl, naphthyridinyl, quinolinyl, isoquinolinyl, benzofuranyl, indolyl, indazolyl, and benzotriazolyl.

“Heteroaryl alkyl” refers to either an alkyl group as defined herein substituted with a heteroaryl group as defined herein or to a heteroaryl group as defined herein substituted with an alkyl group as defined herein.

As used herein, “carbocyclic,” “carbocycle,” or “cycloalkyl” includes a saturated or partially unsaturated (i.e., not aromatic) group containing all carbon ring atoms and from 3 to 14 ring carbon atoms (“C3-14 cycloalkyl”) and zero heteroatoms in the non-aromatic ring system. In some embodiments, a cycloalkyl group has 3 to 10 ring carbon atoms (“C3-10 cycloalkyl”). In some embodiments, a cycloalkyl group has 3 to 9 ring carbon atoms (“C3-9 cycloalkyl”). In some embodiments, a cycloalkyl group has 3 to 8 ring carbon atoms (“C3-8 cycloalkyl”). In some embodiments, a cycloalkyl group has 3 to 7 ring carbon atoms (“C3-7 cycloalkyl”). In some embodiments, a cycloalkyl group has 3 to 6 ring carbon atoms (“C3-6 cycloalkyl”). In some embodiments, a cycloalkyl group has 4 to 6 ring carbon atoms (“C4-6 cycloalkyl”). In some embodiments, a cycloalkyl group has 5 to 6 ring carbon atoms (“C5-6 cycloalkyl”). In some embodiments, a cycloalkyl group has 5 to 10 ring carbon atoms (“C5-10 cycloalkyl”). Exemplary C3-6 cycloalkyl groups include, without limitation, cyclopropyl (C3), cyclopropenyl (C3), cyclobutyl (C4), cyclobutenyl (C4), cyclopentyl (C5), cyclopentenyl (C5), cyclohexyl (C6), cyclohexenyl (C6), cyclohexadienyl (C7), and the like. Exemplary C3-8 cycloalkyl groups include, without limitation, the aforementioned C3-6 cycloalkyl groups as well as cycloheptyl (C7) and cycloheptenyl (C7), cycloheptadienyl (C7), cycloheptatrienyl (C7), cyclooctyl (C8), cyclooctenyl (C8), and the like. Exemplary C3-10 cycloalkyl groups include, without limitation, the aforementioned C3-8 cycloalkyl groups as well as cyclononyl (C9) and cyclononenyl (C9), cyclodecyl (C10), cyclodecenyl (C10), and the like. As the foregoing examples illustrate, in certain embodiments, the cycloalkyl group can be saturated or can contain one or more carbon-carbon double bonds. The term “cycloalkyl” also includes ring systems wherein the cycloalkyl ring, as defined above, is fused with one heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes ring systems wherein the cycloalkyl ring, as defined above, has a spirocyclic heterocycle, aryl, or heteroaryl ring wherein the point of attachment is on the cycloalkyl ring, and in such instances, the number of carbons continues to designate the number of carbons in the carbocyclic ring system. The term “cycloalkyl” also includes bicyclic or polycyclic fused, bridged, or spiro ring systems that contain from 5 to 14 carbon atoms and zero heteroatoms in the non-aromatic ring system. Representative examples of “cycloalkyl” include, but are not limited to,

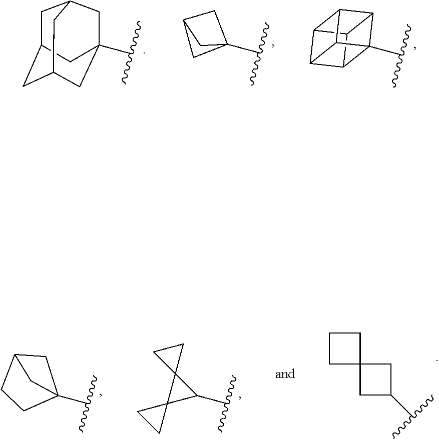 [SMILES: *C12CC3CC(CC(C3)C1)C2 ; *C12CC(C1)C2 ; *C12C3C4C5C3C1C5C42 ; *C12CCC(C1)C2 ; *C1C2(CC2)C12CC2 ; *C1CC2(CCC2)C1]

The term “bicycle” refers to a ring system wherein two rings are fused together, and each ring is independently selected from carbocycle, heterocycle, aryl, and heteroaryl. Non-limiting examples of bicycle groups include:

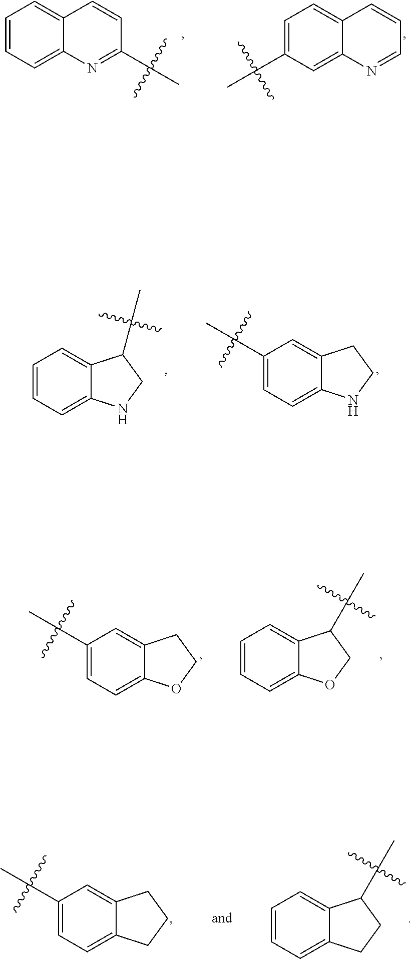

The terms “amine” or “amino” as used herein are represented by the formula —NR¹R², where R¹ and R² can each be substitution groups as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is —C(O)NR¹R².

The term “anhydride” as used herein is represented by the formula Z¹C(O)OC(O)Z²‘ where Z’ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride” as used herein is represented by the formula:

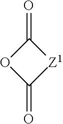

where Z¹ can be an alkyl, alkenyl, alkynyl, aryl, heteroaryl, cycloalkyl, cycloalkenyl, heterocycloalkyl, or heterocycloalkenyl group described above.

The term “azide” as used herein is represented by the formula —N═N═N.

The term “aldehyde” as used herein is represented by the formula —C(O)H. Throughout this specification, “C(O)” or “CO” is a shorthand notation for C═O, which is also referred to herein as a “carbonyl.”

The term “carboxylic acid” as used herein is represented by the formula —C(O)OH. A “carboxylate” or “carboxyl” group as used herein is represented by the formula —C(O)O⁻.

The term “ester” as used herein is represented by the formula —OC(O)R¹ or —C(O)OR¹, where R¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula R¹OR², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three atom ring and can be represented by the formula:

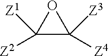

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above.

The term “ketone” as used herein is represented by the formula R¹C(O)R², where R¹ and R² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide” as used herein comprises the formula —S—.

As used herein, the term “thio” refers to a group of formulas —SH.

As used herein, the term “Cₙ-Cₘ alkylthio” refers to a group of formula —S-alkyl, wherein the alkyl group has n to m carbon atoms. In various aspects, the alkyl group has 1 to 6, 1 to 4, or 1 to 3 carbon atoms.

As used herein, the term “Cₙ-Cₘ alkylsulfonyl” refers to a group of formula —S(O)-alkyl, wherein the alkyl group has n to m carbon atoms. In various aspects, the alkyl group has 1 to 6, 1 to 4, or 1 to 3 carbon atoms.

As used herein, the term “Cₙ-Cₘ alkylsulfonyl” refers to a group of formula —S(O)₂-alkyl, wherein the alkyl group has n to m carbon atoms. In various aspects, the alkyl group has 1 to 6, 1 to 4, or 1 to 3 carbon atoms.

As used herein, the term “carbamyl” refers to a group of formula —C(O)NH₂.

As used herein, the term “carbonyl,” employed alone or in combination with other terms, refers to a —C(═O)— group, which may also be written as C(O).

As used herein, the term “carboxy” refers to a group of formula —C(O)OH.

As used herein, “halogen” refers to F, Cl, Br, or I.

The term “sulfonylamino” or “sulfonamide” as used herein is represented by the formula —S(O)₂NH—.

“R¹,” “R²,” “R³,” “Rn,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within the second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated contrary, a formula with chemical bonds shown only as solid lines and not as wedges or dashed lines contemplates each possible stereoisomer or a mixture of stereoisomer (e.g., each enantiomer, each diastereomer, each meso compound, a racemic mixture, or scalemic mixture).

“Phase,” as used herein, generally refers to a region of a material having a substantially uniform composition which is a distinct and physically separate portion of a heterogeneous system. The term “phase” does not imply that the material making up a phase is a chemically pure substance but merely that the chemical and/or physical properties of the material making up the phase are essentially uniform throughout the material and that these chemical and/or physical properties differ significantly from the chemical and/or physical properties of another phase within the material. Examples of physical properties include density, thickness, aspect ratio, specific surface area, porosity, dimensionality, stretchability, modulus, and ionic conductivity. Examples of chemical properties include chemical composition.

The term “olefinically unsaturated group” or “ethylenically unsaturated group” is employed herein in a broad sense and is intended to encompass any groups containing a carbon-carbon double-bonded group (>C═C<group). Exemplary ethylenically unsaturated groups include, but are not limited to, (meth)acrylate, (meth)acrylamide, (meth)acryloyl, allyl, vinyl, styrenyl, or other >C═C<containing groups.

“Polymer” means a material formed by polymerizing one or more monomers.

The term “(co)polymer” includes homopolymers, copolymers, or mixtures thereof.

The term “(meth)acryl . . . ” includes “acryl . . . ,” “methacryl . . . ,” or mixtures thereof.

The term prepolymer is used herein to refer to a polymer that has reactive groups that are available for bond-forming reactions that will crosslink (intermolecular and/or intramolecular crosslink). It is not meant to imply that the prepolymer is not yet a polymer (e.g., a monomer or polymer precursor). Rather, a “prepolymer” refers to a starting polymer which contains multiple crosslinkable groups and can be cured (e.g., crosslinked) to obtain a crosslinked polymer having a molecular weight higher than the starting polymer.

“Molecular weight” of a polymeric material (including monomeric or macro-monomeric materials), as used herein, refers to the number-average molecular weight as measured by ¹H NMR spectroscopy unless otherwise specifically noted or unless testing conditions indicate otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein, the term “and/or” includes any and all combinations of one or more of the associated listed items.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

In other aspects, as used herein, the term “substantially free,” when used in the context of a surface substantially free of defects or substantially free of dendrites, for example, is intended to refer to a surface that has less than about 5% of defects or dendrites, less than about 4.5% of defects or dendrites, less than about 4% of defects or dendrites, less than about 3.5% of defects or dendrites, less than about 3% of defects or dendrites, less than about 2.5% of defects or dendrites, less than about 2% of defects or dendrites, less than about 1.5% of defects or dendrites, less than about 1% of defects or dendrites, less than about 0.5% of defects or dendrites, less than about 0.1% of defects or dendrites, less than about 0.05% of defects, or less than about 0.01% of defects or dendrites of the total surface.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Polymer Compositions

As described above, in some aspects disclosed herein is polymer composition comprising: a) a matrix comprising an elastomeric polymer; b) a plurality of plastic crystals dispersed within the matrix to form a three-dimensional interconnected phase of plastic crystals, and wherein the polymer composition exhibits an ionic conductivity of at least about 1.1 mS/cm at about 20° C.

In some aspects, the polymer composition disclosed herein can exhibit an ionic conductivity from about 1.0 mS/cm to about 10 mS/cm, including exemplary values of about 1.5 mS/cm, about 2.0 mS/cm, about 2.5 mS/cm, about 3.0 mS/cm, about 3.5 mS/cm, about 4.0 mS/cm, about 4.5 mS/cm, about 5.0 mS/cm, about 5.5 mS/cm, about 6.0 mS/cm, about 6.5 mS/cm, about 7.0 mS/cm, about 7.5 mS/cm, about 8.0 mS/cm, about 8.5 mS/cm, about 9.0 mS/cm, and about 9.5 mS/cm. In still further aspects, the polymer composition disclosed herein can exhibit an ionic conductivity greater than about 1 mS/cm, greater than about 1.1 mS/cm, greater than about 1.2 mS/cm, greater than about 1.3 mS/cm, greater than about 1.4 mS/cm, greater than about 1.5 mS/cm, greater than about 1.6 mS/cm, greater than about 1.7 mS/cm, greater than about 1.8 mS/cm, greater than about 1.9 mS/cm, greater than about 2.0 mS/cm, greater than about 2.1 mS/cm, greater than about 2.2 mS/cm, greater than about 2.3 mS/cm, greater than about 2.4 mS/cm, greater than about 2.5 mS/cm, greater than about 2.6 mS/cm, greater than about 2.7 mS/cm, greater than about 2.8 mS/cm, greater than about 2.9 mS/cm, greater than about 3.0 mS/cm, greater than about 3.1 mS/cm, greater than about 3.2 mS/cm, greater than about 3.3 mS/cm, greater than about 3.4 mS/cm, greater than about 3.5 mS/cm, greater than about 3.6 mS/cm, greater than about 3.7 mS/cm, greater than about 3.8 mS/cm, greater than about 3.9 mS/cm, or even greater than about 4.0 mS/cm. In yet still further asepcts, the ionic conductivity of the disclosed herein polymer can be also greater than about 5.0 m S/cm.

In still further aspects, the elastomeric polymer can be derived from at least one monomer comprising

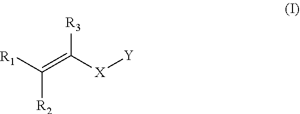

wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), (C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl, wherein X is C(O), O, or null, wherein Y is OR₄, R₄, R₄′OR₄″, C(O)R₄, N(R₄)(R₄′″), or ON; wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆-C₁₄ aryl), —(C₀₋₅ alkyl)(C₁-C₁₃ heteroaryl), —(C₀₋₅ alkyl)(C₆-C₁₄ aryloxy), —(C₀₋₅ alkyl)(C₃-C₁₀ cycloalkyl), —(C₀₋₅ alkyl)(C₃-C₁₀ heterocycloalkyl), —(C₀₋₅ alkyl)(C₃-C₁₀ cycloalkenyl), —(C₀₋₅ alkyl)(C₃-C₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl; or wherein R₄″ is P(O)(OR₄′″)₂;
wherein R₄′″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄′″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl, and wherein n is 1 to 200.

In still further aspects, n can be anywhere between 1 to 200, including exemplary values of 2, 5, 10, 15, 20, 30, 40, 50, 60, 70, 80, 90, 100, 110, 120, 130, 140, 150, 160, 170, 180, and 190. It is understood that any values between any two disclosed above values are also disclosed.

In still further aspects, R₁, R₂, and R₃, each is independently selected from hydrogen, C₁₋₅ alkyl, C₁₋₅ alkoxy, C₁₋₅ heteroalkyl, C₆₋₁₄ aryl, C₁₋₁₃ heteroaryl, C₆₋₁₄ aryloxy, C₃₋₁₀ cycloalkyl, C₃₋₁₀ heterocycloalkyl, C₃₋₁₀ cycloalkenyl, C₃₋₁₀ heterocycloalkenyl, halide, or amine. In yet still further aspects, R₁, R₂, and R₃ each is hydrogen. In yet still further aspects, at least one of R₁, R₂, and R₃ is hydrogen. In yet still further aspects, at least one of R₁, R₂, and R₃ is a halide. In still further aspects, at least one R₁, R₂, and R₃ is an amine. In yet still further aspects, any, none, or at least one of the R₁, R₂, and R₃ can be substituted by any of the disclosed above functional groups.

In still further aspects, when X is C(O), Y can be selected from OR₄, R₄′OR₄″, or N(R₄)(R₄′″). While in yet other aspects, when X is O, Y can be C(O)R₄. In still further aspects, when X is null, Y can be CN. It is understood that R₄, R₄′, R₄″, and R₄′″ can be independently selected from any of the disclosed above functional groups.

In still further exemplary and unlimiting aspects, the monomer of formula (I) can be selected from one or more of:

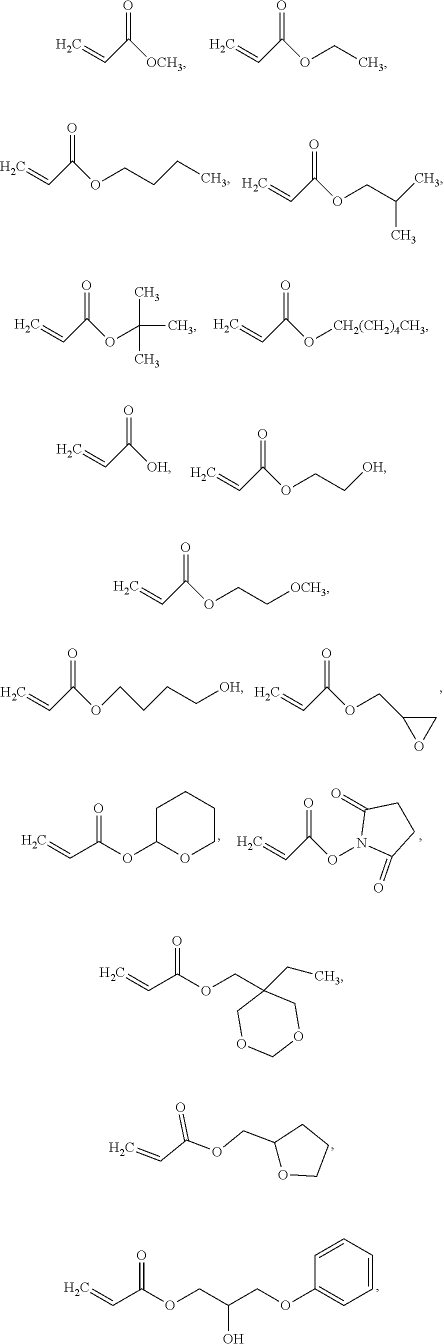

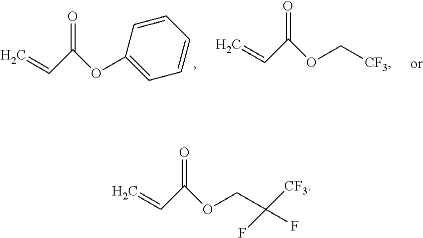

While yet in other aspects, the monomer (I) is selected from one or more of:

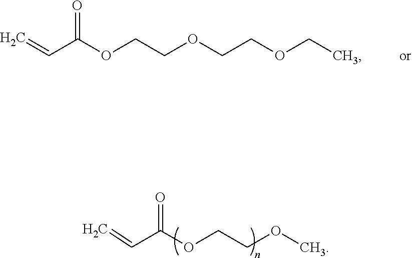

While in still further aspects, the monomer (I) is selected from one or more of:

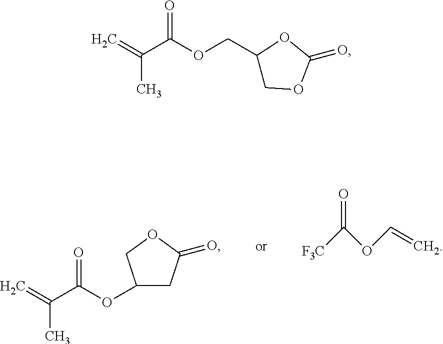

In still further aspects, the monomer (I) is selected from one or more of:

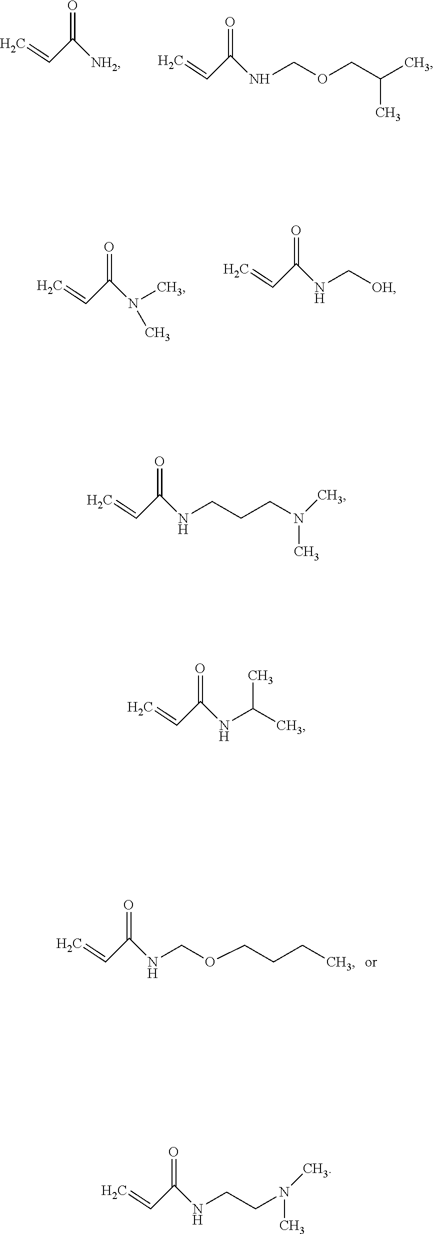

In still further aspects, the monomer (I) is selected from one or more of:

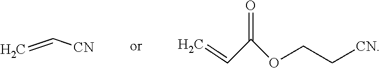

While in still further aspects, the monomer (I) can comprise

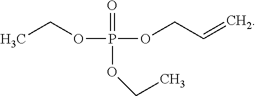

In still further aspects, the polymer composition comprises the plurality of plastic crystals. It is understood that the term plastic crystal refers to a crystal composed of weakly interacting molecules that possess some orientational and conformational degree of freedom. Plastic crystals can be considered a soft matter. Without wishing to be bound by any theory, it is understood that the plastic crystal exhibit strong long-range order.

In certain aspects, any known in the art plastic crystals suitable for the desired application can be used. In still further aspects, the plastic crystals can be selected

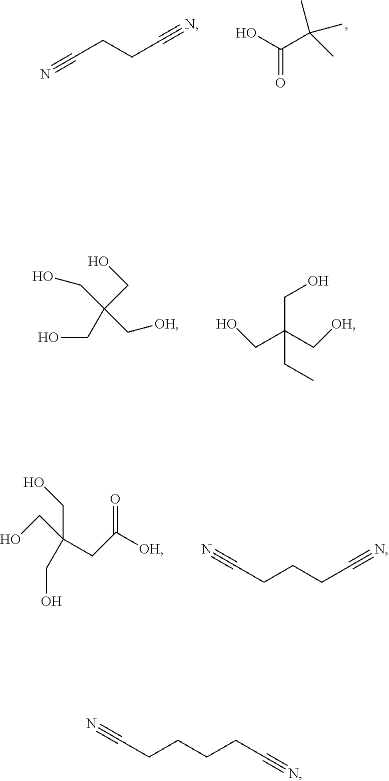

or a combination thereof.

In still further aspects, the polymer compositions disclosed herein can comprise a metal salt. It is understood that any metal salts suitable for the desired applications can be used. For example, in some aspects, the metal salts are alkali metal salts. Yet, in other aspects, the metal salts are alkaline-earth metal salts. Yet, in still further aspects, the metal salts can comprise post-transition metal salts. Yet, in still further aspects, the metal salts can comprise transition metal salts. In still further aspects, the metal salts can comprise any combination of any of the disclosed above metal salts.

In still further aspects, the polymer composition can comprise a metal salt, wherein a cation of metal salt comprises one or more of Li, K, Na, Ca, Mg, Zn, Al, or a combination thereof.

In still further aspects, an anion of the disclosed herein metal salts can comprise any inion that is suitable for the desired application. For example, the anion can be halide. In such aspects, halide can comprise I⁻, Cl⁻, Br⁻, or F⁻. In still further aspects, the anion of metal salt can comprise bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

In still further aspects, the metal salts can be present in an amount from 0 wt % to about 70 wt %, including exemplary values of about 0.01 wt %, about 0.05 wt %, about 0.1 wt %, about 0.5 wt %, about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, and about 66.9 wt % of the polymer composition

In still further aspects, the polymer composition disclosed herein is crosslinked. It is understood that the crosslinking can be covalent or ionic, or both. In yet still further aspects, the crosslinking can be achieved by any known in the art methods that are also discussed in more detail below. In some aspects, the crosslinking of the disclosed herein polymer can be achieved by adding a crosslinker during the polymerization process. In yet other aspects, crosslinking can be achieved by irradiation. In such aspects, irradiation can include IR, UV, or e-beam polymerization. In still further aspects, the crosslinking can be achieved by both adding the crosslinker and irradiating the formed polymer. In yet other aspects, crosslinking can be achieved by a thermal initiation.

In still further aspects, the polymer compositions disclosed herein exhibit elastomeric properties. For example, and without limitations, the polymer composition can have a tensile strength from about 150% to about 500%, including exemplary values of about 175%, about 200%, about 225%, about 250%, about 275%, about 300%, about 325%, about 350%, about 375%, about 400%, about 425%, about 450%, and about 475%.

In still further aspects, the polymer composition described herein can exhibit flame retardant properties.

In still further aspects, the polymer composition is stable in a temperature range from about −30° C. to about 100° C., including exemplary values of about −25° C., about 20° C., about −15° C., about −10° C., about −5° C., about 0° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., and about 95° C. It is understood that the term “stable” as disclosed herein indicates that the polymer composition retains its properties in the disclosed range of temperatures. For example, it does not undergo any degradation or change in the disclosed electrical and mechanical properties. It is understood that the term “stable” implies that the polymer composition can be used for its intended purpose, whether due to its electrical properties or mechanical properties in the disclosed range, without any limitations or substantial changes in performance.

In still further aspects, the polymer compositions disclosed herein exhibit an ion transference number of the cation of any of the disclosed above metal salts to be greater than about 0.4, or greater than about 0.45, or greater than about 0.5, or greater than about 0.6, or greater than about 0.7, or greater than about 0.8. For example, the ion transference number of the cation can be anywhere between about 0.4 to about 0.8, including exemplary values of about 0.42, about 0.45, about 0.47, about 0.5, about 0.52, about 0.55, about 0.57, about 0.6, about 0.62, about 0.65, about 0.67, about 0.7, about 0.72, about 0.75, and about 0.77. It is understood that the specific ion transference number will depend on the specific cation. For example, and without limitations, the polymer compositions disclosed herein exhibit Li-ion transference numbers from about 0.7 to about 0.75, including exemplary numbers of about 0.71, about 0.72, about 0.73, and about 0.74.

In still further aspects, the polymer compositions disclosed herein can be used as solid electrolytes, ionic conductors, actuators, sensors, capacitors, or a combination thereof. In still further aspects, the polymer compositions disclosed herein can be used in solar cells, supercapacitors, fuel cells, Li—S batteries, Na—S batteries, Li-air batteries, Na-air batteries, Zn-air batteries, or any batteries disclosed herein.

Also disclosed herein are polymer compositions that are formed by polymerizing a mixture comprising: a) one or more monomers of Formula (I), b) a plurality of plastic crystals; and c) a salt AB, wherein

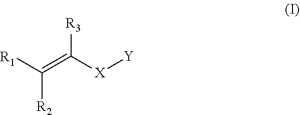

wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), (C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein X is C(O), O, or null,
wherein Y is OR₄, R₄, R₄′OR₄″, C(O)R₄, N(R₄)(R₄′″), or ON;
wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
or wherein R₄″ is P(O)(OR₄′″)₂;
wherein R₄′″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄′″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein n is 1 to 200;
wherein A is selected from Li, K, Na, Ca, Mg, Zn, Al, or a combination thereof; and B is selected from bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), or a combination thereof.

In still further aspects, n can be anywhere between 1 to 200, including exemplary values of 2, 5, 10, 15, 20, 30, 40, 50, 60, 70, 80, 90, 100, 110, 120, 130, 140, 150, 160, 170, 180, and 190. It is understood that any values between any two disclosed above values are also disclosed.

In still further aspects, R₁, R₂, and R₃ each is independently selected from hydrogen, C₁₋₅ alkyl, C₁₋₅ alkoxy, C₁₋₅ heteroalkyl, C₆₋₁₄ aryl, C₁₋₁₃ heteroaryl, C₆₋₁₄ aryloxy, C₃₋₁₀ cycloalkyl, C₃₋₁₀ heterocycloalkyl, C₃₋₁₀ cycloalkenyl, C₃₋₁₀ heterocycloalkenyl, halide, or amine. In yet still further aspects, R₁, R₂, and R₃ each is hydrogen. In yet still further aspects, at least one of R₁, R₂, and R₃ is hydrogen. In yet still further aspects, at least one of R₁, R₂, and R₃ is a halide. In still further aspects, at least one R₁, R₂, and R₃ is an amine. In yet still further aspects, any, none, or at least one of the R₁, R₂, and R₃ can be substituted by any of the disclosed above functional groups.

In still further aspects, when X is C(O), Y can be selected from OR₄, R₄′OR₄″, or N(R₄)(R₄′″). While in yet other aspects, when X is O, Y can be C(O)R₄. In still further aspects, when X is null, Y can be CN. It is understood that R₄, R₄′, R₄″, and R₄′″ can be independently selected from any of the disclosed above functional groups.

In still further aspects, the polymer composition formed from polymerizing the disclosed mixture can also exhibit an ionic conductivity from about 1.0 mS/cm to about 10 mS/cm, including exemplary values of about 1.5 mS/cm, about 2.0 mS/cm, about 2.5 mS/cm, about 3.0 mS/cm, about 3.5 mS/cm, about 4.0 mS/cm, about 4.5 mS/cm, about 5.0 mS/cm, about 5.5 mS/cm, about 6.0 mS/cm, about 6.5 mS/cm, about 7.0 mS/cm, about 7.5 mS/cm, about 8.0 mS/cm, about 8.5 mS/cm, about 9.0 mS/cm, and about 9.5 mS/cm. In still further aspects, the polymer composition disclosed herein can exhibit an ionic conductivity greater than about 1 mS/cm, greater than about 1.1 mS/cm, greater than about 1.2 mS/cm, greater than about 1.3 mS/cm, greater than about 1.4 mS/cm, greater than about 1.5 mS/cm, greater than about 1.6 mS/cm, greater than about 1.7 mS/cm, greater than about 1.8 mS/cm, greater than about 1.9 mS/cm, greater than about 2.0 mS/cm, greater than about 2.1 mS/cm, greater than about 2.2 mS/cm, greater than about 2.3 mS/cm, greater than about 2.4 mS/cm, greater than about 2.5 mS/cm, greater than about 2.6 mS/cm, greater than about 2.7 mS/cm, greater than about 2.8 mS/cm, greater than about 2.9 mS/cm, greater than about 3.0 mS/cm, greater than about 3.1 mS/cm, greater than about 3.2 mS/cm, greater than about 3.3 mS/cm, greater than about 3.4 mS/cm, greater than about 3.5 mS/cm, greater than about 3.6 mS/cm, greater than about 3.7 mS/cm, greater than about 3.8 mS/cm, greater than about 3.9 mS/cm, or even greater than about 4.0 mS/cm. In yet still further aspects, the ionic conductivity of the disclosed herein polymer can be also greater than about 5.0 mS/cm.

In still further aspects, the mixture can further comprise a cross-linker. In such aspects, the cross-linker can comprise one or more of

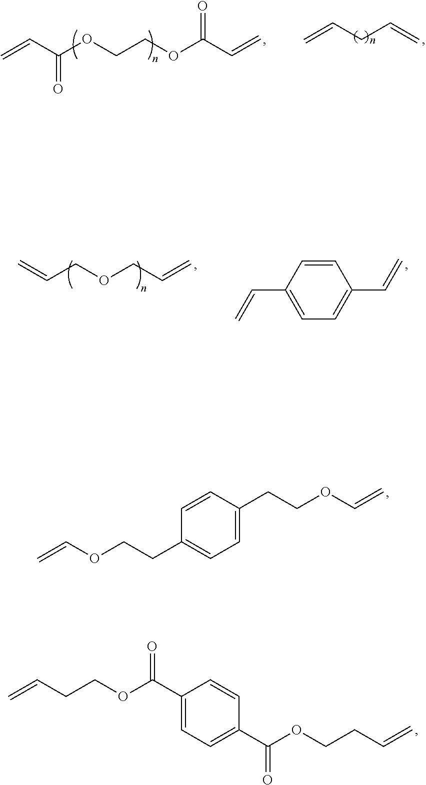

or a combination thereof and wherein n is from 1 to 30, including exemplary values of 2, 3, 4, 5, 6, 7, 8, 9, 10, 11, 12, 13, 14, 15, 16, 17, 18, 19, 20, 21, 22, 23, 24, 25, 26, 27, 28, and 29.

It is understood, however, that the polymer composition can also be crosslinked by irradiating the polymerizable mixture. Any known times of radiation can be used to form a crosslinked polymer. For example, and without limitations, the polymer composition can be crosslinked with UV, IR, or e-beam radiation.

Any of the disclosed above of the plurality of plastic crystals can be used. For example, and without limitations, the plurality of plastic crystals are derived from one or more:

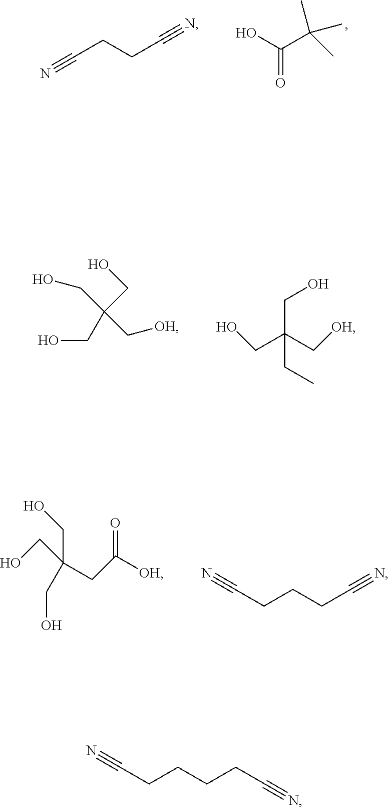

or a combination thereof.

In still further exemplary and unlimiting aspects, the monomer of formula (I) can be selected from one or more of:

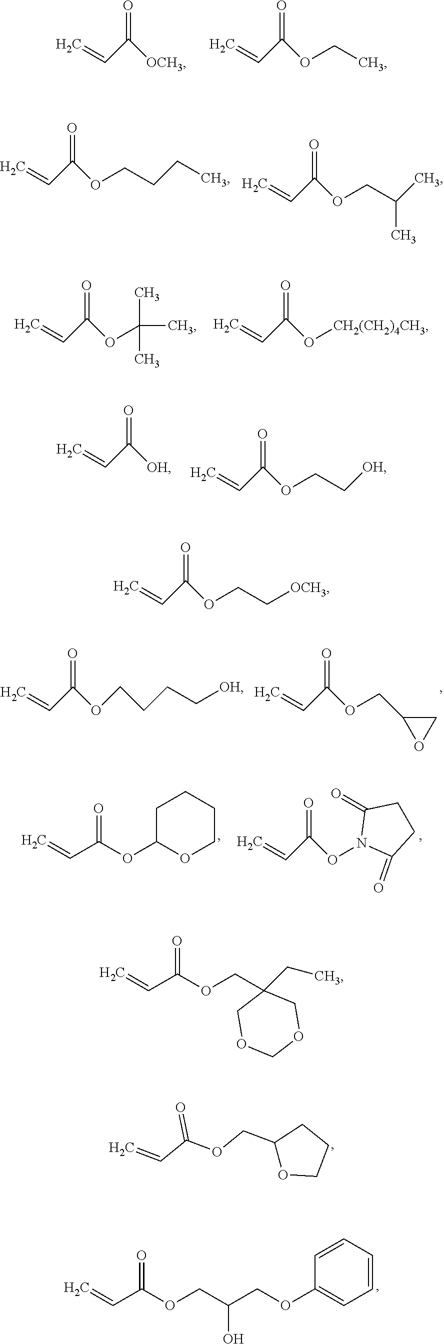

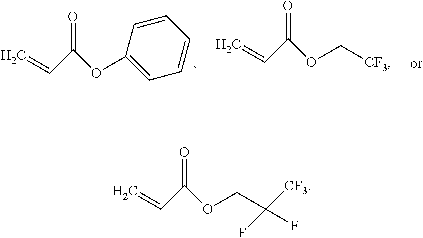

While yet in other aspects, the monomer (I) is selected from one or more of:

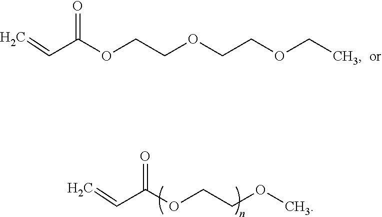

While in still further aspects, the monomer (I) is selected from one or more of:

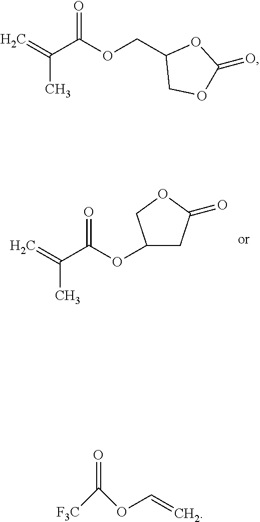

In still further aspects, the monomer (I) is selected from one or more of:

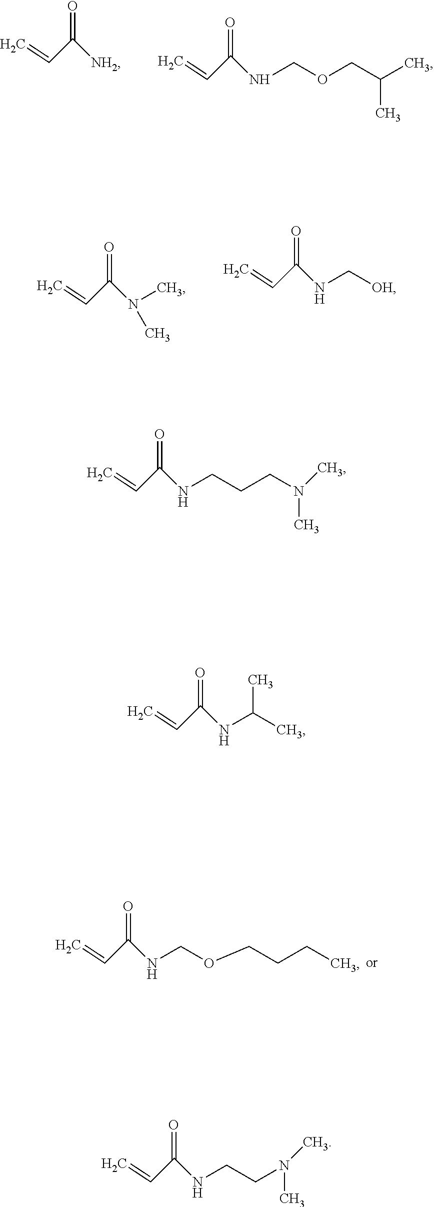

In still further aspects, the monomer (I) is selected from one or more of:

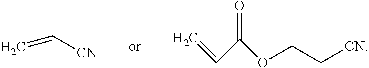

While in still further aspects, the monomer (I) can comprise

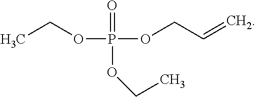

It is understood that the step of polymerizing the polymer composition can be done by any known in the art methods. For example, the polymerization can be free radical polymerization, ionic polymerization, or coordination polymerization. In some aspects, the mixture that is used to form the disclosed herein polymer composition can further comprise an initiator. In such aspects, the initiator is a polymerization initiator. In still further aspects, the initiator can comprise a thermal initiator, a photoinitiator, or a combination thereof.

In some aspects, the initiator is a thermal initiator. Any known in the art thermal initiators can be utilized if they result in the desired polymer composition. In such exemplary and unlimiting aspects, the thermal initiator can comprise azobisisobutyronitrile, benzoyl peroxide, or a combination thereof. When any of these thermal initiators are used to form the polymer composition, the polymerization is a thermal polymerization.

Yet, in other aspects, the initiator is a photo-initiator. Any known in the art photo-initiators can be utilized if they result in the desired polymer composition. In such exemplary and unlimiting aspects, the photo-initiator can comprise bis(2,4,6-trimethylbenzoyl)-phenylphosphine oxide (Irgacure 819), 2-hydroxyl-2-methyl-1-phenyl-1-propanone, methyl benzoylformate, hydroxycyclohexyl phenyl ketone (Igracure 184), or a combination thereof. When any of these photo-initiators are used to form the polymer composition, the polymerization is a photopolymerization.

In some exemplary and unlimiting aspects, the polymer composition can be synthesized by polymerizing a homogeneous solution comprising butyl acrylate (BA), poly(ethylene glycol) diacrylate (PEGDA), succinonitrile (SN), and LiTFSI.

In still further aspects, the mixture can comprise a volume ratio of one or more monomers of Formula (I) and the plurality of plastic crystals from about 70:30 to about 30:70, including exemplary values of about 60:40; 50:50, and about 40:60.

In still further aspects, the salt AB can be present in the mixture in an amount from 0 wt % to about 70 wt %, including exemplary values of about 0.01 wt %, about 0.05 wt %, about 0.1 wt %, about 0.5 wt %, about 1 wt %, about 5 wt %, about 10 wt %, about wt %, about 20 wt %, about 25 wt %, about 30 wt %, about 35 wt %, about 40 wt %, about 45 wt %, about 50 wt %, about 55 wt %, about 60 wt %, about 65 wt %, and about 66.9 wt % of the polymer composition In still further aspects, the salt AB can be added, for example, as a powder. In such aspects, the salt is substantially dry and substantially water-free.

In still further aspects, the mixture is substantially water-free

In still further aspects, the mixture can also comprise various additives. In some aspects, the additives can comprise functional groups that protect the polymerization reaction from side reactions that can form undesired compositions. For example, and without limitation, the mixture can comprise fluoroethylene carbonate (FEC), lithium nitrate (LiNO₃), or any combination thereof. It is understood that the listed herein compounds are only exemplary, and any other compounds capable of achieving the desired application can be utilized. It is understood that all the compounds present in the mixture are substantially water-free.

In still further aspects, the mixture is homogenous prior to polymerization.

In still further aspects, the plurality of plastic crystals dispersed within the polymer composition can form a three-dimensional interconnected phase of plastic crystals.

In still further aspects, the polymer compositions disclosed herein exhibit elastomeric properties. For example, and without limitations, the polymer composition can have a tensile strength from about 150% to about 500%, including exemplary values of about 175%, about 200%, about 225%, about 250%, about 275%, about 300%, about 325%, about 350%, about 375%, about 400%, about 425%, about 450%, and about 475%.

In still further aspects, the polymer composition described herein can exhibit flame retardant properties.

In still further aspects, the polymer composition is stable in a temperature range from about −30° C. to about 100° C., including exemplary values of about −25° C., about 20° C., about −15° C., about −10° C., about −5° C., about 0° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., and about 95° C. It is understood that the term “stable” as disclosed herein indicates that the polymer composition retains its properties in the disclosed range of temperatures. For example, it does not undergo any degradation or change in the disclosed electrical and mechanical properties. It is understood that the term “stable” implies that the polymer composition can be used for its intended purpose, whether due to its electrical properties or mechanical properties in the disclosed range, without any limitations or substantial changes in performance.

In still further aspects, the polymer compositions disclosed herein exhibit an ion transference number of the cation of any of the disclosed above metal salts to be greater than about 0.4, or greater than about 0.45, or greater than about 0.5, or greater than about 0.6, or greater than about 0.7, or greater than about 0.8. For example, the ion transference number of the cation can be anywhere between about 0.4 to about 0.8, including exemplary values of about 0.42, about 0.45, about 0.47, about 0.5, about 0.52, about 0.55, about 0.57, about 0.6, about 0.62, about 0.65, about 0.67, about 0.7, about 0.72, about 0.75, and about 0.77. It is understood that the specific ion transference number will depend on the specific cation. For example, and without limitations, the polymer compositions disclosed herein exhibit Li-ion transference numbers from about 0.7 to about 0.75, including exemplary numbers of about 0.71, about 0.72, about 0.73, and about 0.74.

### Electrochemical Cells

Also disclosed herein are electrochemical cells. In such aspects, the electrochemical cell can comprise a solid electrolyte comprising any of the disclosed herein polymer compositions, an anode electrode; and a cathode electrode; wherein the anode electrode and the cathode electrode are in electrical communication with the solid electrolyte.

In some aspects, the anode electrode can comprise a metal material. It is understood that the metal material can be a metal or material that comprises cations of the disclosed metal. In some aspects, the metal material can comprise metal of Li, Ca, Na, K, Mg, Zn, Al, alloys thereof, or a combination thereof. Yet, in other aspects, the anode can comprise a material capable of intercalating any of the disclosed herein metal materials. In still further aspects, the anode material can comprise ions of Li, Ca, Na, K, Mg, Zn, Al, alloys thereof, or a combination thereof. In certain aspects, the anode is Li-based material. In yet other aspects, the anode is Li metal. In still further aspects, the anode is a K-based material. In yet other aspects, the anode is K metal. In still further aspects, the anode is a Na-based material. In yet other aspects, the anode is Na metal. In still further aspects, the anode is a Zn-based material. In yet other aspects, the anode is Zn metal. In still further aspects, the anode is a Ca-based material. In yet other aspects, the anode is Ca metal. In still further aspects, the anode is an Mg-based material. In yet other aspects, the anode is Mg metal. In still further aspects, the anode is an Al-based material. In yet other aspects, the anode is Al metal. In still further aspects, the anode is an alloy of any of the disclosed above metal materials.

In still further aspects, the anode material can also comprise a host material configured to receive and intercalate any of the disclosed above metal materials. Such host materials can comprise any known in the art materials. For example, the host material can comprise copper or graphite-based materials. In certain exemplary aspects, the host material comprises copper. In such exemplary aspects, it can be presented as a foil, foam, grid, wire, filament, or any combination thereof. In yet other exemplary aspects, the host material comprises a carbon-based material. The carbon-based materials can comprise hard carbon, carbon black, graphene, reduced graphene oxide, graphene oxide, graphite, or any combination thereof. In still further aspects, additional host materials can comprise silicon or graphite/silicon composite materials.

In still further aspects, the cathode electrode can be a metal cathode or a composite cathode. It is understood that any known in the art cathode materials that can be useful for the desired purpose can be utilized. In some aspects, the cathode can be a metal cathode or composite cathode.

In yet still further aspects, the cathode material can comprise copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium cobalt oxide) cathode, lithium-nickel-cobalt-aluminum oxide material (LNCAO), lithium-nickel-manganese-cobalt oxide (LNMCO), LFP (lithium iron phosphate) cathode, fluoride-based cathode, sulfur selenium cathode, sulfur selenium tellurium cathode, spinels, olivines, or any combination thereof

If the metal cathode is similar to the metal anode, such an electrochemical cell can be a symmetrical electrochemical cell. For example, and without limitation, the symmetrical cell can comprise Li or K anode material and Li or K cathode material, respectively, and the like.

In still further aspects, the cathode electrode comprises Na₃V₂(PO₄)₃ (NVP), LNMCO, Na₃V₂(PO₄)₂F₃ (NVPF), KMnFe(CN)₆, MnO₂, V₂O₅, graphite, LiFePO₄, LiCoO₂, LiMnO₂, derivatives thereof, or a combination thereof.

In still further aspects, the cathode material comprises Li metal, LiNi_{1-x-y-}MnₓCo_{y}O₂, or LiNi_{1-a-b}CoₐAl_{b}O₂, wherein 1≥x≥0, 1≥y≥0, 1≥a≥0, and 1≥b≥0. In such exemplary aspects, x can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0. In still further aspects, y can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0. In still further aspects, a can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0. In still further aspects, b can have any value from 0 and 1, including exemplary values of 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1.0.

In still further exemplary and unlimiting aspects, the cathode material can comprise LiCoO₂, LiNi_{0.9}Mn_{0.05}Co_{0.05}O₂, LiNi_{0.6}Mn_{0.2}Co_{0.2}O₂, LiNi_{0.83}Mn_{0.06}Co_{0.11}O₂, or LiNi_{0.88}Co_{0.09}Al_{0.03}O₂, LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, or a LiNi_{0.8}Mn_{0.1}Co_{0.1}O₂ composite cathode.

In yet still further aspects, the cathode material can also comprise additives. For example, and without limitations, the additives can comprise a poly(ethylene oxide), cellulose, carboxymethylcellulose (CMC), a polytetrafluoroethylene (PTFE), styrene-butadiene rubber (SBR), or a polyvinylidene fluoride binder (PVDF).

In still further aspects, the electrochemical cells if the present disclosure can exhibit a cyclic Coulombic efficiency greater than about 90%, greater than about 91%, greater than about 92%, greater than about 93%, greater than about 94%, greater than about 95%, greater than about 96%, greater than about 97%, greater than about 98%, greater than about 99%, greater than about 99.1%, greater than about 99.2%, greater than about 99.3%, greater than about 99.4%, greater than about 99.5%, greater than about 99.6%, greater than about 99.7%, greater than about 99.8%, or greater than about 99.9% for about 500 cycles, about 600 cycles, about 700 cycles, about 800 cycles, about 900 cycles, about 1,000 cycles, about 1,250 cycles, about 1,500 cycles, about 1,750 cycles, about 2,000 cycles, about 5,000 cycles, or about 10,000 at a current density from about 0.1 mA cm⁻² to about 10 mA cm⁻², including exemplary values of about 0.25 mA cm⁻², about 0.5 mA cm⁻², about 0.75 mA cm⁻², about 1 mA cm⁻², about 1.5 mA cm⁻², about 2 mA cm⁻², about 2.5 mA cm⁻², about 3 mA cm⁻², about 3.5 mA cm⁻², about 4 mA cm⁻², about 4.5 mA cm⁻², about 5 mA cm⁻², about 5.5 mA cm⁻², about 6 mA cm⁻², about 6.5 mA cm⁻², about 7 mA cm⁻², about 7.5 mA cm⁻², about 8 mA cm⁻², about 8.5 mA cm⁻², about 9 mA cm⁻², and about 9.5 mA cm⁻².

In yet further aspects, the cell is substantially stable for about 200, about 300, about 400, about 500, about 600, about 700, about 800, about 900, or about 1,000 plating/stripping cycles a temperature from about −30° C. to about 100° C., including exemplary values of about-about −25° C., about −20° C., about −15° C., about −10° C., about −5° C., about 0° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., and about 95° C.

In still further aspects, the disclosed herein electrochemical cells are configured to provide specific energy of about 350 to about 520 watt-hours per kilogram of the anode, cathode, and the solid electrolyte after about 500 cycles at a specific energy of about 150 to about 500 W/kg. In such aspects, the specific energy of the cell can be from about 350 to about 600 watt-hours per kilogram of the anode, cathode, and the solid electrolyte, including exemplary values of about 400, about 425, about 450, about 475, about 500, about 520, about 550, and about 575 watt-hours per kilogram of the anode, cathode, and the solid electrolyte after about 500 cycles at a specific energy of about 150 to about 500 W/kg, including exemplary values of about 200, about 250, about 300, about 350, about 400, and about 450 W/kg.

In yet still further aspects, the electrochemical cell exhibits a substantially stable plating and stripping cycling at least about 500 hours, at least about 600 hours, at least about 700 hours, at least about 800 hours, at least about 900 hours, at least about 1,000 hours, at least about 1,250 hours, at least about 1,500 hours, at least about 1,750 hours, at least about 2,000 hours, at least about 5,000 hours, at least about 10,000 at a current density from about 0.1 mA cm⁻² to about 10 mA cm⁻², including exemplary values of about 0.25 mA cm⁻², about 0.5 mA cm⁻², about 0.75 mA cm⁻², about 1 mA cm⁻², about 1.5 mA cm⁻², about 2 mA cm⁻², about 2.5 mA cm⁻², about 3 mA cm⁻², about 3.5 mA cm⁻², about 4 mA cm⁻², about 4.5 mA cm⁻², about 5 mA cm⁻², about 5.5 mA cm⁻², about 6 mA cm⁻², about 6.5 mA cm⁻², about 7 mA cm⁻², about 7.5 mA cm⁻², about 8 mA cm⁻², about 8.5 mA cm⁻², about 9 mA cm⁻², and about 9.5 mA cm⁻².

In still further aspects, the cell exhibits a substantially stable plating and stripping cycling for up to about 500 hours, up to about 600 hours, up to about 700 hours, up to about 800 hours, up to about 900 hours, up to about 1,000 hours, up to about 1,100 hours, up to about 1,200 hours, up to about 1,300 hours, up to about 1,400 hours, and up to about 1500 hours at a current density from about 0.1 mA cm⁻² to about 10 mA cm⁻², including exemplary values of about 0.25 mA cm⁻², about 0.5 mA cm⁻², about 0.75 mA cm⁻², about 1 mA cm⁻², about 1.5 mA cm⁻², about 2 mA cm⁻², about 2.5 mA cm⁻², about 3 mA cm⁻², about 3.5 mA cm⁻², about 4 mA cm⁻², about 4.5 mA cm⁻², about 5 mA cm⁻², about 5.5 mA cm⁻², about 6 mA cm⁻², about 6.5 mA cm⁻², about 7 mA cm⁻², about 7.5 mA cm⁻², about 8 mA cm⁻², about 8.5 mA cm⁻², about 9 mA cm⁻², and about 9.5 mA cm⁻².

In still further aspects, the electrochemical cell can exhibit a reversible capacity up to about 100 mAh/g, up to about 110 mAh/g, up to about 120 mAh/g, up to about 130 mAh/g, up to about 140 mAh/g, up to about 150 mAh/g, up to about 160 mAh/g, up to about 170 mAh/g, up to about 180 mAh/g, up to about 190 mAh/g, and up to about 200 mAh/g.

In still further aspects, the solid electrolyte composition does not undergo any substantial change for about 200, about 300, about 400, about 500, about 600, about 700, about 800, about 900, or about 1,000 plating/stripping cycles a temperature from about −30° C. to about 100° C., including exemplary values of about-about −25° C., about −20° C., about −15° C., about −10° C., about −5° C., about 0° C., about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., and about 95%.

In still further aspects, the solid electrolyte can have a thickness from about 10 nm to about 1 mm, including exemplary values of about 15 nm, about 20 nm, about 50 nm, about 100 nm, about 250 nm, about 500 nm, about 750 nm, about 1 μm, about 5 μm, about 10 μm, about 25 μm, about 50 μm, about 75 μm, about 100 μm, about 250 μm, about 500 μm, about 750 μm, and about 990 μm

In still further aspects, the electrochemical cell, as disclosed herein, exhibits a capacity retention greater than about 80%, greater than about 81%, greater than about 82%, greater than about 83%, greater than about 84%, greater than about 85%, greater than about 86%, greater than about 87%, greater than about 88%, greater than about 89%, greater than about 90%, greater than about 91%, greater than about 92%, greater than about 93%, greater than about 94%, greater than about 95%, greater than about 96%, greater than about 97%, greater than about 98%, or greater than about 99% for at least about 50 cycles, at least about 80 cycles, at least about 100 cycles, at least about 200 cycles, at least about 300 cycles, at least about 400 cycles, at least about 500 cycles, at least about 600 cycles, at least about 700 cycles, at least about 800 cycles, at least about 900 cycles, or at least about 1000 cycles.

In yet still further aspects, the cell can exhibit a substantial discharge capacity retention of no less than about 99.9%, no less than about 99%, no less than about 98, or no less than about 97, or no less than about 96, or no less than about 95%, no less than about 94, or no less than about 93, or no less than about 92, or no less than about 91, or no less than about 90%, no less than about 89, or no less than about 88, or no less than about 87, or no less than about 86, or no less than about 85%, no less than about 84, or no less than about 83, or no less than about 82, or no less than about 81, or no less than about 80%, no less than about 79, or no less than about 78, or no less than about 77, or no less than about 76, or no less than about 75%, or no less than about 74, or no less than about 73, or no less than about 72, or no less than about 71, or no less than about 70% after at least about 50 cycles, at least about 80 cycles, at least about 100 cycles, at least about 200 cycles, at least about 300 cycles, at least about 400 cycles, at least about 500 cycles, at least about 600 cycles, at least about 700 cycles, at least about 800 cycles, at least about 900 cycles, or at least about 1000 cycles

In still further aspects, the solid electrolyte can be formed in situ. In such aspects, the mixture as described above can be inserted into the electrochemical cell during the cell construction, and the polymerization process can be achieved inside the cell. In such exemplary and unlimiting aspects, the polymerization can be activated by heat.

In yet other aspects, the solid electrolyte can be formed separately and added as a separate component during the cell construction.

In still further aspects, the disclosed herein electrochemical cells operate such that the anode material is substantially dendrite free during a plating cycle.

In still further aspects, the electrochemical cell disclosed herein is a battery. In still further aspects, the battery is a secondary battery.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

### Methods

Further disclosed herein are methods of making of the disclosed herein polymer compositions. In some aspects, the methods comprise: a) forming a mixture comprising: i) one or more monomers of Formula (I) as disclosed above, ii) any of the disclosed above a plurality of plastic crystals; iii) any of the disclosed above salts AB, and polymerizing the mixture to form the disclosed above polymer composition.

In still further aspects, the mixture can also comprise a cross-linker. Any of the disclosed above cross-liners can be utilized. In still further aspects, the mixture can further comprise an initiator. Any of the disclosed above initiators can be utilized.

In some exemplary and unlimiting aspects, the polymer composition can be synthesized by polymerizing a homogeneous solution comprising butyl acrylate (BA), poly(ethylene glycol) diacrylate (PEGDA), succinonitrile (SN), and LiTFSI.

In still further aspects, the disclosed methods result in the polymer composition where the plurality of plastic crystals dispersed within the polymer composition to form a three-dimensional interconnected phase of plastic crystals and wherein the polymer composition exhibits an ionic conductivity of at least about 1.1 mS/cm at about 20° C.

In still further aspects, the methods result in any of the disclosed above polymer compositions.

Also disclosed herein are methods of making an electrochemical cell comprising: a) providing an anode material; b) providing a cathode material, and c) providing a solid electrolyte formed by the disclosed methods.

While in still further aspects, also disclosed is a method of making an electrochemical cell comprising: a) providing an anode material; b) providing a cathode material; and c) providing the mixture of any of the disclosed herein compounds and polymerizing the mixture in-situ during the electrochemical cell operation to form the disclosed solid electrolyte.

By way of non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

Without wishing to be bound by any theory, it was hypothesized that excellent ionic and mechanical properties could be realized if ionic conducting materials can form a three-dimensional (3D) interconnected phase within a mechanically robust elastomer matrix through PIPS. In this disclosure, a different class of SPEs for high-energy LMBs is reported. These materials are based on an in situ-formed elastomer with a 3D interconnected phase of ion-conductive plastic crystals. Co-continuous structures of plastic-crystal-embedded elastomer electrolyte (PCEE) are developed by PIPS between polymers and plastic crystals within the cell. The PCEE exhibits both superior mechanical properties and high ionic conductivity (1.1 mS cm⁻¹ at 20° C.) with a high Li-ion transference number (t+) of 0.75. In addition, owing to its mechanical elasticity, the in situ-formed PCEE within the cells (hereinafter, ‘built-in PCEE’) effectively accommodates the substantial volume changes of Li during the fast charge-discharge cycling. Using built-in PCEE, the stable operation of an SPE-based solid-state LMB with a LiNi_{0.83}Mn_{0.06}Co_{0.11}O₂ (NMC-83) cathode at a high voltage of 4.5 V was demonstrated. This elastomeric electrolyte system presents a promising strategy for achieving high-performance and stable solid-state LMBs.

### Example 1

### Preparation of Electrolytes

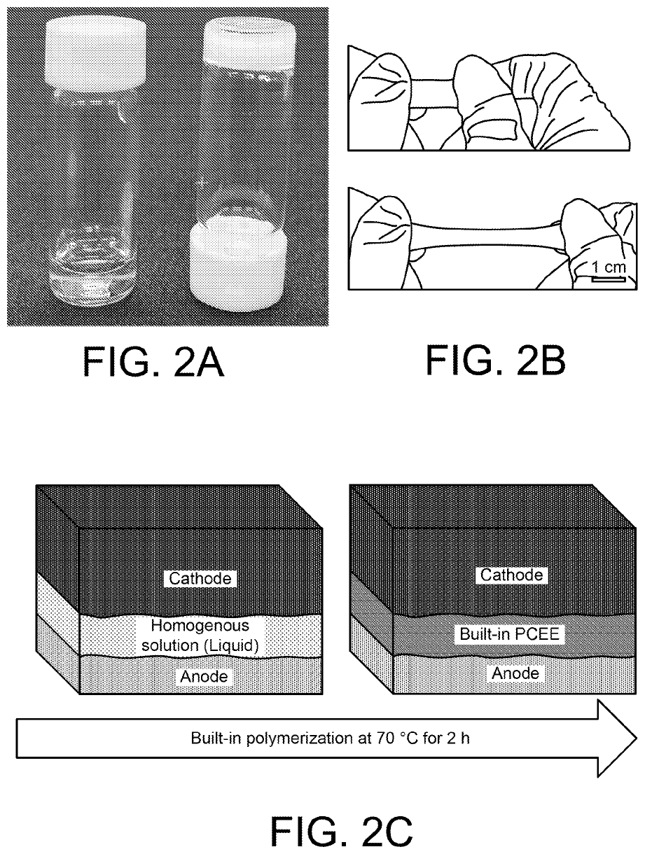

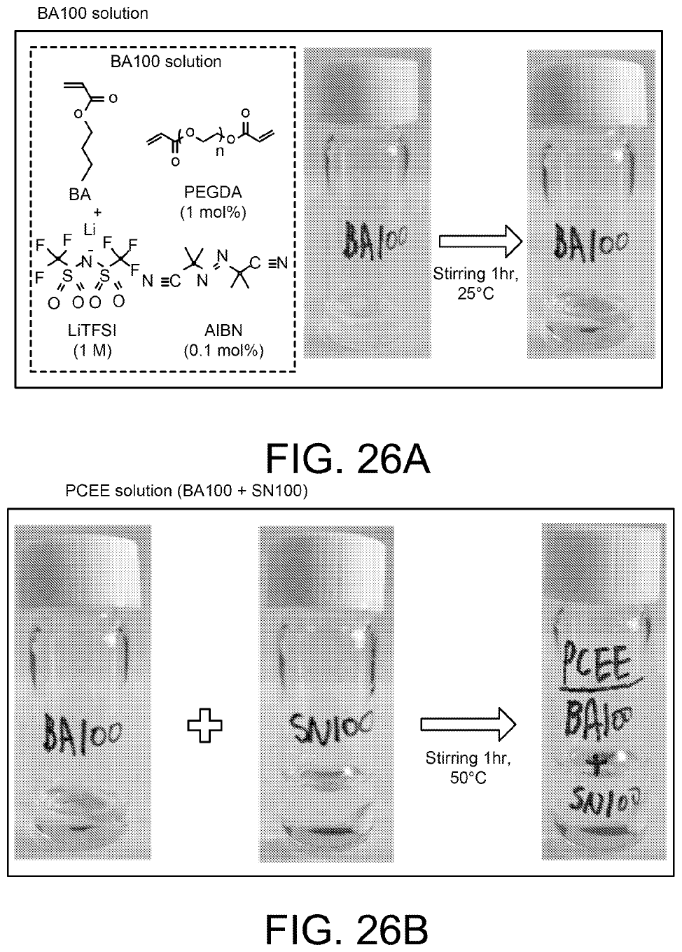

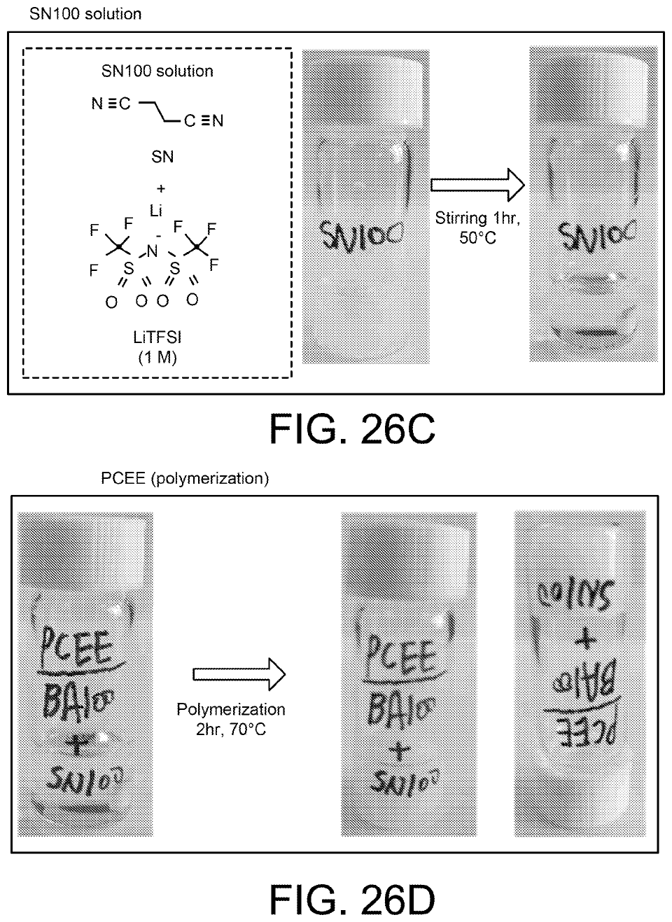

For PCEE fabrication, electrolyte preparation and cell assembly were implemented in an argon gas-filled glove box where the concentration of 02 and water (H₂O) was below 0.1 ppm. The butylacrylate (BA)-based solutions were prepared by dissolving 1 mol % poly(ethylene glycol) diacrylate (PEGDA) (Sigma-Aldrich), 0.5 mol % AIBN (Sigma-Aldrich), and 1 M LiTFSI powder (≥99%; Sigma-Aldrich) in BA liquid (Sigma-Aldrich). The BA-based solutions were polymerized at 70° C. for 2 h to compare BA-based elastomer (BA100) with PCEE. The succinonitrile (SN)-based solutions (SN 100) were made by mixing SN (Sigma-Aldrich) with 1 M LiTFSI powder and 5 Vol % fluoroethylene carbonate additive (Sigma-Aldrich) to protect against the side reaction of SN with Li metal at 50° C. Each prepared liquid solution was homogeneously mixed in a volume ratio of 1:1 at 50° C. to fabricate the build-in PCEE (FIGS. 26A-26D). After injecting the prepared solution into the cells (2032-type coin cell, for example), the assembled cell was heated at 70° C. for 2 h to generate built-in PCEEs (FIGS. 2A-2C). A homemade mold was used to prepare the free-standing ex-situ PCEEs.

PCEE can also be prepared via a photopolymerization process. The polymerization time of PCEE can be reduced from 2 h to 5-20 min by replacing the thermal initiator (e.g., azobisisobutyronitrile) with a photoinitiator (e.g., photoinitiator bis(2,4,6-trimethylbenzoyl)-phenylphosphine oxide (Irgacure 819), 2-hydroxyl-2-methyl-1-phenyl-1-propanone, and methyl benzoylformate).

### Material Characterization

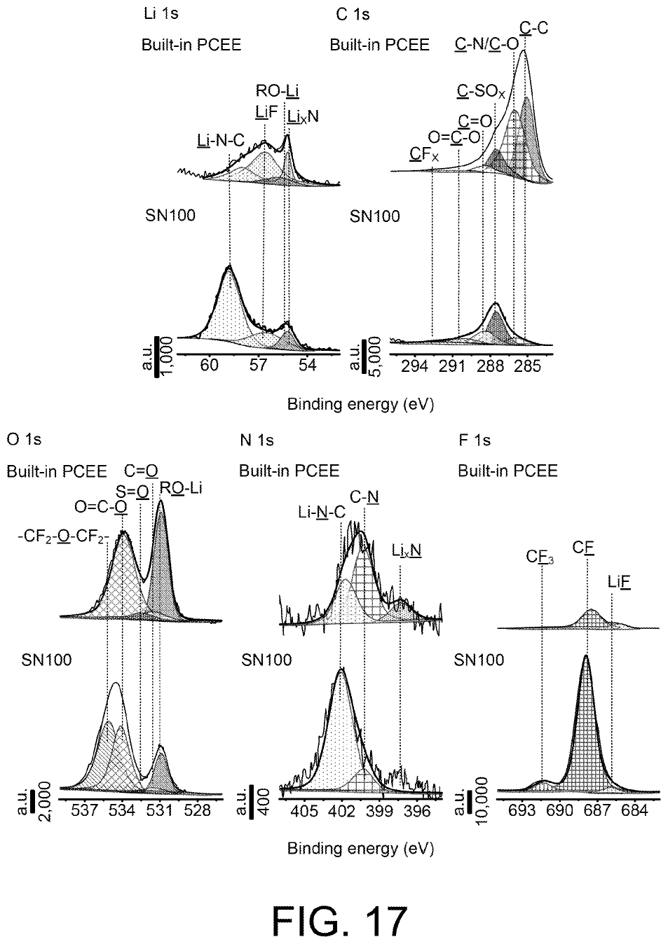

Fourier transform infrared spectroscopy spectra were measured using a Bruker ALPHA-P spectrometer in an attenuated total reflectance setup. Thermogravimetric analysis testing (TA Instruments Q500) was measured from room temperature to 700° C. at a heating rate of 10° C. min⁻¹ under a nitrogen atmosphere. Differential scanning calorimetry curves were obtained using a TA Instruments Q200 under a nitrogen atmosphere at a heating and cooling rate of 1000 min⁻¹. The morphologies of the built-in PCEE were observed by SEM (Hitachi SU-5000) and TEM (Talos F200X). Cross-sectional TEM samples were prepared by microtoming with a diamond knife (RMC PowerTomeX). Electron energy-loss spectroscopy elemental mapping was performed using TEM with high-angle annular dark-field imaging. The 3D tomography image was constructed by an X-ray microscope (Zeiss Xradia 520 versa). Mechanical tensile stress and interfacial adhesion-strength measurements were carried out using a universal testing machine (Lloyd Instruments LR5K). Adhesion energies were calculated using a previously reported method. X-ray photoelectron spectroscopy (XPS; Thermal Scientific K-alpha XPS instrument) was used to investigate the compositions of the SEI formed on the Li metal anodes after 100 cycles in the symmetric Li cells with the built-in PCEE and SN100 (FIG. 17). The cycled cells were disassembled in an argon-filled glove box. The cycled Li metal anodes were then transferred to the XPS using a vacuum transfer vessel to avoid contamination or side reactions with ambient oxygen and moisture. For comparison, the top surfaces of the cycled Li metal anodes were etched using argon-ion sputtering until the atomic ratio of Li in the SEI components of the built-in PCEE, and SN100 reached approximately 30%. High-resolution XPS Li 1 s, C 1 s, O 1 s, N 1 s, and F 1 s spectra were deconvoluted using XPSPEAKS 4.1.

### Electrode Preparation

NMC-622, NMC-83, and LFP cathodes were prepared using a slurry casting technique. Active material, Super P carbon as a conductive additive, SN-LiTFSI with a molar ratio of 20:1, and polyvinylidene fluoride were dissolved in N-methyl-2-pyrrolidone with a weight ratio of 7:1:1:1 to make a slurry and then coated onto a current collector of aluminum foil. The cathodes were dried in a vacuum oven at 55° C. for 24 h. The active loading density of the LFP cathode was 1.5 mg cm⁻². The active loading densities of the NMC-622 cathode were 2.1 mg cm⁻² and 9.8 mg cm⁻². The active loading density of the NMC-83 cathode was in the range of 10.3-10.6 mg cm⁻².

### Electrochemical Measurements

The electrochemical performances of all cells were tested with 2032-type coin cells assembled using Li foil as the anode in an argon-filled glovebox (M. Braun, O2 and H2O<0.1 ppm). Linear-sweep voltammetry was carried out using Li∥stainless steel (SS) asymmetric cells from 1.5 V to 6 V versus Li/Li+ at a scan rate of 1 mV s⁻¹. EIS (Bio-Logic VMP3) of the PCEEs was carried out from 100 Hz to 105 Hz using a 10-mV peak voltage at an open-circuit voltage. The ionic conductivity of the electrolytes was measured using EIS with SSIlelectrolytelISS symmetric cells in an environmental chamber (MC-812R, Espec) at the desired temperatures. Considering the compatibility with the current roll-to-roll-based Li-ion battery manufacturing, polypropylene or glass fibre as a separator was applied to prevent a short circuit in the liquid precursors of the PCEEs for the full cells in this work. The cycling test of the 35-μm-thick LiII25-μm-built-in PCEEIIhigh-loading NMC-83 cell was performed in the voltage range of 2.7-4.3 V with three initialization cycles at a current density of 0.1 mA cm⁻² before cycling at a current density of 0.5 mA cm-2 without any voltage holding. The galvanostatic charge/discharge test of the 35-μm-thick LiII25-μm-thick built-in PCEEIIhigh-loading NMC-83 cell was carried out in the voltage range of 2.7-4.5 V at equal current densities of 0.1-3 mA cm⁻² (Arbin battery tester). For the temperature-dependent test, the 35-μm-thick LiII25-μm-built-in PCEEIIhigh-loading NMC-83 cell was charged and discharged at equal current density (0.1 mA cm⁻²) and temperatures (0° C. to 60° C.) in an environmental chamber. All specific and areal capacities were normalized using the weight of the active material in the electrodes and the area of the electrodes, respectively.

### Example 2

### Designing Elastomeric Electrolytes

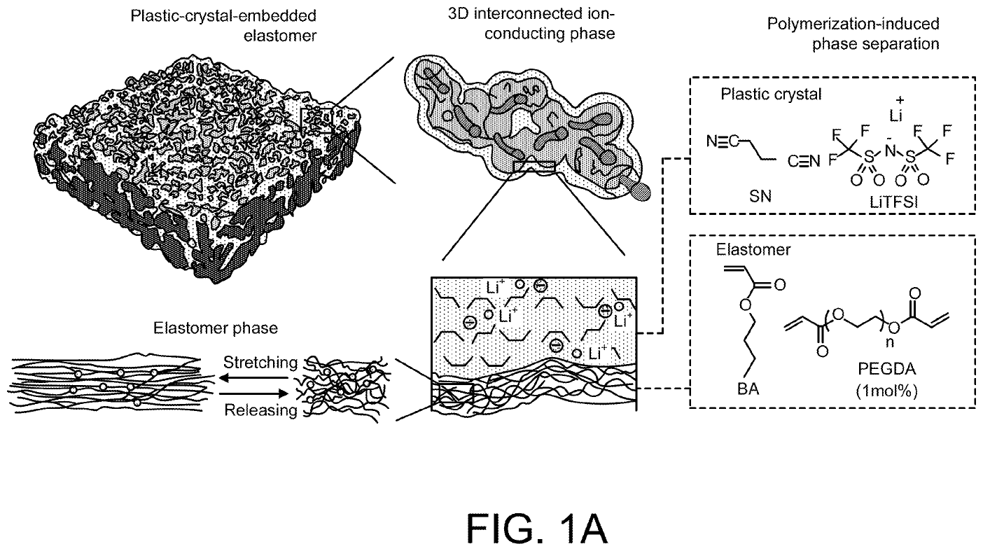

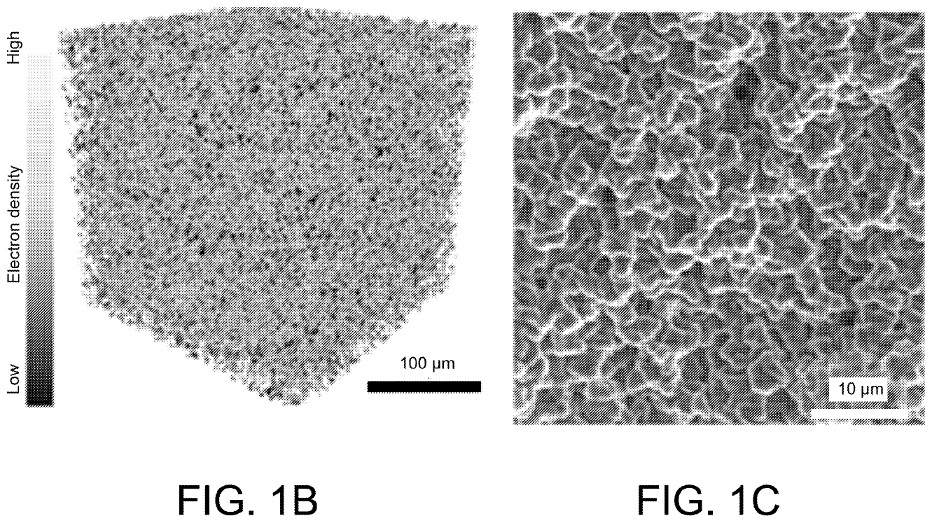

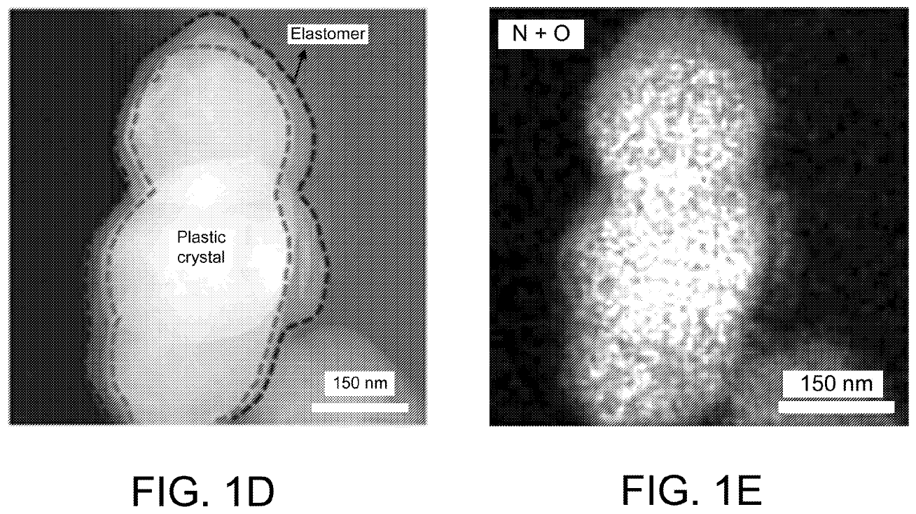

Built-in PCEE was synthesized by polymerizing a homogeneous solution consisting primarily of butyl acrylate (BA), succinonitrile (SN), and lithium bis(trifluoromethanesulfonyl)imide (LiTFSI) at 70° C. in an assembled electrochemical cell (FIG. 1a, FIGS. 2A, 2C). SN, a representative plastic crystal, was selected as an ionic conductive material owing to its high ionic conductivity when complexed with Li salts. For polymerization, azobisisobutyronitrile (AIBN; 0.5 mol %) and poly(ethylene glycol) diacrylate (PEGDA; 1 mol %) were used as the thermal initiator and crosslinking agent, respectively. In this polymerization process, BA/PEGDA produces in situ-formed polymers chemically cross-linked by PEGDA, eventually resulting in elastomer networks, whereas the SN-LiTFSI phase is partitioned into nanoscale domains.

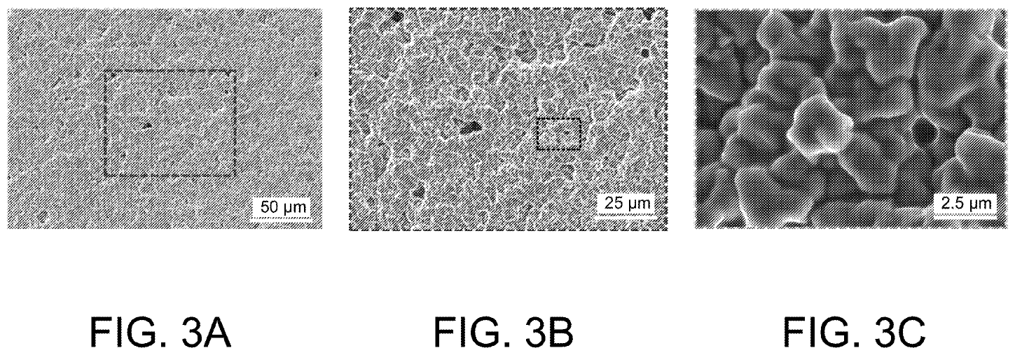

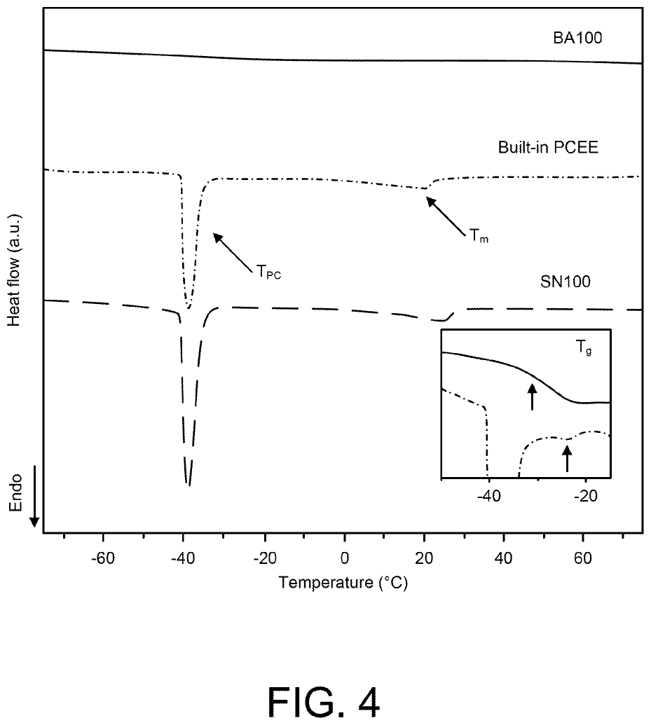

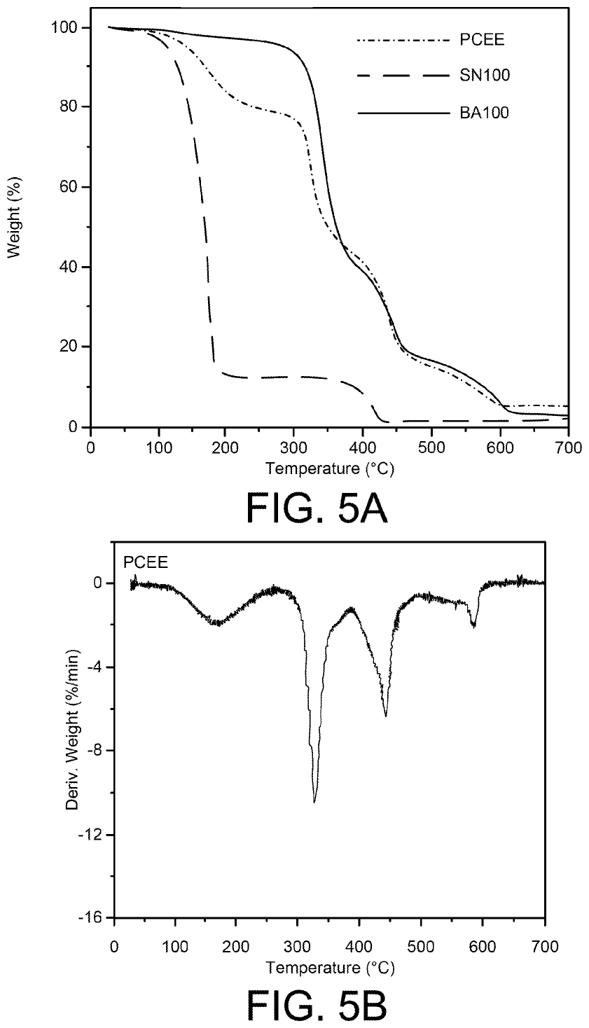

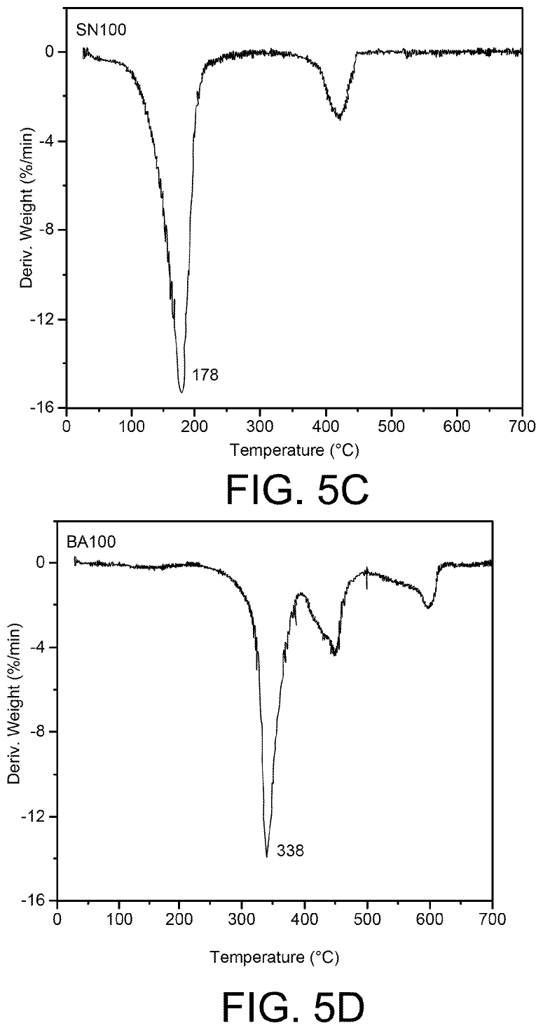

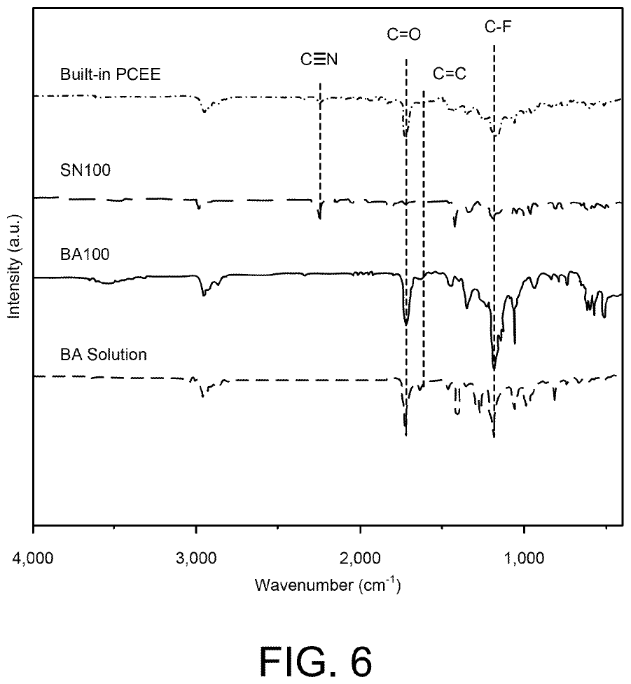

The synthesized PCEE showed a high mechanical elasticity owing to the elastomer matrix (FIG. 2B). Three-dimensional tomography and scanning electron microscopy (SEM) images showed that PCEE had an interconnected network structure in which worm-shaped polymer ducts were three-dimensionally connected (FIGS. 1B, 1C, FIG. 3). In detail the SN phase was well enclosed by the cross-linked polymer phase, and the interface between the SN phase and the elastomer matrix was smoothly connected, as revealed by transmission electron microscopy (TEM) (FIG. 1D). The electron energy-loss spectroscopy elemental mapping image confirmed that nitrogen (N) of the SN phase was embedded within oxygen (O) of the BA-based elastomer matrix (FIG. 1E). Without wishing to be bound by any theory, this unique structure was attributed to nanoscale phase separation during PIPS, which was driven by the increase in the molecular weight of polymerized BA/PEGDA and the enthalpic interactions between the SN and the emerging polymer. Importantly, the coarsening of the resulting SN phase was effectively suppressed by the elastomer matrix, allowing the formation of the 3D interconnected SN phase as an effective ion-conducting pathway within the BA-based elastomer. In addition, differential scanning calorimetry, thermogravimetric analysis, and Fourier transform infrared spectroscopy revealed that PCEE showed the characteristics of both the plastic crystal and the rubbery polymer phases (FIGS. 4-6).

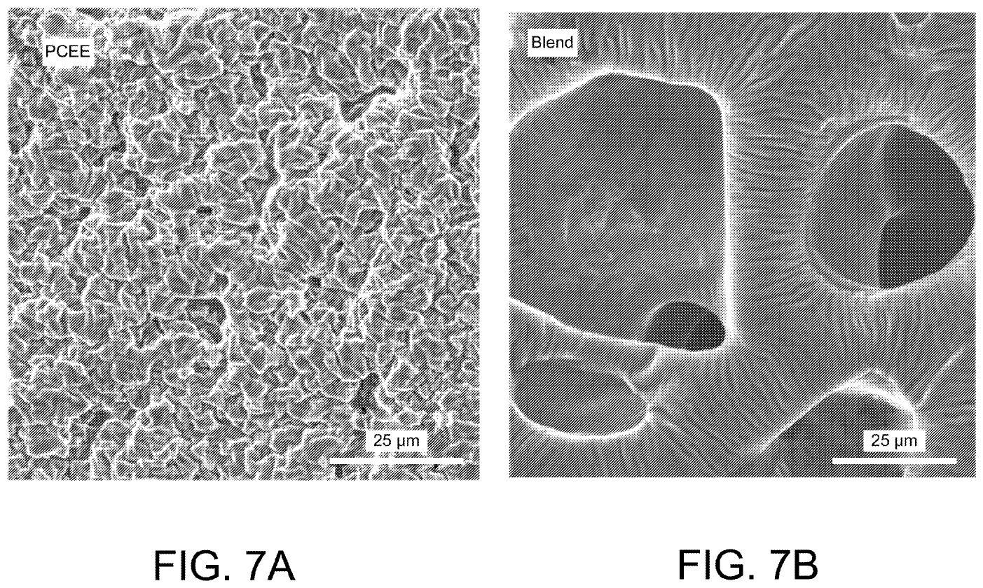

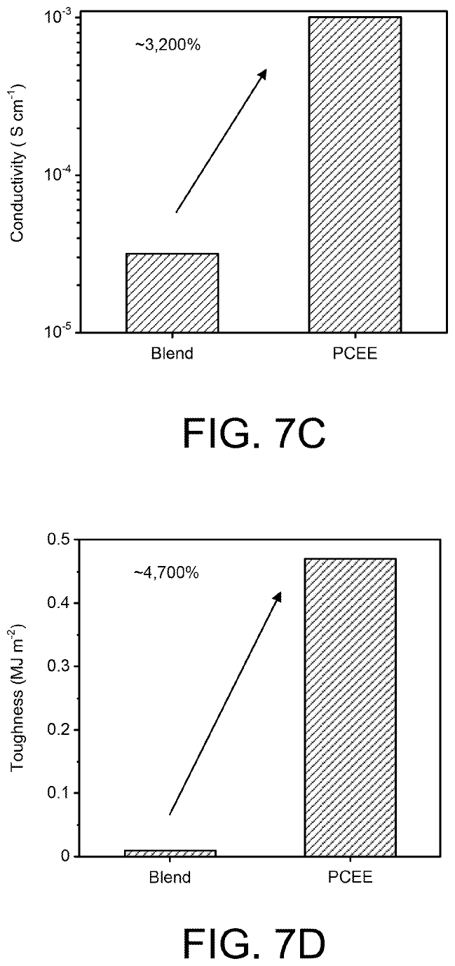

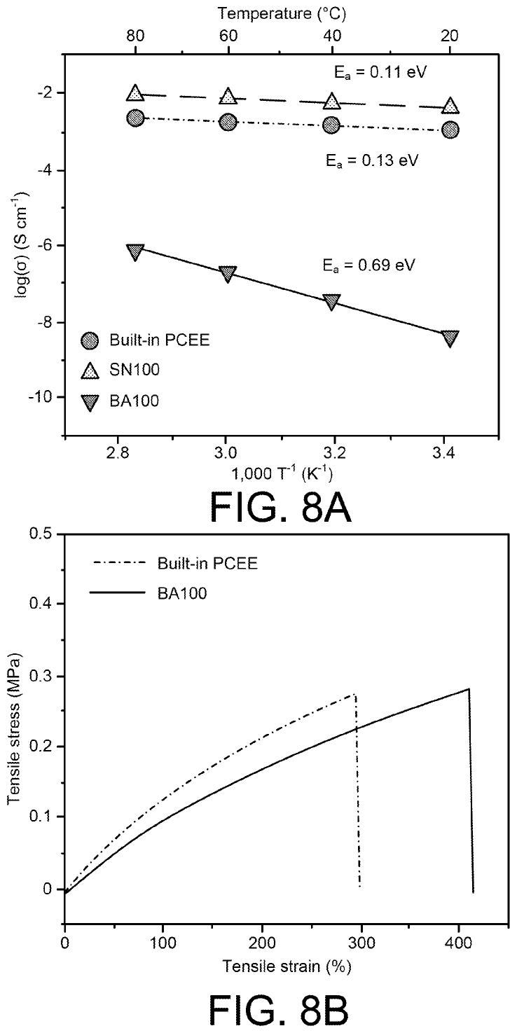

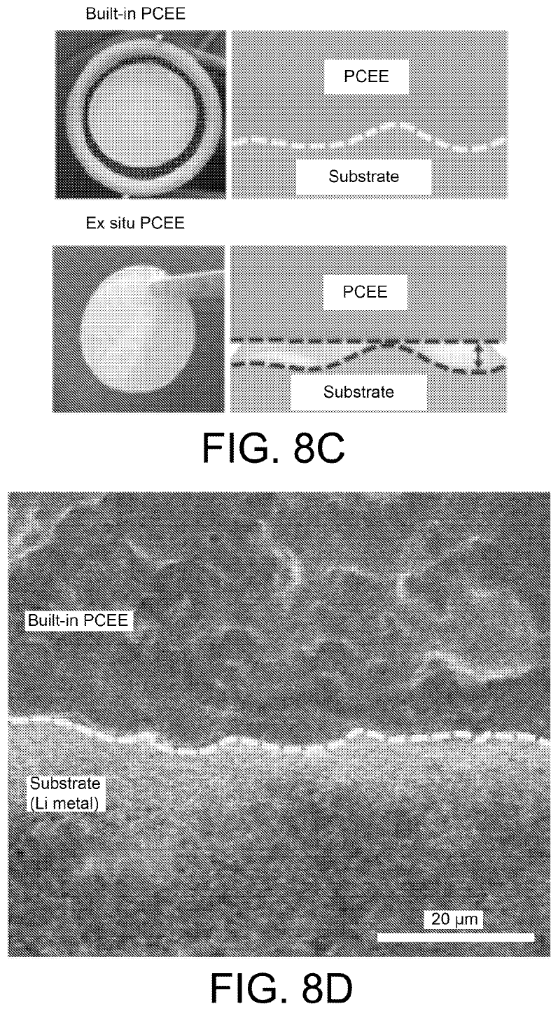

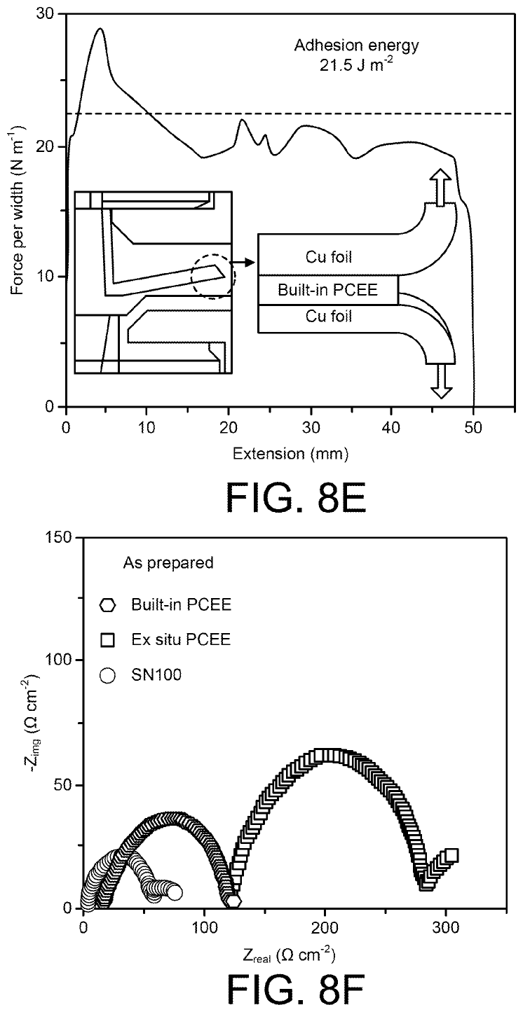

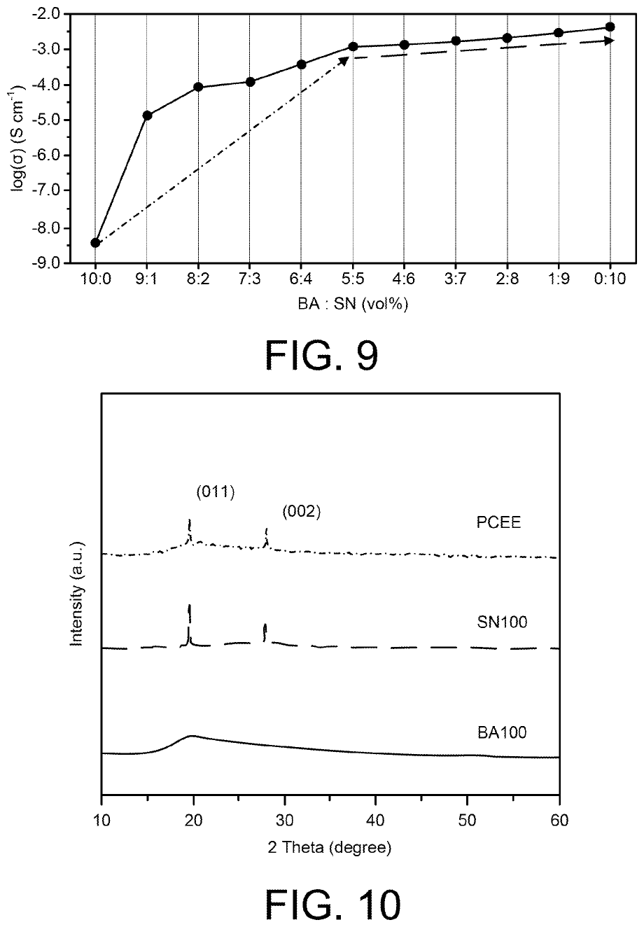

It should be noted that the unique structure of PCEE is completely different from that of a conventional blend (FIGS. 7A-7D). The simple blend of BA-based polymer (BA100) and SN without involving PIPS showed macroscopically separated morphologies. The ionic conductivity and tensile toughness of the blend are substantially inferior by factors of 32 and 47, respectively, compared with those of PCEE (FIG. 7C, 7D). The interconnected nature of the SN phase in PCEE was further studied by temperature-dependent ionic conductivity measurements. Despite the low ionic conductivity of BA100 (about 10⁻⁶ mS cm⁻¹ at 20° C.), PCEE exhibited a high ionic conductivity of 1.1 mS cm⁻¹ at 20° C., which was slightly lower than that of the SN-LiTFSI complex (SN100; 4.1 mS cm⁻¹ at 20° C.; FIG. 8A, FIG. 9). The activation energy (Ea) of the built-in PCEE was estimated to be 0.13 eV, which was comparable to that of SN100 (0.11 eV) but much smaller than that of BA100 (0.69 eV).

Considering the volume fraction of the SN conducting phase in PCEE, the tortuosity of the continuous conducting phase was determined to be very low (1.9). This result suggests that the ion-conductive pathways of the continuous SN domains with high connectivity were successfully developed within the elastomer matrix of PCEE. In addition, X-ray diffraction results showed that the crystallinity of the SN phase within the elastomeric phase was well maintained, contributing to the high ionic conductivity of PCEE (FIG. 10). The superior mechanical elasticity of PCEE was demonstrated by tensile tests. PCEE showed an SN100 could not be measured owing to its extreme brittleness (FIG. 7B). Overall, the results indicate that the embedded SN network in PCEE did not compromise the mechanical robustness of the elastomer matrix.

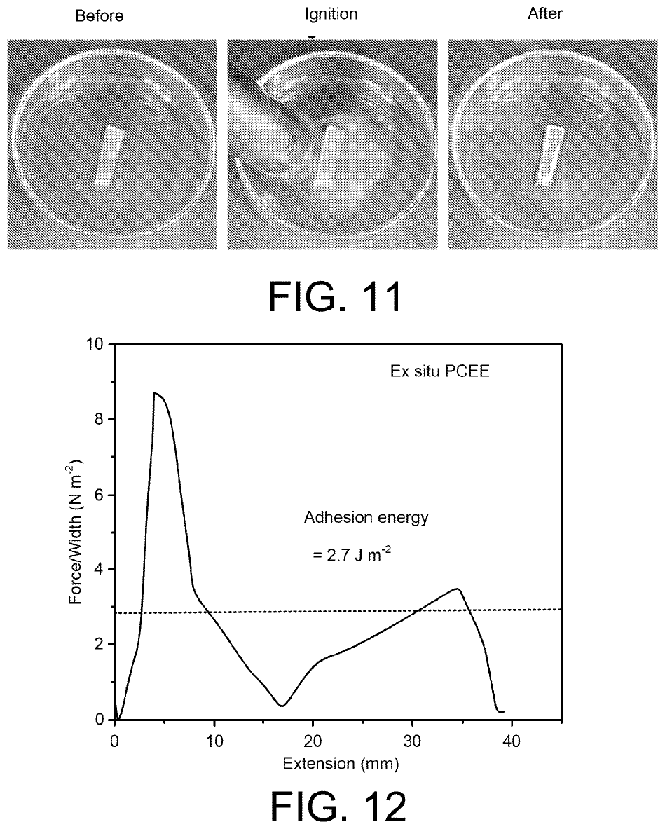

Moreover, PCEE showed excellent flame retardancy (FIG. 11). A photographic image of the built-in PCEE that was formed on Li metal is compared with that of the ex situ-synthesized PCEE (hereinafter, ‘ex-situ PCEE’) (FIG. 7C). The built-in PCEE had a seamless contact with the electrode, forming a more stable interface than the ex-situ PCEE. A cross-sectional SEM image shows that the built-in PCEE seamlessly adhered to the Li metal anode (FIG. 7D), in which the solution that initially wet the rough electrode is in situ-polymerized along the surface8. An interfacial adhesion test shows that the built-in PCEE produced a strong adhesion with the electrode, resulting in higher adhesion energy of 21.5 J m⁻² than that of the ex-situ PCEE (2.7 J m⁻²) (FIG. 7E, FIG. 12). In general, adhesion energy above 5 J m⁻² is considered to be a crucial requirement for creating a stable interface that is capable of withstanding mechanical stress during cell fabrication and operation30. In addition, electrochemical impedance spectroscopy (EIS) measurements showed that the overall resistance of the built-in PCEE was 122 Ωcm⁻², which was lower than that of the ex-situ PCEE (304 Ωcm⁻²) (FIG. 7F).

### Investigating Li Reversibility

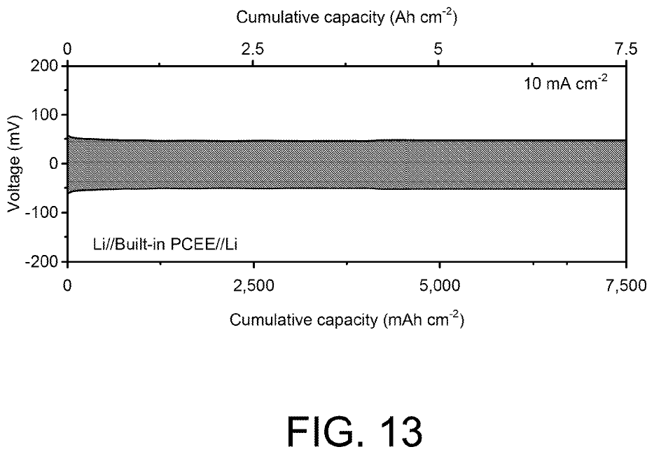

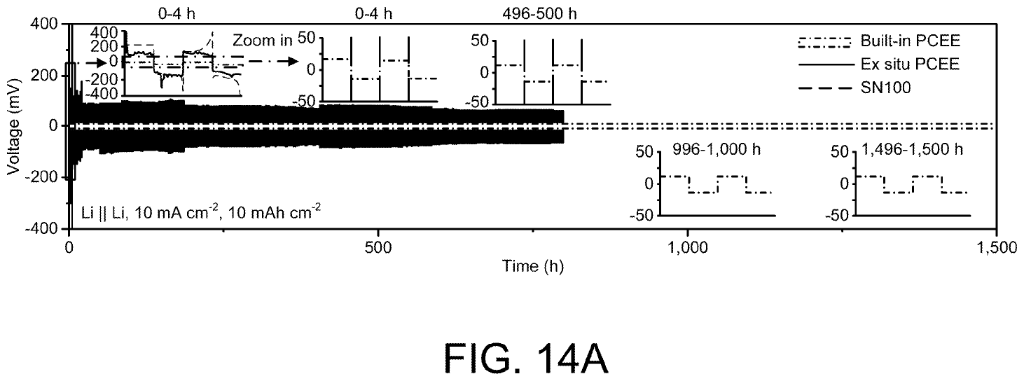

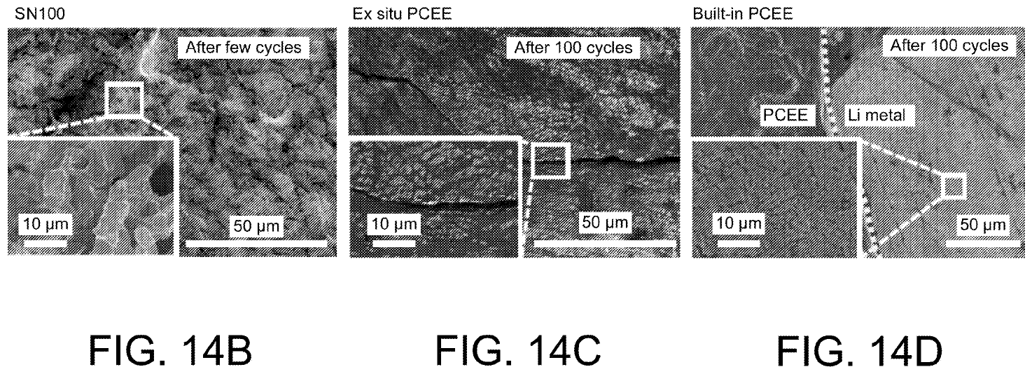

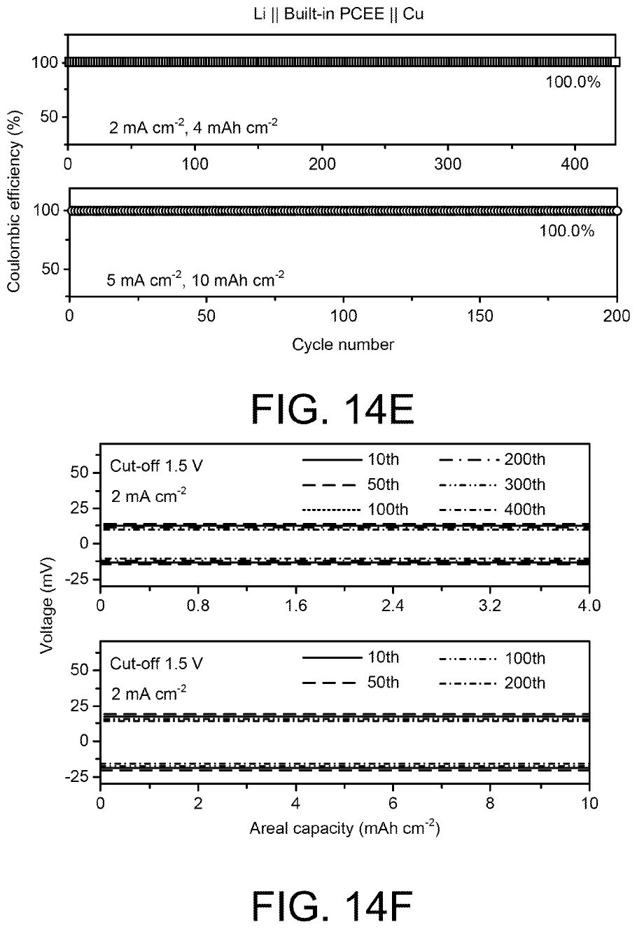

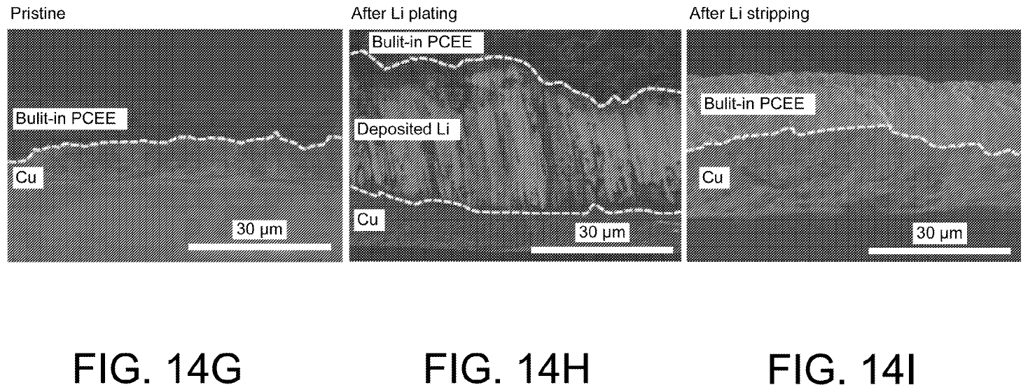

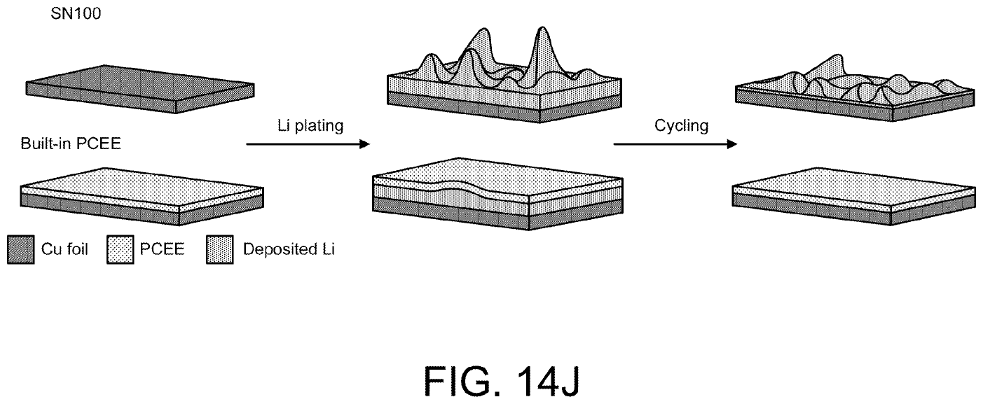

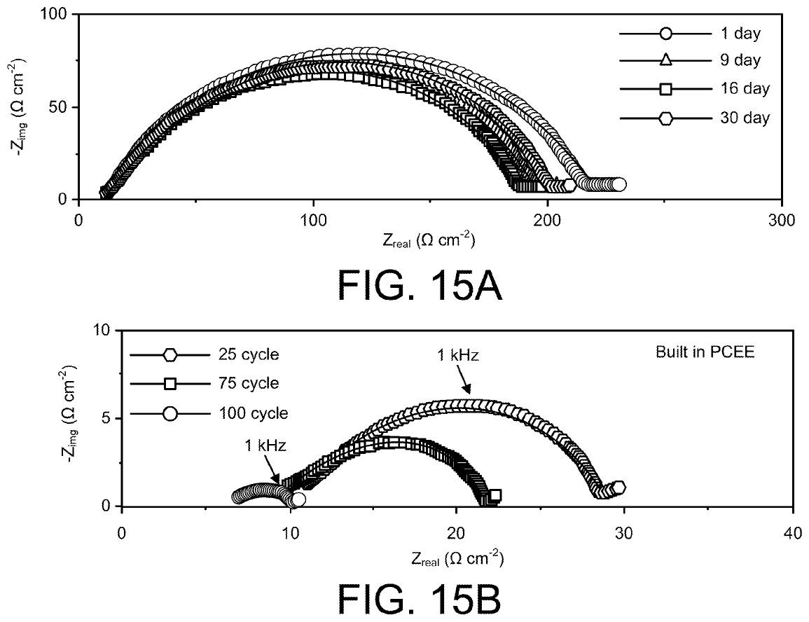

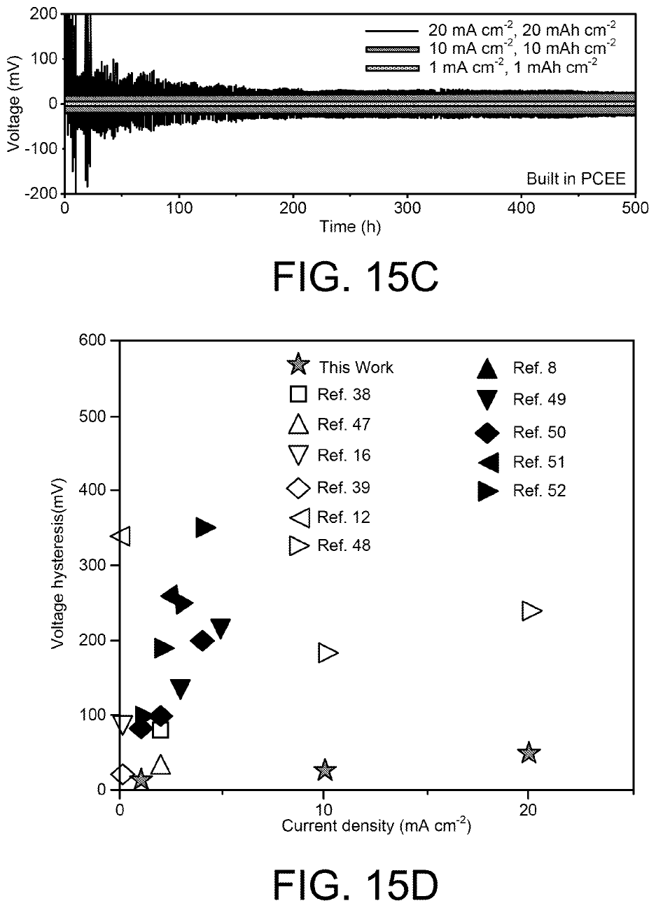

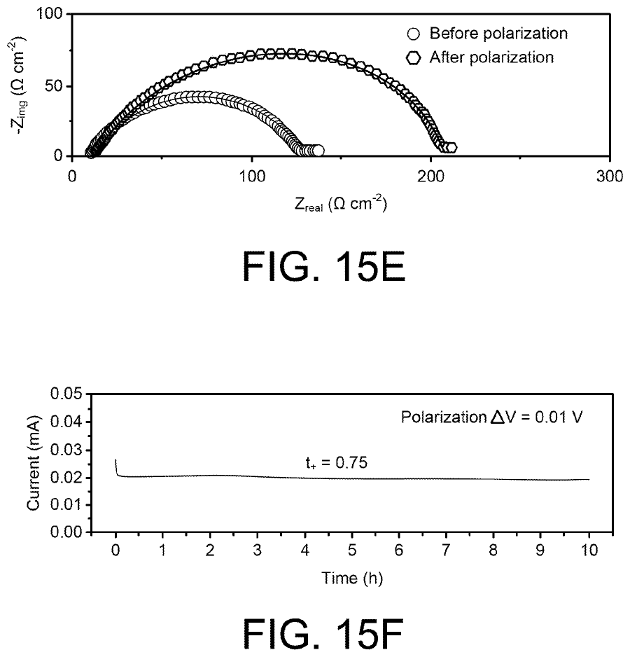

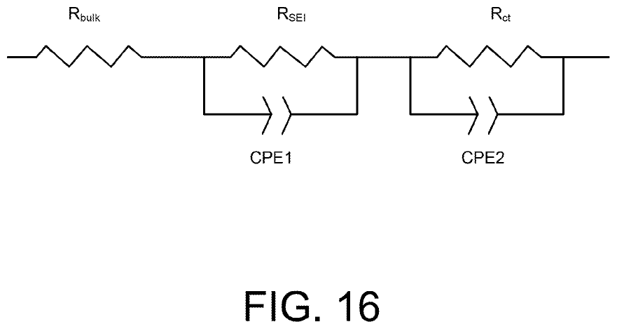

Since the built-in PCEE has demonstrated exceptional mechanical and electrochemical properties, it was decided to use it as a solid electrolyte. Li plating and stripping tests in symmetric Li cells using disclosed PCEE were performed (FIG. 14A). At a high current density of 10 mA cm⁻², the cell with SN 100 lasted for only a few cycles. In contrast, the cell with the built-in PCEE showed excellent cycling performance with low polarization over 1,500 h, reaching a cumulative capacity of 7.5 Ah cm⁻² (FIG. 13). Specifically, an extremely low polarization of 13 mV at 10 mA cm⁻² was observed for the built-in PCEE, which is considerably lower than that of the ex situ PCEE (63-111 mV). This low polarization can be attributed to the conformal coating of the built-in PCEE on Li metal, which can substantially reduce the interfacial resistance and generate a uniform Li-ion flux. It is noted that the ‘arch’ shape at the edge of the voltage profile, which is commonly observed with dendritic and dead Li accumulation, did not appear even after repeated plating and stripping of Li metal for 1,500 h (insets of FIG. 14A). These results far exceed the Advanced Research Projects Agency-Energy (ARPA-E) Integration and Optimization of Novel Ion-Conducting Solids (ION ICS) goal based on current density, cumulative capacity, and per-cycle areal capacity. The compatibility of PCEE with Li metal was further supported based on the stable interfacial resistances (175 Ωcm⁻²) for 30 days at the Li-PCEE (solid-solid) interface (FIG. 15A). In addition, as the cycle increased, the overall resistance of the built-in PCEE significantly decreased (FIG. 15B). These results demonstrate that the in situ-polymerized PCEE can effectively reduce the interfacial resistance at the solid-solid interfaces, enabling ultra-stable Li plating and stripping cycles. The morphologies of the Li metal anodes with different electrolytes were compared after 100 cycles at 10 mA cm⁻². For SN 100, Li metal showed a porous structure containing mossy and dead Li after only a few cycles (FIG. 14B), explaining the sudden failure of the Li cell (FIG. 14A). In contrast, the Li anodes with both the ex-situ and the built-in PCEEs showed a dense and uniform Li structure without dendritic Li after 100 cycles (200 h) (FIGS. 14C, 14D). However, after removing the attached PCEE film, Li metal with the built-in PCEE showed a much smoother surface (FIG. 14D) compared with that of the ex situ PCEE, which showed a wrinkled surface with cracks (FIG. 14C). The stability of the Li cell with the built-in PCEE was further investigated under higher current conditions of 20 mA cm⁻² and 20 mAh cm⁻² (FIG. 15C). After voltage fluctuations in the earlier cycles (<50 h), the Li cell showed a stable polarization of 25-29 mV for 500 h. It is noted that the voltage hysteresis of the Li cells with the built-in PCEE at various current densities was significantly lower than those of previously reported polymer-based electrolytes (FIG. 15D). Next, the t⁺ value of the built-in PCEE was determined by using the Bruce-Vincent method (FIGS. 15E, 15F, FIG. 16).

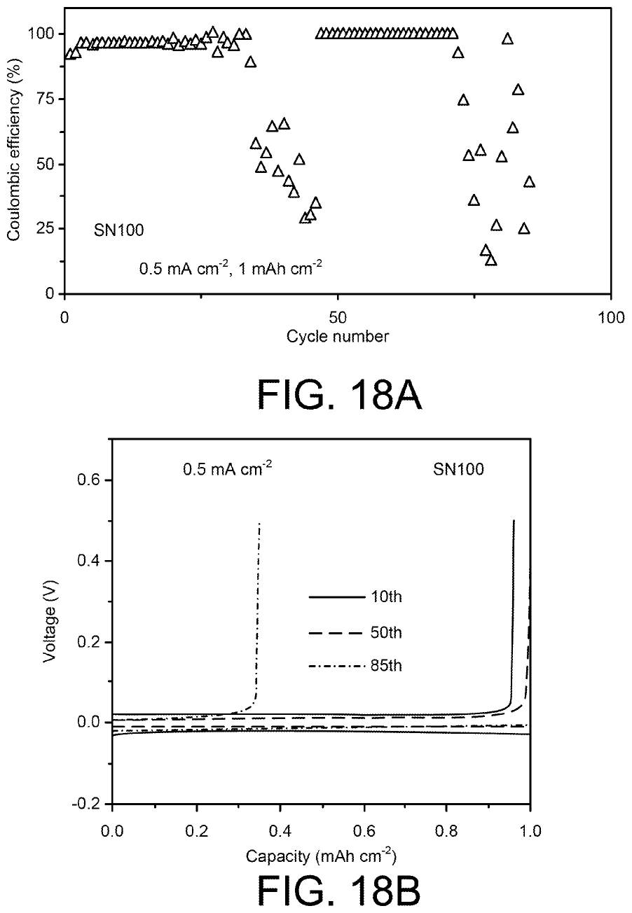

Notably, the built-in PCEE showed a high t⁺ value of 0.75, which is substantially higher than the t⁺ values of conventional organic liquid electrolytes (t⁺=0.4) and PEO-based polymer electrolyte (t⁺<0.5). This excellent stability at high-rate Li plating and stripping cycles and high t⁺ value are crucial to enabling fast charging of LMBs. In addition, an inorganic-organic hybrid SEI layer was found in the built-in PCEE, which is beneficial for interfacial stability, whereas the SEI layer derived from SN 100 was mainly composed of organic compounds (FIG. 17). The built-in PCEE also showed excellent stability and cyclability in asymmetric Li∥Cu cells (FIG. 14E). At 0.5 mA cm⁻² with 1 mAh cm⁻², the Coulombic efficiency (CE) of the Li∥Cu cell with SN100 fluctuated and faded out after 35 cycles (FIG. 18).

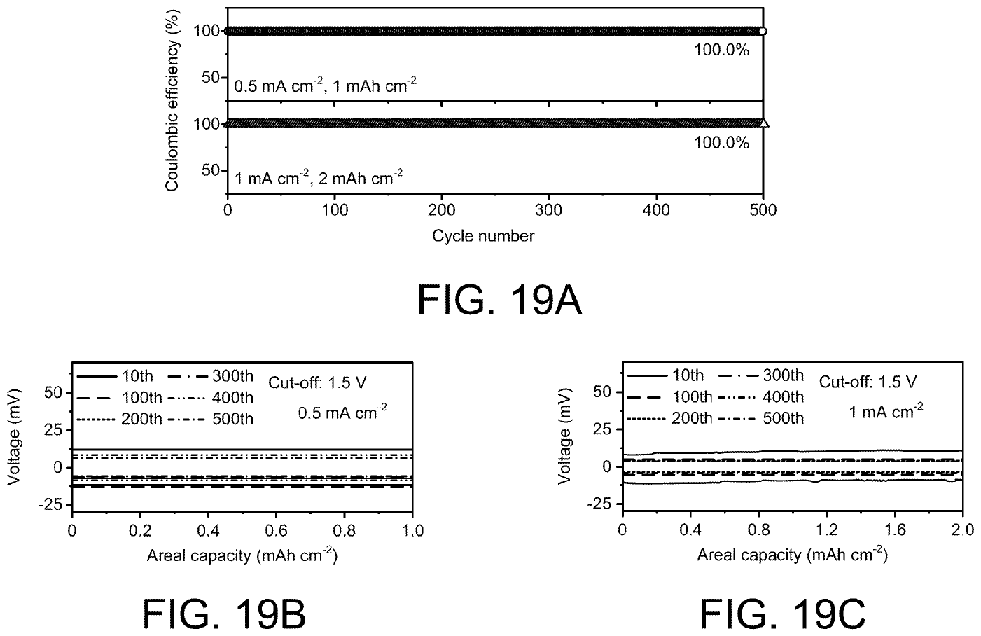

In stark contrast, the cell with the built-in PCEE showed a CE of 100.0% with a small polarization below 8 mV after 500 cycles (FIG. 19). The Li∥Cu cells with PCEEs further maintained a 100.0% CE at higher current densities of 2 mA cm⁻² and 5 mA cm⁻² with capacities of 4 mA cm-2 and 10 mAh cm-2 for 430 and 200 cycles, respectively (FIG. 14E, 14F). To better understand the cycling behavior, the morphological changes of the Li∥Cu cells with the built-in PCEE during the Li plating and stripping process were investigated. The cross-sectional SEM image showed that PCEE was conformally coated onto the copper (Cu) foil before electroplating (FIG. 14G). After the first Li plating at 0.5 mA cm⁻² with 1 mAh cm⁻², densely and uniformly deposited Li on the Cu foil was observed (FIG. 14H). After subsequent Li stripping, the Li deposited on the Cu foil disappeared completely (FIG. 14I). These results indicate that PCEE with high elasticity and strong adhesion successfully accommodated large volume changes during Li plating (FIG. 14J). In addition, the resilience of the built-in PCEE allowed the system to return to its original state without having any deformation after the stripping process. Thus, the ultra-stable cycling process of the cells with PCEE stems from its superior mechanical and interfacial properties.

### Demonstrating High-Energy Li Batteries

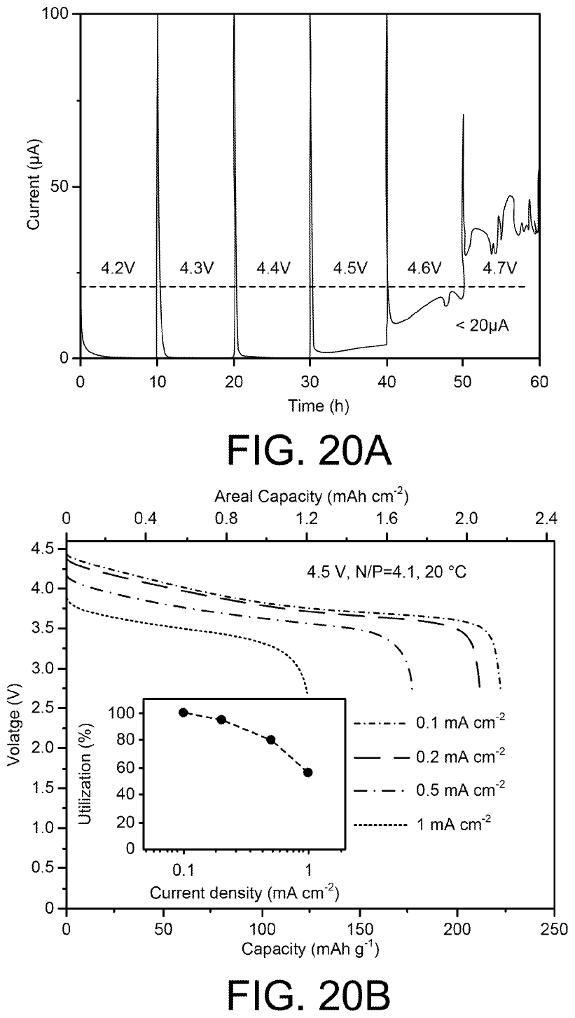

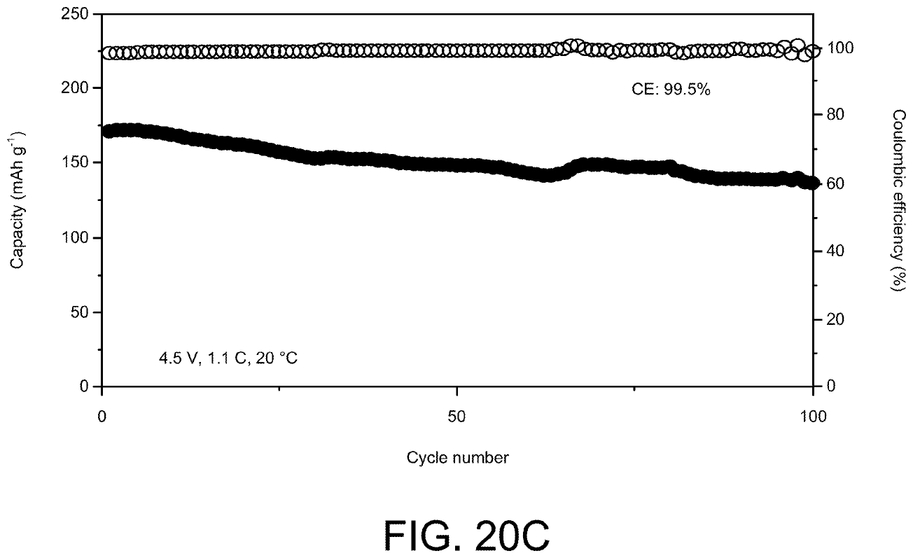

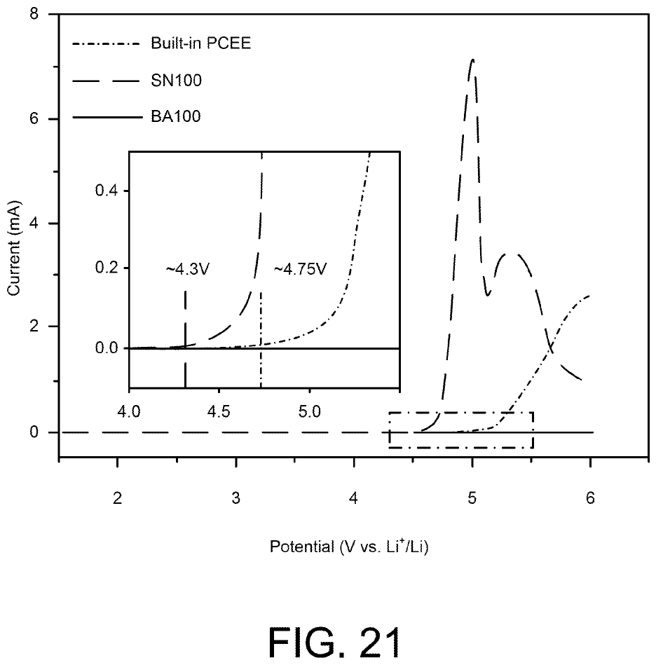

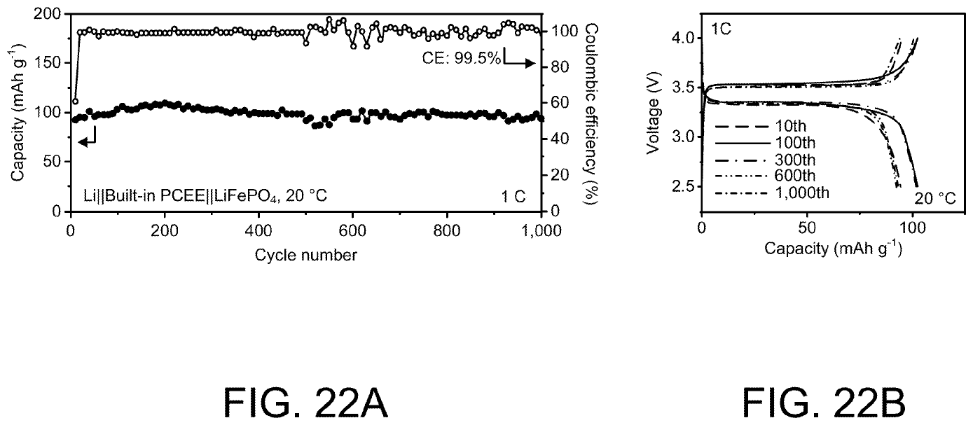

The built-in PCEE with various cathodes, including LiFePO₄ (LFP), LiNi_{0.6}Mn_{0.2}Co_{0.2}O₂ (NMC-622), and NMC-83 cathodes, for solid-state LMB applications, was investigated. Before battery performance testing, an electrochemical floating experiment of PCEE was performed to strictly define the feasible electrochemical window (FIG. 19A). The measured leakage current was less than 20 μA up to 4.6 V, which is consistent with the linear-sweep voltammetry results showing an oxidation wave at 4.75 V (FIG. 21). Thus, the excellent oxidative stability of PCEE allows for stable operation (rate capability and cycling) with NMC-622 cathodes at a high voltage of 4.5 V (FIGS. 20B, 20C). It is noted that the use of SPEs with high-voltage cathodes has been limited to a voltage of 4.3 V. Thus, this study demonstrates the stable operation of SPE-based all-solid-state LMBs at a high voltage of 4.5 V at ambient temperature. In addition, the full cell with an LFP cathode maintained a discharge capacity of 93 mAh g⁻¹ at 1 C without significant capacity fading (0.005% per cycle) over 1,000 cycles at 20° C. (FIG. 22). Towards high-energy LMBs, there is a strong demand for full cells with a limited source of Li metal anode, a high-loading cathode, and a thin solid electrolyte.

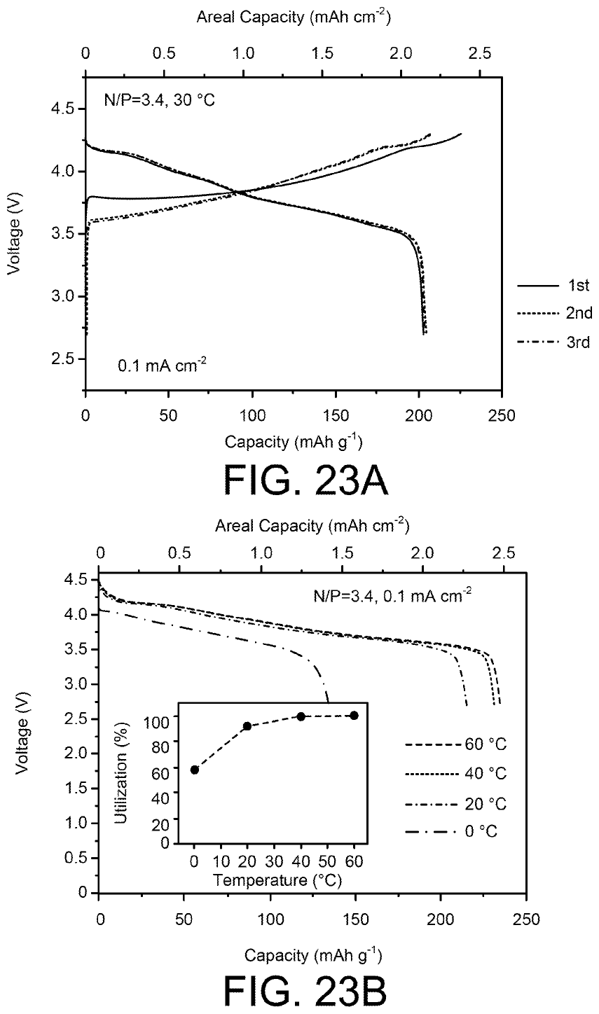

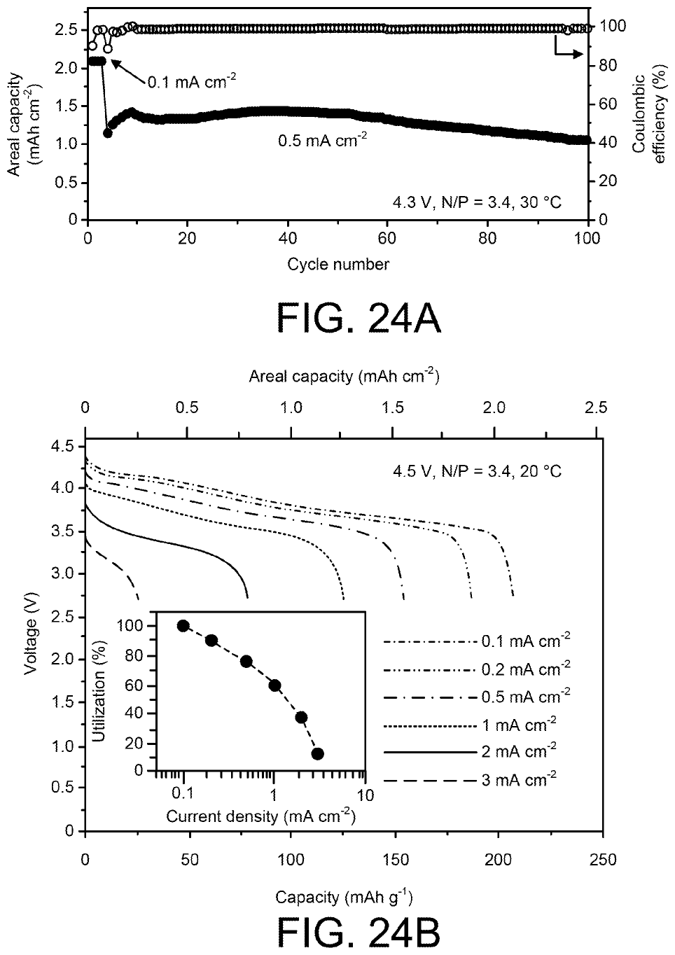

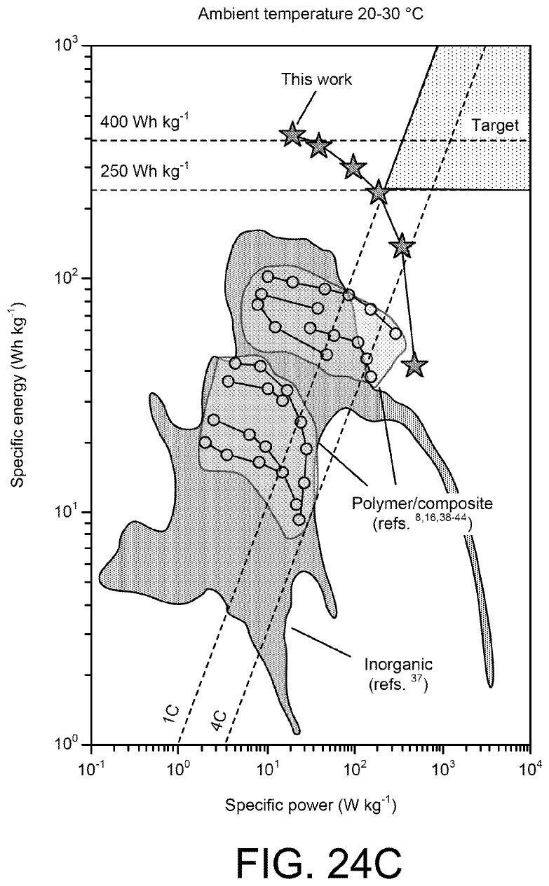

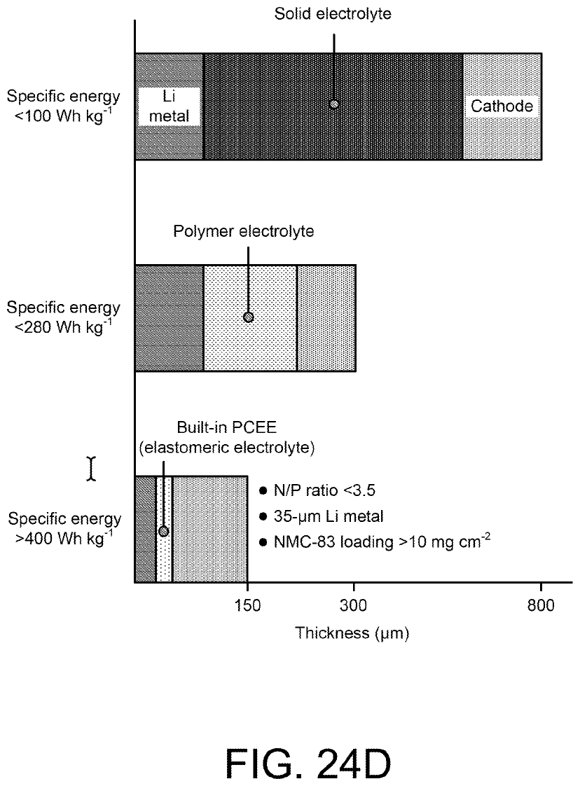

We further performed electrochemical tests of the full cell with a low negative/positive capacity (N/P) ratio of 3.4 (35-μm-thick Li anode; 25-μm-thick built-in PCEE; high-loading NMC-83 (>10 mg cm⁻²)). The full cell delivered a high capacity of 2.1 mAh cm⁻² during the initialization cycles at 0.1 mA cm⁻² (FIG. 23A). Thereafter, the cell maintained a capacity of 1.1 mAh cm⁻² (88% capacity retention) with a CE of 99.4% at 0.5 mA cm⁻² after 100 cycles at 30° C. (FIG. 24A). In addition, the rate capability of the cell was evaluated at various current densities from 0.1 mA cm⁻² to 3 mA cm⁻² (FIG. 24B). The cell exhibited a capacity of 1.3 mAh cm⁻² at a high rate of 1 mA cm⁻² (60% of its capacity at 0.1 mA cm⁻²), demonstrating excellent rate capability (inset of FIG. 24B). The temperature-dependent voltage profile of the cell from 60° C. to 0° C. (FIG. 23B) was further investigated. The full cell showed a negligible capacity drop from 60° C. to 40° C. (99%) and retained 92% of its capacity at 20° C. and 57% at 0° C. (inset of FIG. 23B).

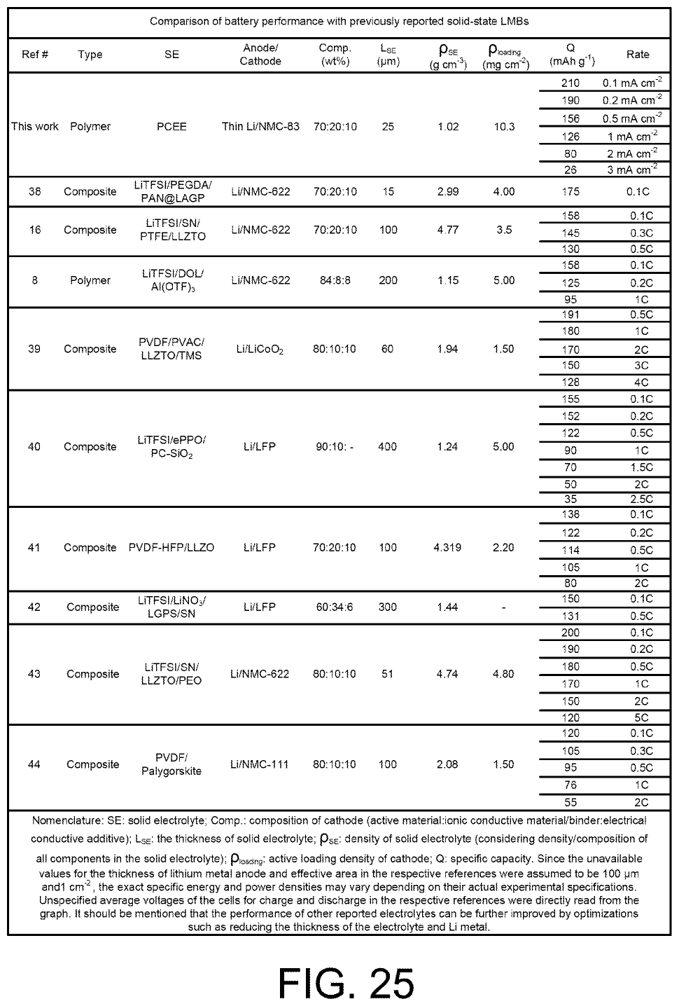

The excellent rate and low-temperature performances can be attributed to the exceptionally high ionic conductivity and t⁺ of PCEE. The specific energy and power of all-solid-state LMBs at ambient temperature were calculated based on the weight of the anode, cathode, and solid electrolyte using a Ragone-type plot (FIG. 24C, FIG. 25). The full cell with the NMC-83 cathode exhibited high specific energy exceeding 410 Wh kg⁻¹ (791 Wh kg_{NMC-}83⁻¹) and maintained high specific energy of 235 Wh kg⁻¹ at 184 W kg⁻¹ at ambient temperature. These performances of the full cell with thin PCEE are much higher than any of the previously reported cells using ceramic, polymer, or composite electrolytes tested at ambient temperature (FIGS. 23C, 23D).

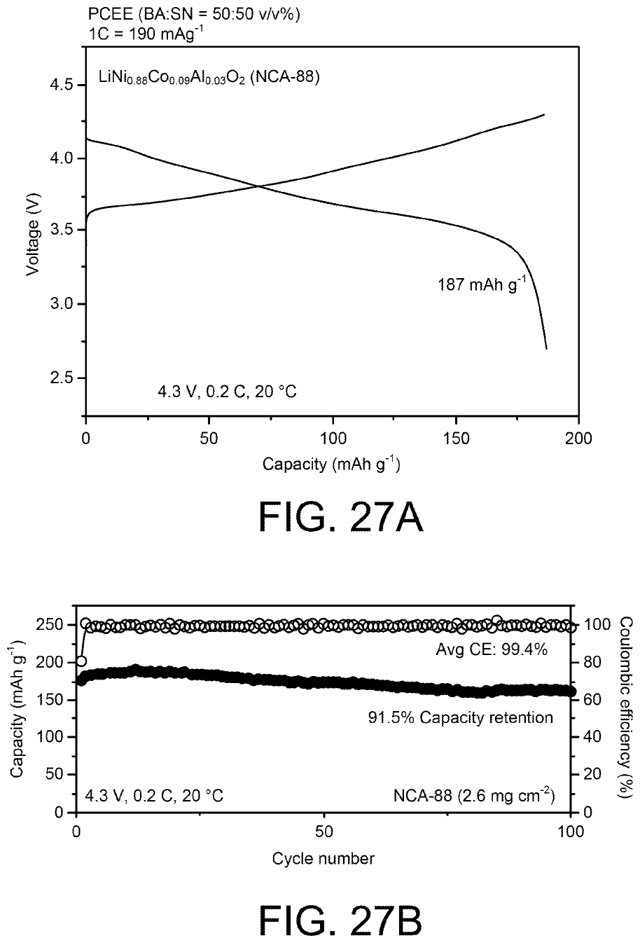

It was also found that PCC can be used for LiNiₓCo_{y}Al_{z}O₂(NCA) cathode, as shown in FIGS. 27A-27B.

### Example 3

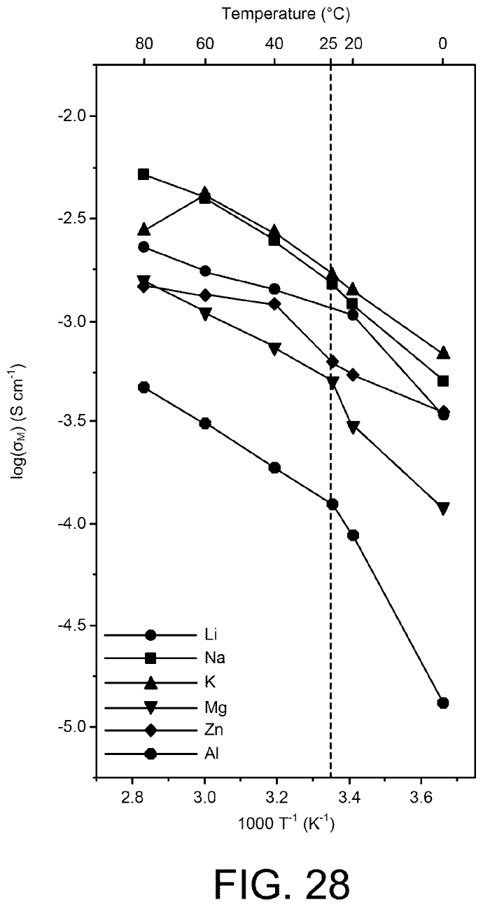

In addition to Li-ions, PCEE has high ion conductivities (FIG. 28) for various metal cations, including Na, K, Mg, Zn, and Al. Therefore, PCEE can be used for various metal batteries.

Without wishing to be bound by any theory, it was hypothesized that the specific energy of the cells can be further increased by changing the cathode structures or stacking cells multiple times. In summary, a class of SPEs based on an in situ formation of an elastomer electrolyte containing a 3D interconnected plastic crystal phase is reported. It was found that this class can successfully combine the advantages from both elastomer and plastic crystal, including high ionic conductivity, superior mechanical properties, electrochemical stability, low interfacial resistance, and high Li-ion transference number. The built-in PCEEs enabled excellent cycling performances in the symmetric Li and asymmetric Li∥Cu cells with low voltage hysteresis below 26 mV and 100.0% CEs. Finally, under the constrained conditions of a limited Li source and a high-loading NMC cathode (N/P ratio <3.4), the stable operation of a PC FE-based solid-state LMB with high specific energy and power at ambient temperature was demonstrated. Without wishing to be bound by any theory, it is assumed that disclosed herein elastomeric electrolyte system can be widely applied to the operation of various post-metal (for example, sodium, potassium, zinc, magnesium, and aluminum) batteries, including metal-air and metal-sulfur batteries, because of its excellent mechanical properties and high ionic conductivity.

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### Aspects

In view of the described electrodes, batteries, and methods and variations thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Aspect 1: A polymer composition comprising: a) a matrix comprising an elastomeric polymer; b) a plurality of plastic crystals dispersed within the matrix to form a three-dimensional interconnected phase of plastic crystals, and wherein the polymer composition exhibits an ionic conductivity of at least about 1.1 mS/cm at about 20° C.

Aspect 2: The polymer composition of Aspect 1, wherein the elastomeric polymer is derived from at least one monomer comprising:

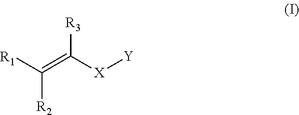

wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), (C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl, wherein X is C(O), O, or null, wherein Y is OR₄, R₄, R₄′OR₄″, C(O)R₄, N(R₄)(R₄′″), or ON;
wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆-C₁₄ aryl), —(C₀₋₅ alkyl)(C₁-C₁₃ heteroaryl), —(C₀₋₅ alkyl)(C₆-C₁₄ aryloxy), —(C₀₋₅ alkyl)(C₃-C₁₀ cycloalkyl), —(C₀₋₅ alkyl)(C₃-C₁₀ heterocycloalkyl), —(C₀₋₅ alkyl)(C₃-C₁₀ cycloalkenyl), —(C₀₋₅ alkyl)(C₃-C₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl; or wherein R₄″ is P(O)(OR₄″)₂;
wherein R₄″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl, and wherein n is 1 to 200.

Aspect 3: The polymer composition of Aspect 2, wherein X is C(O), Y is OR₄, R₄′OR₄″, or N(R₄)(R₄′″).

Aspect 4: The polymer composition of Aspect 2, wherein X is O, Y is C(O)R₄.

Aspect 5: The polymer composition of Aspect 2, wherein X is null, Y is CN.

Aspect 6: The polymer composition of any one of Aspects 2-5, wherein (I) is selected from one or more of:

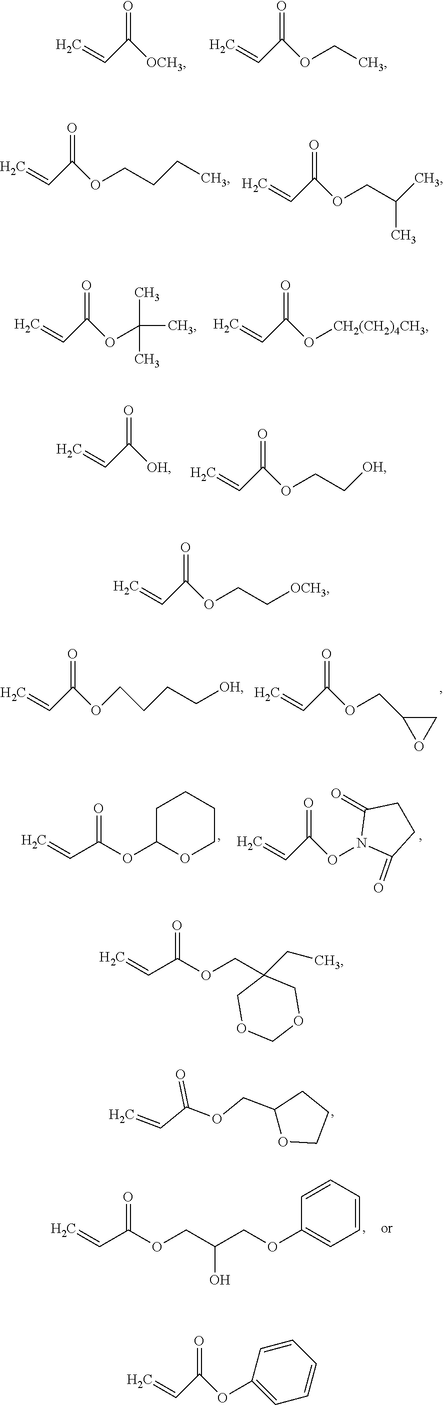

Aspect 7: The polymer composition of any one of Aspects 2-6, wherein (I) is selected from one or more of:

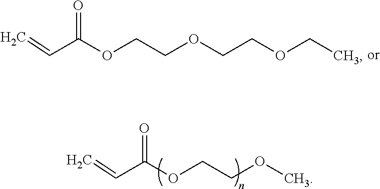

Aspect 8: The polymer composition of any one of Aspects 2-7, wherein (I) is selected from one or more of:

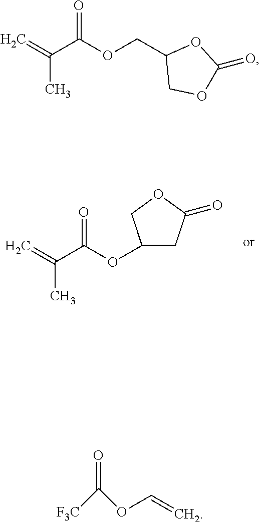

Aspect 9: The polymer composition of any one of Aspects 2-8, wherein (I) is selected from one or more of:

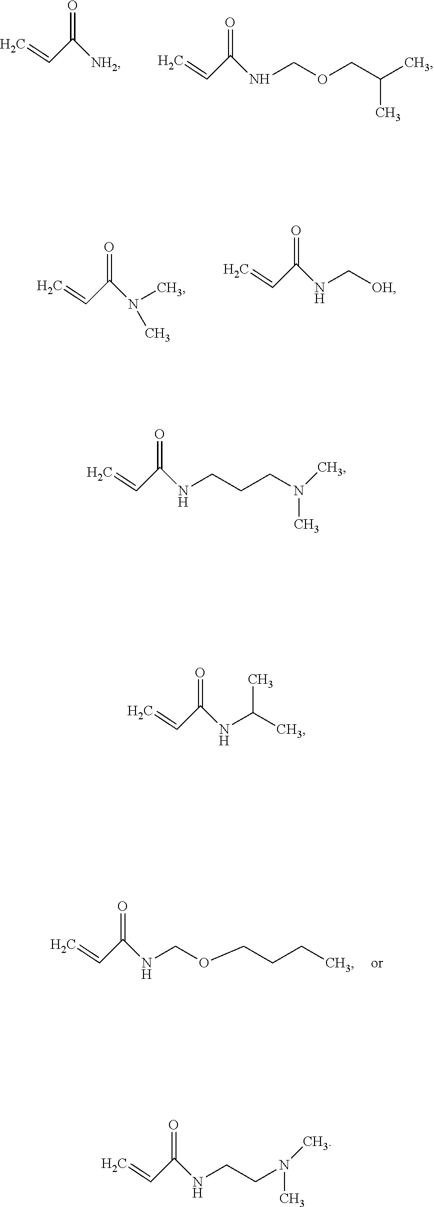

Aspect 10: The polymer composition of any one of Aspects 2-9, wherein (I) is selected from one or more of:

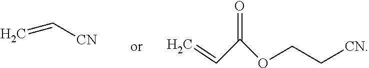

Aspect 11: The polymer composition of any one of Aspects 2-10, wherein (I) comprises

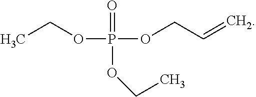

Aspect 12: The polymer composition of any one of Aspects 1-11, wherein the plurality of plastic crystals are derived from one or more:

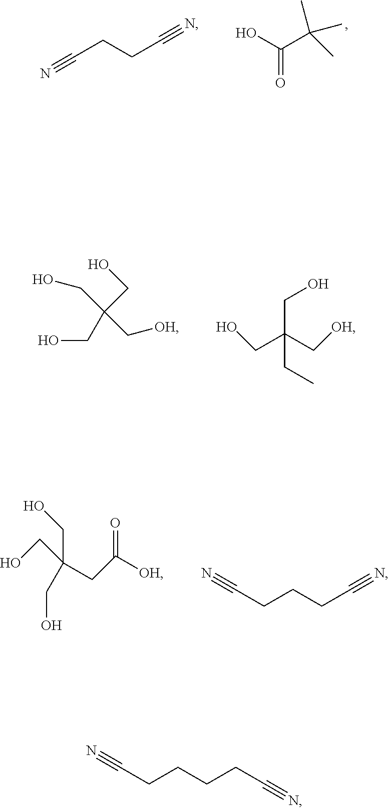

or a combination thereof.

Aspect 13: The polymer composition of any one of Aspects 1-12, further comprising a metal salt, wherein a cation of metal salt comprises one or more of Li, K, Na, Ca, Mg, Zn, Al, or a combination thereof.

Aspect 14: The polymer composition of Aspect 13, wherein an anion of metal salt comprises bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

Aspect 15: The polymer composition of any one Aspects 1-14, wherein the polymer composition is crosslinked.

Aspect 16: The polymer composition of any one of Aspects 1-15, wherein the polymer composition has a tensile strain from about 150% to about 500%.

Aspect 17: The polymer composition of any one of Aspects 1-16, wherein the polymer composition is flame retardant.

Aspect 18: The polymer composition of any one of Aspects 1-17, wherein the polymer composition is stable in a temperature range from about −30° C. to about 100° C.

Aspect 19: The polymer composition of any one of Aspects 13-18, wherein an ion transfer number of the cation is greater than about 0.4.

Aspect 20: A solid electrolyte comprising the polymer composition of any one of Aspects 1-19.

Aspect 21: A battery comprising the solid electrolyte of Aspect 20.

Aspect 22: A polymer composition formed by polymerizing a mixture comprising: a) one or more monomers of Formula (I), b) a plurality of plastic crystals; and c) a salt AB, wherein

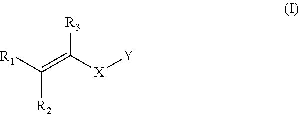

wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), (C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein X is C(O), O, or null,
wherein Y is OR₄, R₄, R₄′OR₄″, C(O)R₄, N(R₄)(R₄′″), or ON;
wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
or wherein R₄″ is P(O)(OR₄′″)₂;
wherein R₄′″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein n is 1 to 200;
wherein A is selected from Li, K, Na, Ca, Mg, Zn, Al, or a combination thereof; and
B is selected from bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

Aspect 23: The polymer composition of Aspect 22, wherein the mixture further comprises a cross-linker.

Aspect 24: The polymer composition of Aspect 23, wherein the cross-linker comprises one or more of:

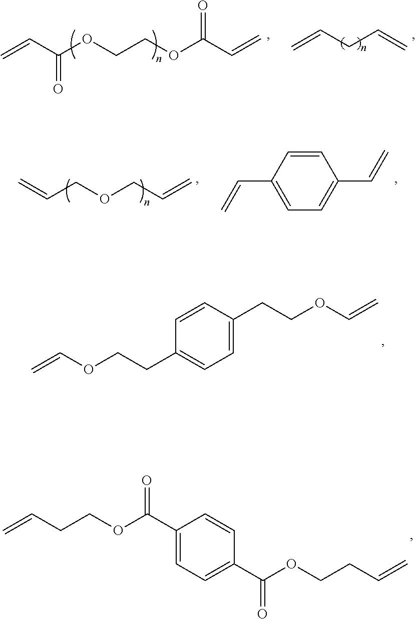

or a combination thereof and wherein n is from 1 to 30.

Aspect 25: The polymer composition of any one of Aspects 22-24, wherein the plurality of plastic crystals are derived from one or more:

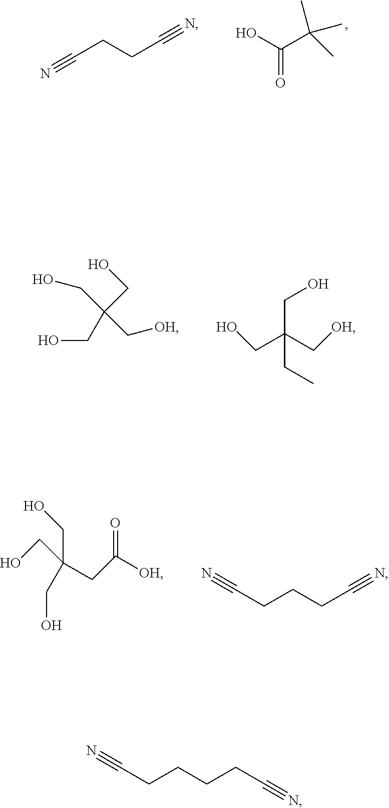

or a combination thereof.

Aspect 26: The polymer composition of any one of Aspects 22-25, wherein X is C(O), Y is OR₄, R₄′OR₄″, or N(R₄)(R₄′″).

Aspect 27: The polymer composition of any one of Aspects 22-25, wherein X is O, Y is C(O)R₄.

Aspect 28: The polymer composition of any one of Aspects 22-25, wherein X is null, Y is CN.

Aspect 29: The polymer composition of any one of Aspects 22-28, wherein (I) is selected from one or more of:

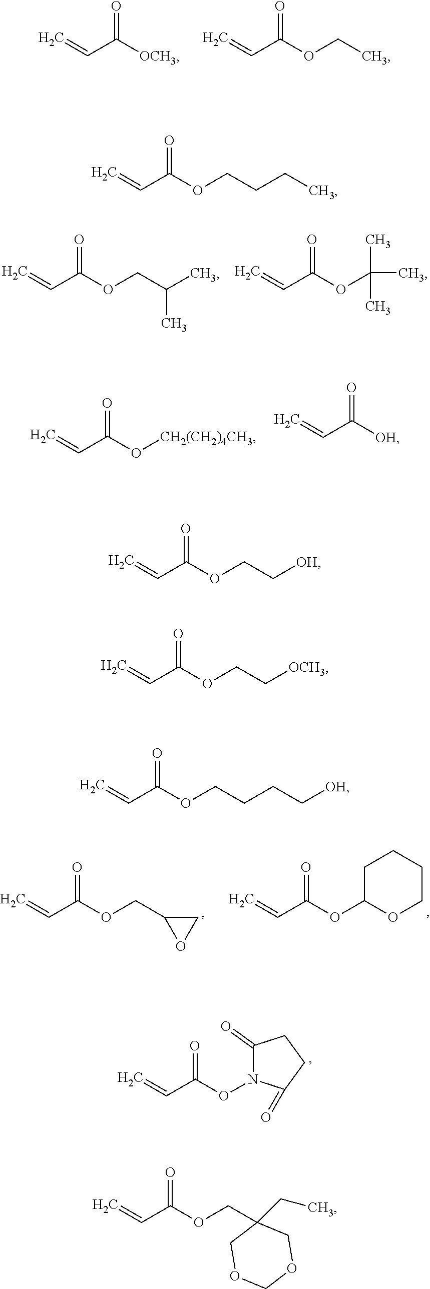

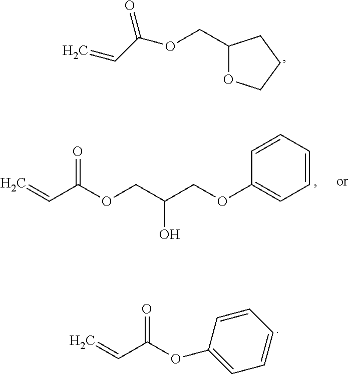 [SMILES: C=CC(=O)OCC1CCCO1 ; C=CC(=O)OCC(O)COc1ccccc1 ; C=CC(=O)Oc1ccccc1]

Aspect 30: The polymer composition of any one of Aspects 22-29, wherein (I) is selected from one or more of:

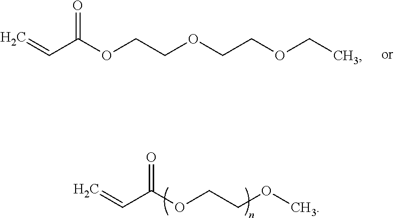

Aspect 31: The polymer composition of any one of Aspects 22-30, wherein (I) is selected from one or more of:

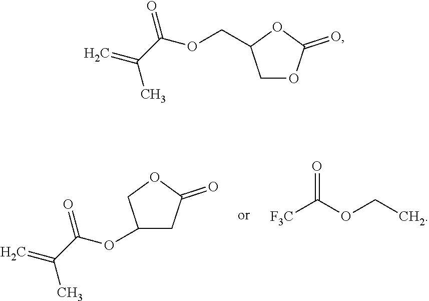

Aspect 32: The polymer composition of any one of Aspects 22-31, wherein (I) is selected from one or more of:

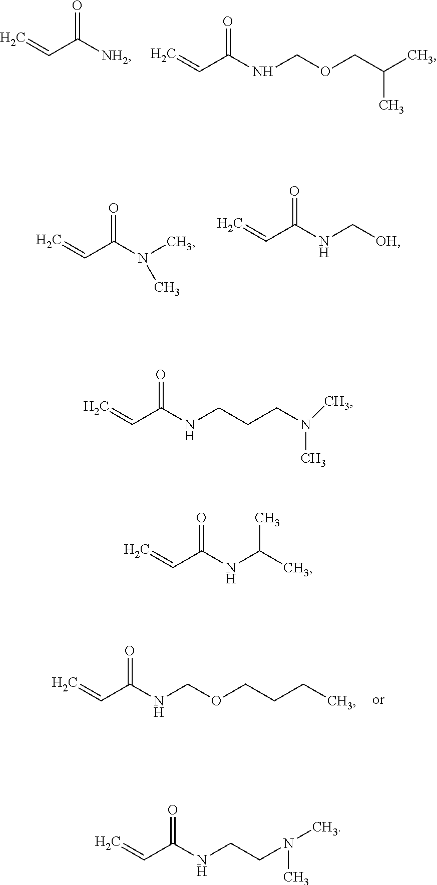

Aspect 33: The polymer composition of any one of Aspects 22-32, wherein (I) is selected from one or more of:

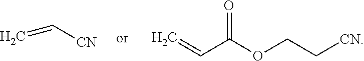

Aspect 34: The polymer composition of any one of Aspects 22-33, wherein (I) comprises:

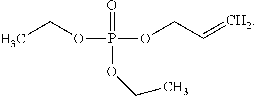

Aspect 35: The polymer composition of any one of Aspects 22-34, wherein the mixture further comprises an initiator.

Aspect 36: The polymer composition of Aspect 35, wherein the initiator comprises a thermal initiator, a photoinitiator, or a combination thereof.

Aspect 37: The polymer composition of Aspect 36, wherein the initiator comprises azobisisobutyronitrile, benzoyl peroxide, or a combination thereof.

Aspect 38: The polymer composition of Aspect 35, wherein the polymerization is a thermal polymerization.

Aspect 39: The polymer composition of Aspect 38, wherein the initiator comprises bis(2,4,6-trimethylbenzoyl)-phenylphosphine oxide (Irgacure 819), 2-hydroxyl-2-methyl-1-phenyl-1-propanone, methyl benzoylformate, Hydroxycyclohexyl phenyl ketone (Igracure 184), or a combination thereof.

Aspect 40: The polymer composition of Aspect 39, wherein the polymerization is a photopolymerization.

Aspect 41: The polymer composition of any one of Aspects 23-40, wherein the polymer composition is synthesized by polymerizing a homogeneous solution comprising butyl acrylate (BA), poly(ethylene glycol) diacrylate (PEGDA), succinonitrile (SN), and LiTFSI.

Aspect 42: The polymer composition of any one of Aspects 22-41, wherein the plurality of plastic crystals dispersed within the polymer composition to form a three-dimensional interconnected phase of plastic crystals and wherein the polymer composition exhibits an ionic conductivity of at least about 1.1 mS/cm at about 20° C.

Aspect 43: The polymer composition of any one of Aspects 22-41, wherein the polymer composition has a tensile strain from about 150% to about 500.

Aspect 44: The polymer composition of any one of Aspects 22-43, wherein the polymer composition is flame retardant.

Aspect 45: The polymer composition of any one of Aspects 22-44, wherein the polymer composition is stable in a temperature range from about −30° C. to about 100° C.

Aspect 46: The polymer composition of any one of Aspects 22-45, wherein an ion transference number of the A is greater than about 0.4.

Aspect 47: A solid electrolyte comprising the polymer composition of any one of Aspects 1-46.

Aspect 48: A battery comprising the solid electrolyte of Aspects 47.

Aspect 49: An electrochemical cell comprising the solid electrolyte Aspects 20 or 47.

Aspect 50: The electrochemical cell of Aspect 49 further comprising: an anode electrode; and a cathode electrode; wherein the anode electrode and the cathode electrode are in electrical communication with the solid electrolyte.

Aspect 51: The electrochemical cell of Aspect 50, wherein the anode electrode comprises a metal material.

Aspect 52: The electrochemical cell of Aspect 51, wherein the metal material comprises Li, Ca, Na, K, Mg, Zn, Al, alloys thereof, or a combination thereof.

Aspect 53: The electrochemical cell of any one of Aspects 50-52, wherein the cathode electrode the cathode is a metal cathode or a composite cathode.

Aspect 54: The electrochemical cell of Aspect 53, wherein the cathode comprises copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium cobalt oxide) cathode, lithium-nickel-cobalt-aluminum oxide material (LNCAO), lithium-nickel-manganese-cobalt oxide (LNMCO), LFP (lithium iron phosphate) cathode, fluoride-based cathode, sulfur selenium cathode, sulfur selenium tellurium cathode, spinels, olivines, or any combination thereof.

Aspect 55: The electrochemical cell of Aspect 54, wherein the cathode electrode comprises Na₃V₂(PO₄)₃ (NVP), LNMCO, Na₃V₂(PO₄)₂F₃ (NVPF), KMnFe(CN)₆, MnO₂, V₂O₅, graphite, LiFePO₄, LiCoO₂, LiMnO₂, derivatives thereof, or a combination thereof.

Aspect 56: The electrochemical cell of any one of Aspects 50-55, wherein the anode material comprises Li.

Aspect 57: The electrochemical cell of Aspect 56, wherein Li is a metal.

Aspect 58: The electrochemical cell of any one of Aspects 54-57, wherein the cathode material comprises Li metal, LiNi_{1-x-y}MnₓCo_{y}O₂, or LiNi_{1-a-b}CoₐAl_{b}O₂, wherein 1≥x≥0, 1≥y≥0, 1≥a≥0, and 1≥b≥0.

Aspect 59: The electrochemical cell of Aspect 58, wherein the cathode material comprises LiCoO₂, LiNi_{0.9}Mn_{0.05}Co_{0.05}O₂, LiNi_{0.6}Mn_{0.2}Co_{0.2}O₂, LiNi_{0.83}Mn_{0.06}Co_{0.11}O₂, or LiNi_{0.88}Co_{0.09}Al_{0.03}O₂, LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, or a LiNi_{0.8}Mn_{0.1}C_{0.1}O₂ composite cathode.

Aspect 60: The electrochemical cell of any one of Aspects 48-58, wherein the cell exhibits a cyclic Coulombic efficiency greater than about 99.5% for about 1,000 cycles at a current density from about 0.1 mA cm⁻² to about 10 mA cm⁻².

Aspect 61: The electrochemical cell of any one of Aspects 58-59, wherein the cell is configured to provide a specific energy of about 350 to about 520 watt-hours per kilogram of the anode, cathode, and the solid electrolyte after about 500 cycles at a specific energy of about 150 to about 500 W/kg.

Aspect 62: The electrochemical cell of any one of Aspects 50-61, wherein the cell exhibits a substantially stable plating and stripping cycling for at least about 500 hours at a current density from about 0.1 mA cm⁻² to about 10 mA cm⁻².

Aspect 63: The electrochemical cell of any one of Aspects 50-62, wherein the cell exhibits a substantially stable plating and stripping cycling for up to about 1500 hours at a current density from about 0.1 mA cm⁻² to about 10 mA cm⁻².

Aspect 64: The electrochemical cell of any one of Aspects 50-63, wherein the cell exhibits a reversible capacity up to about 200 mAh/g.

Aspect 65: The electrochemical cell of any one of Aspects 49-64, wherein the solid electrolyte is formed in-situ.

Aspect 66: The electrochemical cell of any one of Aspects 49-65, wherein the anode is substantially dendrite free during a plating cycle.

Aspect 67: A battery comprising the electrochemical cell of any one of Aspects 49-66.

Aspect 68: The battery of Aspect 67, wherein the battery is a secondary battery.

Aspect 69: A method of making of the polymer composition of any one of Aspects 1-19 or 22-46.

Aspect 70: The method of making a polymer composition comprising: a) forming a mixture comprising: i) one or more monomers of Formula (I), ii) a plurality of plastic crystals; iii) a salt AB, and polymerizing the mixture to form the polymer composition; wherein

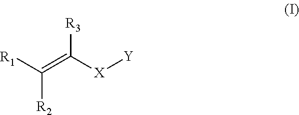

wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,

wherein X is C(O), O, or null,
wherein Y is OR₄, R₄, R₄′OR₄″, C(O)R₄, N(R₄)(R₄′″), or ON;
wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl-)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
or wherein R₄″ is P(O)(OR₄′″)₂;
wherein R₄′″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein n is 1 to 200; wherein A is selected from Li, K, Na, Ca, Mg, Zn, Al, or a combination thereof; and B is selected from bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

Aspect 71: The method of Aspect 70, wherein the mixture further comprises a cross-linker.

Aspect 72: The method of Aspect 71, wherein the cross-linker comprises one or more of:

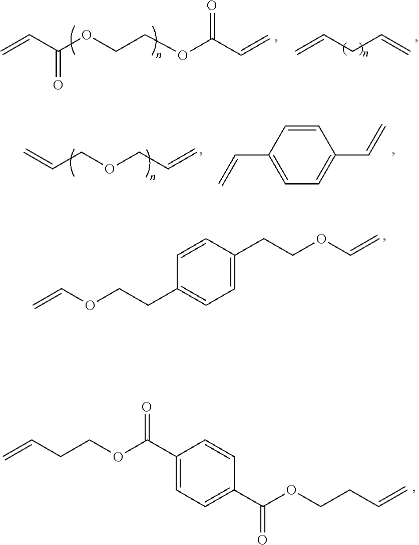

or a combination thereof and wherein n is from 1 to 30.

Aspect 73: The method of any one of Aspects 70-72, wherein the plurality of plastic crystals are derived from one or more:

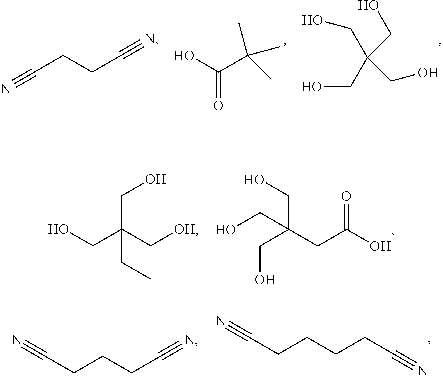

or a combination thereof.

Aspect 74: The method of any one of Aspects 70-73, wherein (I) is selected from one or more of:

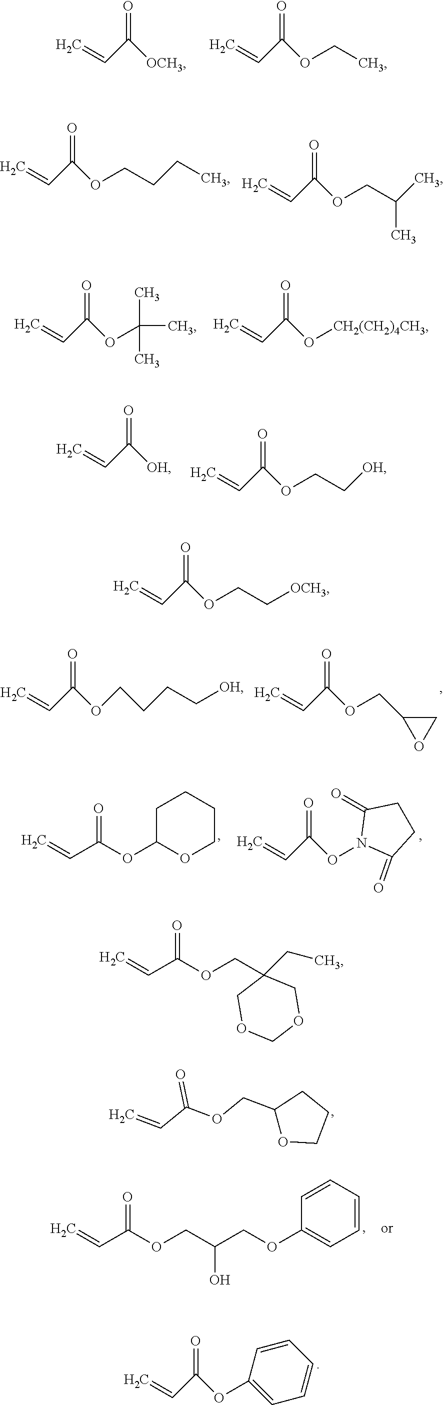

Aspect 75: The method of any one of Aspects 70-74, wherein (I) is selected from one or more of:

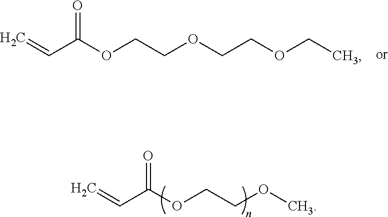

Aspect 76: The method of any one of Aspects 70-75, wherein (I) is selected from one or more of:

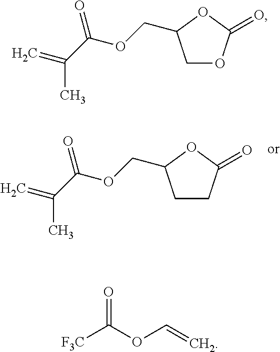

Aspect 77: The method of any one of Aspects 70-76, wherein (I) is selected from one or more of:

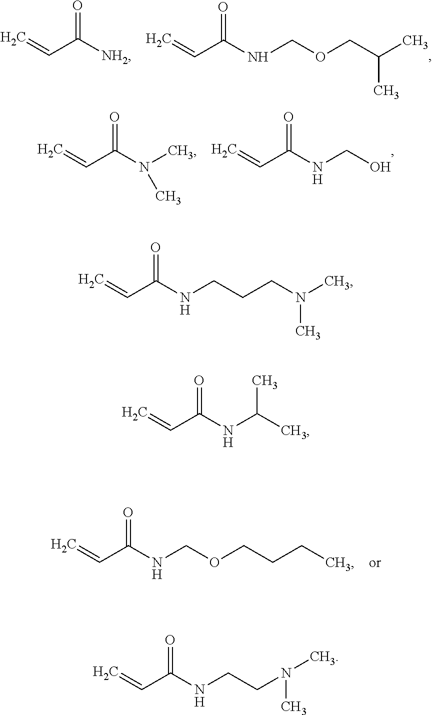

Aspect 78: The method of any one of Aspects 70-77, wherein (I) is selected from one or more of:

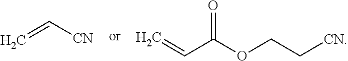

Aspect 79: The method of any one of Aspects 70-78, wherein (I) comprises:

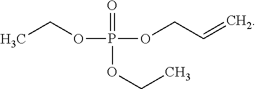

Aspect 80: The method of any one of Aspects 70-79, wherein the mixture further comprises an initiator.

Aspect 81: The method of Aspect 80, wherein the initiator comprises a thermal initiator, a photoinitiator, or a combination thereof.

Aspect 82: The method of Aspect 81, wherein the initiator comprises azobisisobutyronitrile, benzoyl peroxide, or a combination thereof.

Aspect 83: The method of Aspect 82, wherein the polymerization is a thermal polymerization.

Aspect 84: The method of Aspect 81, wherein the initiator comprises bis(2,4,6-trimethylbenzoyl)-phenylphosphine oxide (Irgacure 819), 2-hydroxyl-2-methyl-1-phenyl-1-propanone, methyl benzoylformate, Hydroxycyclohexyl phenyl ketone (Igracure 184), or a combination thereof.

Aspect 85: The method of Aspect 84, wherein the polymerization is a photopolymerization.

Aspect 86: The method of any one of Aspects 71-85, wherein the polymer composition is synthesized by polymerizing a homogeneous solution comprising butyl acrylate (BA), poly(ethylene glycol) diacrylate (PEGDA), succinonitrile (SN), and LiTFSI.

Aspect 87: The method of any one of Aspects 70-86, wherein the plurality of plastic crystals dispersed within the polymer composition to form a three-dimensional interconnected phase of plastic crystals and wherein the polymer composition exhibits an ionic conductivity of at least about 1.1 mS/cm at about 20° C.

Aspect 88: The method of any one of Aspects 70-87, wherein the polymer composition has a tensile strain from about 150% to about 500%.

Aspect 89: The method of any one of Aspects 70-88, wherein the polymer composition is flame retardant.

Aspect 90: The method of any one of Aspects 70-89, wherein the polymer composition is stable in a temperature range from about −30° C. to about 100° C.

Aspect 91: The method of any one of Aspects 70-89, wherein an ion transference number of the A is greater than about 0.4.

Aspect 92: A method of making an electrochemical cell comprising: a) providing an anode material; b) providing a cathode material; and c) providing a solid electrolyte formed by the methods of Aspects 70-91.

Aspect 93: A method of making an electrochemical cell comprising: a) providing an anode material; b) providing a cathode material; and c) providing the mixture of any one of claims 70-92 and polymerizing the mixture in-situ during the electrochemical cell operation to form the solid electrolyte of any one of Aspects 19 or 46.

### REFERENCES

1. Armand, M. & Tarascon, J.-M. Building better batteries. Nature 451, 652-657 (2008).
2. Choi, J. W. & Aurbach, D. Promise and reality of post-lithium-ion batteries with high energy densities. Nat. Rev. Mater. 1, 16013 (2016).
3. Bai, P., Li, J., Brushett, F. R. & Bazant, M. Z. Transition of lithium growth mechanisms in liquid electrolytes. Energy Environ. Sci. 9, 3221-3229 (2016).
4. Lin, D. C., Liu, Y & Cui, Y Reviving the lithium metal anode for high-energy batteries. Nat. Nanotechnol. 12, 194-206 (2017).
5. Wan, J. Y et al. Ultrathin, flexible, solid polymer composite electrolyte enabled with aligned nanoporous host for lithium batteries. Nat. Nanotechnol. 14, 705-711 (2019).
6. Lee, Y-G. et al. High-energy long-cycling all-solid-state lithium metal batteries enabled by silver-carbon composite anodes. Nat. Energy 5, 299-308 (2020).
7. Liu, W. et al. Enhancing ionic conductivity in composite polymer electrolytes with well-aligned ceramic nanowires. Nat. Energy 2, 17035 (2017).
8. Zhao, Q., Liu, X. T., Stalin, S., Khan, K. & Archer, L. A. Solid-state polymer electrolytes with in-built fast interfacial transport for secondary lithium batteries. Nat. Energy 4, 365-373 (2019).
9. Zhang, X. Y et al. Long cycling life solid-state Li metal batteries with stress self-adapted Li/garnet interface. Nano Lett. 20, 2871-2878 (2020).
10. Zhu, Y., Cao, J., Chen, H., Yu, Q. & Li, B. High electrochemical stability of a 3D cross-linked network PEO@nano-SiO₂ composite polymer electrolyte for lithium metal batteries. J. Mater. Chem. A 7, 6832-6839 (2019).
11. Lee, W. et al. Ceramic-salt composite electrolytes from cold sintering. Adv. Funct. Mater. 29, 1807872 (2019)
12. Yang, X. et al. Determining the limiting factor of the electrochemical stability window for PEO-based solid polymer electrolytes: main chain or terminal —OH group? Energy Environ. Sci. 13, 1318-1325 (2020).
13. Chen, R.-J. et al. Addressing the interface issues in all-solid-state bulk-type lithium ion battery via an all-composite approach. ACS App. Mater. Inter. 9, 9654 9661 (2017).
14. Bouchet, R. et al. Single-ion BAB triblock copolymers as highly efficient electrolytes for lithium-metal batteries. Nat. Mater. 12, 452-457 (2013).
15. Zhou, D. et al. In situ synthesis of a hierarchical all-solid-state electrolyte based on nitrile materials for high-performance lithium-ion batteries. Adv. Energy Mater. 5, 1500353 (2015).
16. Jiang, T. et al. Solvent-free synthesis of thin, flexible, nonflammable garnet-based composite solid electrolyte for all-solid-state lithium batteries. Adv. Energy Mater. 10, 1903376 (2020).
17. Markvicka, E. J., Bartlett, M. D., Huang, X. & Majidi, C. An autonomously electrically self-healing liquid metal-elastomer composite for robust soft-matter robotics and electronics. Nat. Mater. 17, 618-624 (2018).
18. Pan, C. et al. A liquid-metal-elastomer nanocomposite for stretchable dielectric materials. Adv. Mater. 31, 1900663 (2019).
19. Kim, H. J., Chen, B., Suo, Z. & Hayward, R. C. lonoelastomer junctions between polymer networks of fixed anions and cations. Science 367, 773-776 (2020).
20. Park, M. et al. Highly stretchable electric circuits from a composite mateiral of silver nanoparticles and elastomeric fibres. Nat. Nanotech. 7, 803-809 (2012).
21. Chen, L. et al. PEO/garnet composite electrolytes for solid-state lithium batteries: From “ceramic-in-polymer” to “polymer-in-ceramic”. Nano energy 46, 176-184 (2018).
22. Wang, F. et al. Progress report on phase separation in polymer solutions. Adv. Mater. 31, 1806733 (2019).
23. Seo, M. & Hillmyer, M. A. Reticulated nanoporous polymers by controlled polymerization-induced microphase separation. Science 336, 1422-1425 (2012).
24. Schulze, M. W., Mcintosh, L. D., Hilmyer, M. A. & Lodge, T. P. High-modulus, high-conductivty nanostructured polymer electrolyte membrane via polymerization-induced phase separation. Nano Lett. 14, 122-126 (2014).
25. Alarco, P.-J., Abu-Lebdeh, Y, Abouimrane, A. & Armand, M. The plastic-crystalline phase of succinonitrile as a universal matrix for solid-state ionic conductors. Nat. Mater. 3, 476-481 (2004).
26. Choi, K.-H. et al. Thin, deformable, and safety-reinforced plastic crystal polymer electrolytes for high-performance flexible lithium-ion batteries. Adv. Funct. Mater. 24, 44-52 (2014).
27. White, T. J., Natarajan, L. V., Tondiglia, V. P., Bunning, T. J. & Guymon, C. A. Polymerization kinetics and monomer functionality effects in thiol-ene polymer dispersed liquid crystals. Macromolecules 40, 1112-1120 (2007).
28. Serbutoviez, C., Kloosterboer, J. G., Boots, H. M. J. & Touwslager, F. J. Polymerization-induced phase separation. 2. morphology of polymer-dispersed liquid crystal thin films. Macromolecules 29, 7690-7698 (1996).
29. Phillip, W. A. et al. Diffusion and flow across nanoporous polydicyclopentadiene-based membranes. ACS Appl. Mater. Interfaces 1, 472-480 (2009).
30. Watson, B. L., Rolston, N., Printz, A. D. & Dauskardt, R. H. Scaffold-reinforced perovskite compound solar cells. Energy Environ. Sci. 10, 2500-2508 (2017).
31. Meng, J., Chu, F., Hu, J. & Li, C. Liquid polydimethylsiloxane grafting to enable dendrite-free Li plating for highly reversible Li-metal batteries. Adv. Funct. Mater. 29, 1902220 (2019).
32. Albertus, P., Babinec, S., Litzelman, S. & Newman, A. Status and challenges in enabling the lithium metal electrode for high-energy and low-cost rechargeable batteries. Nat. Energy 3, 16-21 (2018).
33. Bruce, P. G., Evans, J. & Vincent, C. A. Conductivity and transference number measurements on polymer electrolytes. Solid State Ion. 28, 918-922 (1988).
34. Diederichsen, K. M., McShane, E. J. & McCloskey, B. D. Promising routes to a high Li⁺ transference number electrolyte for lithium ion batteries. ACS Energy Lett. 2, 2563-2575 (2017).
35. Timachova, K., Watanabe, H. & Balsara, N. P. Effect of molecular weight and salt concentration on ion transport and the transference number in polymer electrolytes. Macromolecules 48, 7882-7888 (2015).
36. He, M. et al. Fluorinated electrolytes for 5-V Li-ion chemistry: probing voltage stability of electrolytes with electrochemical floating test. J. Electrochem. Soc. 162, A1725-A1729 (2015).
37. Randau, S. et al. Benchmarking the performance of all-solid-state lithium batteries. Nat. Energy 5, 259-270 (2020).
38. Duan, H. et al. Extended Electrochemical Window of Solid Electrolytes via Heterogeneous Multilayered Structure for High-Voltage Lithium Metal Batteries. Adv. Mater. 31, 1807789 (2019).
39. Yu, X. et al. Selectively Wetted Rigid-Flexible Coupling Polymer Electrolyte Enabling Superior Stability and Compatibility of High-Voltage Lithium Metal Batteries. Adv. Energy Mater. 10, 1903939 (2020).
40. Lopez, J. et al. A Dual-Crosslinking Design for Resilient Lithium-Ion Conductors. Adv. Mater. 30, 1804142 (2018).
41. Zhang, W., Nie, J., Li, F., Wang, Z. L. & Sun, C. A durable and safe solid-state lithium battery with a hybrid electrolyte membrane. Nano Energy 45, 413-419 (2018).
42. Wang, C. et al. Solid-State Plastic Crystal Electrolytes: Effective Protection Interlayers for Sulfide-Based All-Solid-State Lithium Metal Batteries. Adv. Funct. Mater. 29, 1900392 (2019).
43. Sun, J. et al. Hierarchical Composite-Solid-Electrolyte with High Electrochemical Stability and Interfacial Regulation for Boosting Ultra-Stable Lithium Batteries. Adv. Funct. Mater. 31, 2006381 (2021).
44. Yao, P. et al. PVDF/Palygorskite Nanowire Composite Electrolyte for 4 V Rechargeable Lithium Batteries with High Energy Density. Nano Lett. 18, 6113 6120 (2018).

1. A polymer composition comprising:
a) a matrix comprising an elastomeric polymer;
b) a plurality of plastic crystals dispersed within the matrix to form a three-dimensional interconnected phase of plastic crystals, and
wherein the polymer composition exhibits an ionic conductivity of at least about 1.1 mS/cm at about 20° C.

2. The polymer composition of claim 1, wherein the elastomeric polymer is derived from at least one monomer comprising: 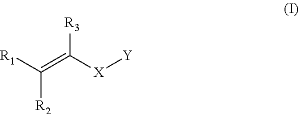
wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆-14 aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein X is C(O), O, or null,
wherein Y is OR₄, R₄, R₄′OR₄″, C(O)R₄, N(R₄)(R₄′″), or CN;
wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆-C₁₄ aryl), —(C₀₋₅ alkyl)(C₁-C₁₃ heteroaryl), —(C₀₋₅ alkyl)(C₆-C₁₄ aryloxy), —(C₀₋₅ alkyl)(C₃-C₁₀ cycloalkyl), —(C₀₋₅ alkyl)(C₃-C₁₀ heterocycloalkyl), —(C₀₋₅ alkyl)(C₃-C₁₀ cycloalkenyl), —(C₀₋₅ alkyl)(C₃-C₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), (C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R_{4″} is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
or wherein R₄″ is P(O)(OR₄′″)₂;
wherein R₄′″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄′″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl, and
wherein n is 1 to 200.

3. The polymer composition of claim 2, wherein:
when X is C(O), Y is OR₄, R₄′OR₄″, or N(R₄)(R₄′″); or
when X is O, Y is C(O)R₄; or
when X is null, Y is CN.

4. (canceled)

5. (canceled)

6. The polymer composition of claim 2, wherein (I) is selected from one or more of:

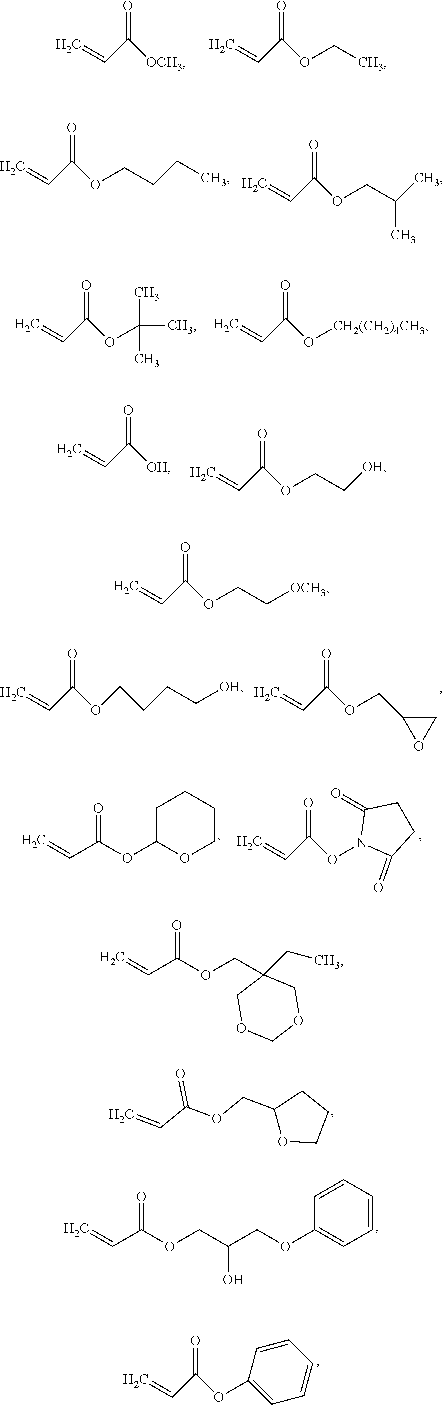

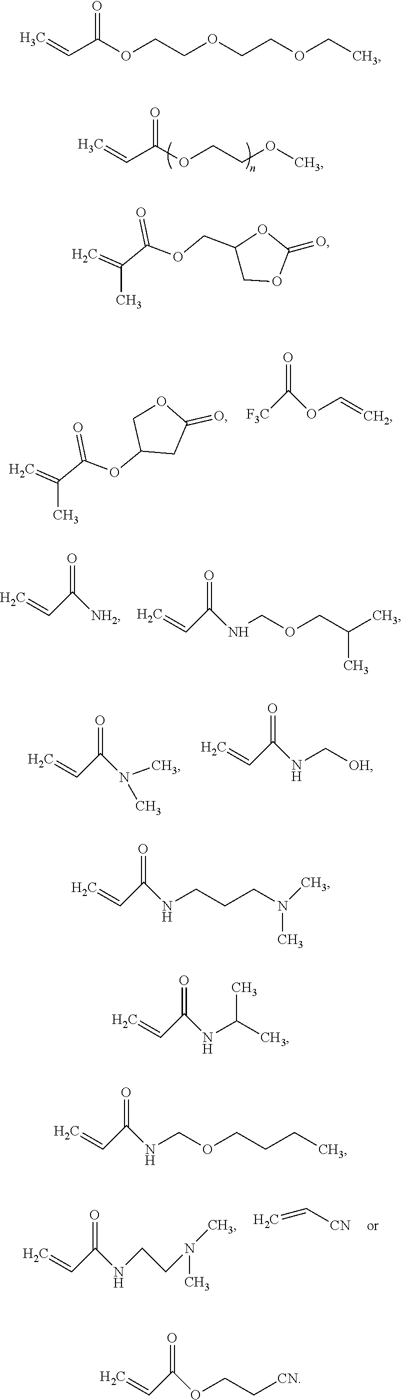

7. (canceled)

8. (canceled)

9. (canceled)

10. (canceled)

11. The polymer composition of claim 2, wherein (I) comprises:

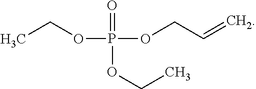

12. The polymer composition of claim 1, wherein the plurality of plastic crystals are derived from one or more: 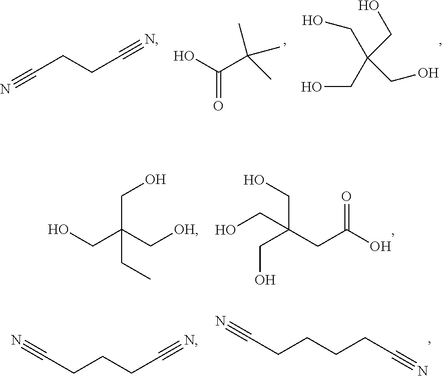
or a combination thereof.

13. The polymer composition of claim 1, further comprising a metal salt, wherein a cation of metal salt comprises one or more of Li, K, Na, Ca, Mg, Zn, Al, or a combination thereof, and wherein an anion of metal salt comprises bistrifilimide (TFSI⁻), bis(fluorosulfonyl)imide) (FSI⁻), triflate (OTf⁻), hexafluorophosphate (PF₆⁻), hexafluoroarsenate (AsF₆⁻), aluminum tetrachloride (AlCl₄⁻), boron tetrachloride (BCl₄⁻), boron tetrafluoride (BF₄⁻), iodide I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP) or a combination thereof, and wherein an ion transference number of the cation is greater than about 0.4.

14. (canceled)

15. (canceled)

16. (canceled)

17. (canceled)

18. (canceled)

19. (canceled)

20. A polymer composition formed by polymerizing a mixture comprising
a) one or more monomers of Formula (I),
b) a plurality of plastic crystals; and
c) a salt AB, wherein 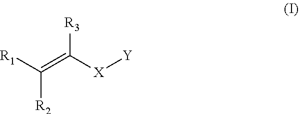
wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein X is C(O), O, or null,
wherein Y is OR₄, R₄, R₄′OR₄″, C(O)R₄, N(R₄)(R₄′″), or CN;
wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R_{4′} is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
or wherein R₄″ is P(O)(OR₄′″)₂;
wherein R₄′″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄′″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein n is 1 to 200;
wherein A is selected from Li, K, Na, Ca, Mg, Zn, Al, or a combination thereof, and
B is selected from bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

21. The polymer composition of claim 20, wherein the mixture further comprises a cross-linker comprising one or more of: 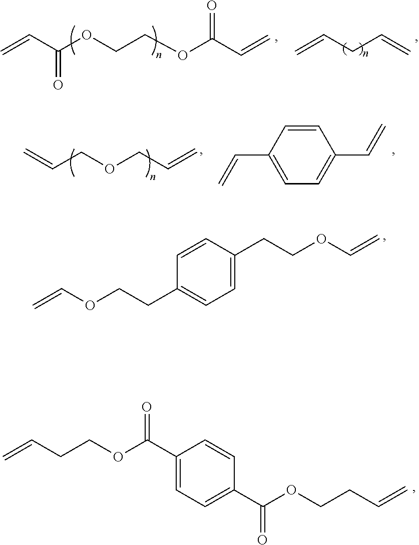
or a combination thereof and, wherein n is from 1 to 30.

22. (canceled)

23. The polymer composition of claim 20, wherein the plurality of plastic crystals are derived from one or more: 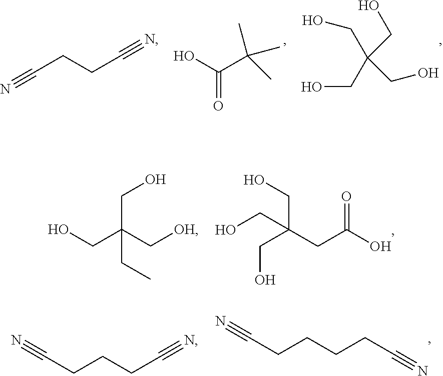
or a combination thereof.

24. The polymer composition of claim 20, wherein:
when X is C(O), Y is OR₄, R₄′OR₄″, or N(R₄)(R₄′″); or
when X is O, Y is C(O)R₄; or
when X is null, Y is CN.

25. (canceled)

26. (canceled)

27. The polymer composition of claim 20, wherein (I) is selected from one or more of:

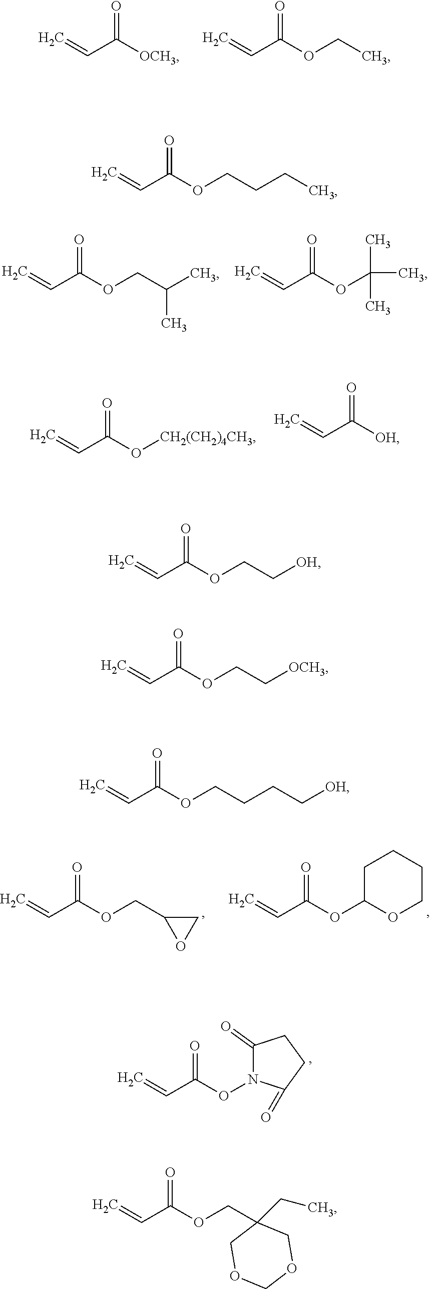

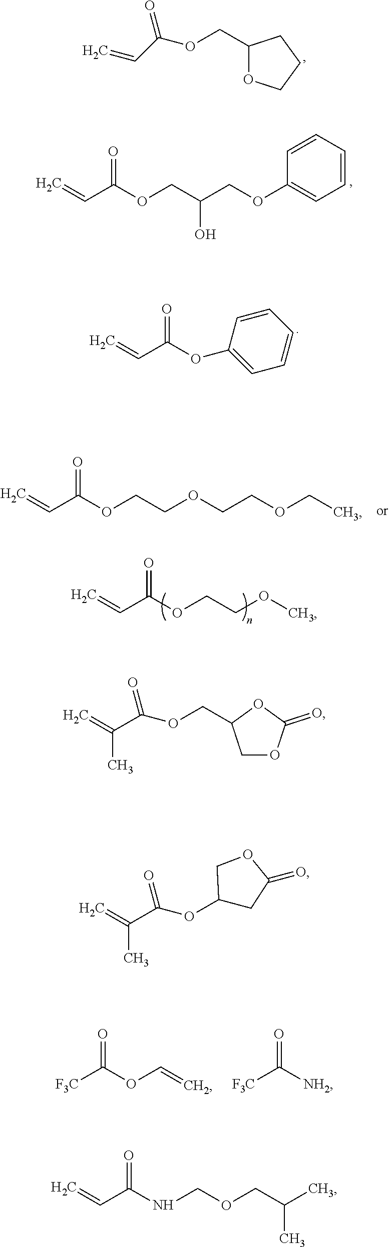

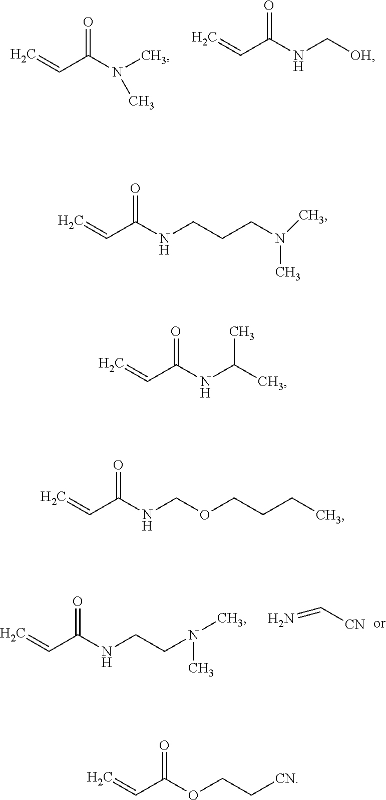

28. (canceled)

29. (canceled)

30. (canceled)

31. (canceled)

32. The polymer composition of claim 20, wherein (I) comprises:

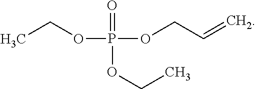

33. The polymer composition of claim 20, wherein the mixture further comprises an initiator, and wherein the initiator comprises a thermal initiator, a photoinitiator, or a combination thereof.

34. (canceled)

35. The polymer composition of claim 33, wherein the initiator comprises:
azobisisobutyronitrile, benzoyl peroxide, or a combination thereof; or
bis(2,4,6-trimethylbenzoyl)-phenylphosphine oxide (Irgacure 819), 2-hydroxyl-2-methyl-1-phenyl-1-propanone, methyl benzoylformate, Hydroxycyclohexyl phenyl ketone (Igracure 184), or a combination thereof.

36. (canceled)

37. (canceled)

38. (canceled)

39. The polymer composition of claim 20, wherein the polymer composition is synthesized by polymerizing a homogeneous solution comprising butyl acrylate (BA), poly(ethylene glycol) diacrylate (PEGDA), succinonitrile (SN), and LiTFSI.

40. The polymer composition of claim 20, wherein the plurality of plastic crystals dispersed within the polymer composition to form a three-dimensional interconnected phase of plastic crystals and wherein the polymer composition exhibits an ionic conductivity of at least about 1.1 mS/cm at about 20° C.

41. (canceled)

42. (canceled)

43. (canceled)

44. (canceled)

45. (canceled)

46. An electrochemical cell comprising:
a) an anode electrode;
b) a cathode electrode; and
c) a solid electrolyte comprising the polymer composition of claim 1;
wherein the anode electrode and the cathode electrode are in electrical communication with the solid electrolyte.

47. The electrochemical cell of claim 46, wherein the anode electrode comprises a metal material comprising Li, Ca, Na, K, Mg, Zn, Al, alloys thereof, or a combination thereof.

48. (canceled)

49. The electrochemical cell of claim 46, wherein the cathode electrode the cathode is a metal cathode or a composite cathode.

50. The electrochemical cell of claim 49, wherein the cathode comprises copper, carbon, graphite, sodium, potassium, lithium, magnesium, calcium, aluminum, layered oxides, vanadium-based cathode, sulfur-based cathode, manganese-based cathode, rocksalt cathode, disordered rocksalt cathode, lithium-rich cathode, high voltage ceramic, low voltage ceramic, NMC (nickel-manganese-cobalt oxide) cathode, NCA (nickel-cobalt-aluminum oxide) cathode, LCO (lithium cobalt oxide) cathode, lithium-nickel-cobalt-aluminum oxide material (LNCAO), lithium-nickel-manganese-cobalt oxide (LNMCO), LFP (lithium iron phosphate) cathode, fluoride-based cathode, sulfur selenium cathode, sulfur selenium tellurium cathode, spinels, olivines, or any combination thereof.

51. (canceled)

52. (canceled)

53. (canceled)

54. The electrochemical cell of claim 50, wherein the cathode material comprises Li metal, LiNi_{1-x-y}MnₓCo_{y}O₂, or LiNi_{1-a-b}CoₐAl_{b}O₂, wherein 1≥x≥0, 1≥y≥0, 1≥a≥0, and 1≥b≥0.

55. (canceled)

56. The electrochemical cell of claim 46, wherein the cell:
exhibits a cyclic Coulombic efficiency greater than about 99.5% for about 1,000 cycles at a current density from about 0.1 mA cm⁻² to about 10 mA cm⁻²; or
is configured to provide a specific energy of about 350 to about 520 watt-hours per kilogram of the anode, cathode, and the solid electrolyte after about 500 cycles at a specific energy of about 150 to about 500 W/kg; or
exhibits a substantially stable plating and stripping cycling for at least about 500 hours at a current density from about 0.1 mA cm⁻² to about 10 mA cm⁻²; or
exhibits a substantially stable plating and stripping cycling for up to about 1500 hours at a current density from about 0.1 mA cm⁻² to about 10 mA cm⁻²; or exhibits a reversible capacity up to about 200 mAh/g.

57. (canceled)

58. (canceled)

59. (canceled)

60. (canceled)

61. The electrochemical cell of claim 46, wherein the polymer composition is formed in-situ.

62. (canceled)

63. A method of making a polymer composition comprising:
a) forming a mixture comprising
i. one or more monomers of Formula (I),
ii. a plurality of plastic crystals;
iii. a salt AB, and
b) polymerizing the mixture to form the polymer composition; wherein 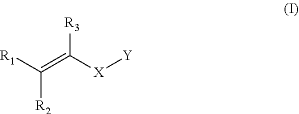
wherein R₁, R₂, and R₃ each is independently selected from hydrogen, C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₁ and R₂ each is independently and optionally substituted with one or more of C₁₋₁₂ alkyl, C₁₋₁₂ alkoxy, C₁₋₁₂ heteroalkyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein X is C(O), O, or null,
wherein Y is OR₄, R₄, R₄′OR₄″, C(O)R₄, N(R₄)(R₄′″), or CN;
wherein R₄ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄′ is (—O—CH₂—CH₂—)ₙ, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄′ is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
wherein R₄″ hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R_{4″} is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl;
or wherein R₄″ is P(O)(OR₄′″)₂;
wherein R₄′″ is selected from hydrogen, C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl-)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), halide, amine; wherein R₄″ and R₄′″ each is independently and optionally substituted with one or more of C₁₋₂₀ alkyl, C₂₋₂₀ alkenyl, C₂₋₂₀ alkynyl, C₁₋₂₀ alkoxy, C₁₋₂₀ heteroalkyl, C₂₋₂₀ heteroalkenyl, C₂₋₂₀ heteroalkynyl, —(C₀₋₅ alkyl)(C₆₋₁₄ aryl), —(C₀₋₅ alkyl)(C₁₋₁₃ heteroaryl), —(C₀₋₅ alkyl)(C₆₋₁₄ aryloxy), —(C₀₋₅ alkyl)(C₃₋₁₀ cycloalkyl), —(C₀₋₅ alkyl)(C₃₋₁₀ heterocycloalkyl), —(C₀₋₅ alkyl)(C₃₋₁₀ cycloalkenyl), —(C₀₋₅ alkyl)(C₃₋₁₀ heterocycloalkenyl), aldehyde, amino, carbonyl, ester, ketone, ether, halide, carboxyl, hydroxy, nitro, sulfo-oxo, sulfonyl, sulfone, sulfoxide, thiol, or phosphonyl,
wherein n is 1 to 200;
wherein A is selected from Li, K, Na, Ca, Mg, Zn, Al, or a combination thereof, and
B is selected from bistrifilimide (TFSI⁻), bis(fluorosulfonyl)imide) (FSI⁻), triflate (OTf⁻), hexafluorophosphate (PF₆⁻), hexafluroarsenate (AsF₆⁻), aluminum tetrachloride (AlCl₄⁻), boron tetrachloride (BCl₄⁻), boron tetrafluoride (BF₄⁻), iodide (I⁻), chlorate (ClO₃⁻), bromate (BrO₃⁻), iodate (IO₃⁻), difluoro(oxalato)borate (DFOB⁻), bis(oxalato)borate (BOB⁻), difluorophosphate (DFP), or a combination thereof.

64.-86. (canceled)
